(19) United States
(12) Patent Application Publication
(10) Pub. No.: US 2025/0087684 A1
(43) Pub. Date: Mar. 13, 2025

(54) METHOD FOR FORMING POSITIVE ELECTRODE ACTIVE MATERIAL AND METHOD FOR FABRICATING LITHIUM-ION BATTERY

(71) Applicant: SEMICONDUCTOR ENERGY LABORATORY CO., LTD., Atsugi-shi (JP)

(72) Inventors: Shuji FUKAI, Kanagawa (JP); Kazutaka KURIKI, Kanagawa (JP); Yumiko YONEDA, Kanagawa (JP); Yosiharu ASADA, Kanagawa (JP); Kazuya SHIMADA, Kanagawa (JP)

(21) Appl. No.: 18/798,072

(22) Filed: Aug. 8, 2024

(30) Foreign Application Priority Data
Aug. 10, 2023 (JP) 2023-130742
Nov. 22, 2023 (JP) 2023-198136

(51) Int. Cl. H01M 4/525; C01G 53/00; H01M 4/04; H01M 10/0525; H01M 10/0569

(52) U.S. Cl. CPC H01M 4/525; C01G 53/42; H01M 4/0404; H01M 10/0525; H01M 10/0569; C01P 2002/50; C01P 2002/72; C01P 2002/77; C01P 2002/88; C01P 2006/40; H01M 2300/0034; H01M 2300/0037

(57) ABSTRACT

A method for forming a positive electrode active material applicable to a lithium-ion battery having excellent charge and discharge characteristics even in a low-temperature environment is provided. The method for forming a positive electrode active material includes: a first step of heating lithium cobalt oxide with a median diameter of less than or equal to 10 μm; a second step of mixing a fluorine source and a magnesium source with the lithium cobalt oxide subjected to the first step, thereby forming a first mixture; a third step of heating the first mixture; a fourth step of mixing a nickel source and an aluminum source with the first mixture subjected to the third step, thereby forming a second mixture; and a fifth step of heating the second mixture. The third step and the fifth step are performed in a state where the first mixture is held to have a thickness of less than or equal to 2.0 mm in a first setter. The first step, the third step, and the fifth step are performed in an atmosphere containing oxygen.

### BACKGROUND OF THE INVENTION

### 1. Field of the Invention

One embodiment of the present invention relates to a lithium-ion battery (also referred to as a lithium-ion secondary battery). The present invention is not limited to the above field and relates to a semiconductor device, a display device, a light-emitting device, a power storage device, a lighting device, an electronic device, a vehicle, and manufacturing methods thereof. The lithium-ion battery of one embodiment of the present invention can be used as a power supply necessary for the above semiconductor device, display device, light-emitting device, e device, lighting device, electronic device, and vehicle. For example, the above electronic device may be an information terminal device provided with the lithium-ion secondary battery. Furthermore, the above power storage device may be a stationary power storage device, for example.

### 2. Description of the Related Art

In recent years, a variety of storage batteries such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

It is known that the discharge capacity of a lithium-ion battery changes depending on a discharge temperature. Thus, a lithium-ion battery having excellent battery characteristics even in a low-temperature environment is required (e.g., see Patent Document 1).

In order to increase the capacities of lithium-ion batteries and improve their charge-discharge cycle performance at room temperature, various researches and developments have been conducted on both positive and negative electrodes. As the positive electrode active material, lithium cobalt oxide having a stable crystal structure has been studied (for example, see Patent Document 2).

Fluorides such as fluorite (calcium fluoride) have been used as fusing agents in iron manufacture and the like for a very long time, and the physical properties of fluorides have been studied (e.g., Non-Patent Document 1).

As for negative electrode active materials, it is known that silicon-based materials have higher capacities than graphite-based materials, and negative electrodes using silicon-based materials have been examined (e.g., Patent Document 3).

### REFERENCE

### Patent Document

[Patent Document 1] Japanese Published Patent Application No. 2015-026608
[Patent Document 2] PCT International publication No. WO2020/026078
[Patent Document 3] Japanese Published Patent Application No. 2019-165005

### Non-Patent Document

[Non-Patent Document 1]W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36 [1], 12-17 (1953).

### SUMMARY OF THE INVENTION

Patent Document 1 describes that a lithium-ion battery capable of operating even in a low-temperature environment (e.g., 0° C. or lower) can be obtained with the use of the electrolyte solution described in Patent Document 1. However, even the lithium-ion battery described in Patent Document 1 does not have a high charge capacity when discharging in a low-temperature environment at the time of this application, and further improvement is desired.

In order to achieve a lithium-ion battery having excellent charge and discharge characteristics even in a low-temperature environment, it is required to develop not only an electrolyte solution but also a positive electrode and a negative electrode suitable for a lithium-ion battery capable of operating even in a low-temperature environment. The positive electrode preferably includes a positive electrode active material capable of performing high-voltage charge and discharge. With use of the positive electrode active material capable of performing high-voltage charge and discharge, the lithium-ion battery can have high charge capacity and/or high charge energy density.

In view of the above, an object of one embodiment of the present invention is to provide a lithium-ion battery having excellent charge and discharge characteristics even in a low-temperature environment. Specifically, an object is to provide a positive electrode, a negative electrode, an electrolyte solution, and the like that can be used for a lithium-ion battery with high discharge capacity even when discharge is performed in a low-temperature environment. Another object is to provide a positive electrode, a negative electrode, an electrolyte solution, and the like that can be used for a lithium-ion battery with high charge capacity and/or high charge energy density even when charge is performed in a low-temperature environment.

Note that the description of these objects does not preclude the existence of other objects. In one embodiment of the present invention, there is no need to achieve all the objects. Other objects can be derived from the descriptions of the specification, the drawings, the claims, and the like.

One embodiment of the present invention is a method for forming a positive electrode active material using a setter for holding an object to be heated. The method includes a first step of heating lithium cobalt oxide with a median diameter of less than or equal to 10 μm at a temperature higher than or equal to 700° C. and lower than or equal to 1000° C. for longer than or equal to an hour and shorter than or equal to 5 hours; a second step of mixing a fluorine source and a magnesium source with the lithium cobalt oxide subjected to the first step, thereby forming a first mixture; a third step of heating the first mixture at a temperature higher than or equal to 800° C. and lower than or equal to 1100° C. for longer than or equal to an hour and shorter than or equal to 10 hours; a fourth step of mixing a nickel source and an aluminum source with the first mixture subjected to the third step, thereby forming a second mixture; and a fifth step of heating the second mixture at a temperature higher than or equal to 800° C. and lower than or equal to 950° C. for longer than or equal to an hour and shorter than or equal to 5 hours. The third step is performed in a state where the first mixture is held to have a thickness of less than or equal to 2.0 mm in a first setter. The fifth step is performed in a state where the second mixture is held to have a thickness of less than or equal to 2.0 mm in a second setter. The first step, the third step, and the fifth step are performed in an atmosphere containing oxygen.

In the above method, the number of magnesium atoms in the magnesium source is preferably greater than or equal to 0.3% and less than or equal to 3% of the number of cobalt atoms in the lithium cobalt oxide subjected to the first step.

In the above method, the number of nickel atoms in the nickel source is preferably greater than or equal to 0.05% and less than or equal to 4% of the number of cobalt atoms in the lithium cobalt oxide subjected to the first step.

In the above method, the number of aluminum atoms in the aluminum source is greater than or equal to 0.05% and less than or equal to 4% of the number of cobalt atoms in the lithium cobalt oxide subjected to the first step.

Another embodiment of the present invention is a method for fabricating a lithium-ion battery. The lithium-ion battery includes a positive electrode, an electrolyte solution, a negative electrode, a separator, and an exterior body. The method for fabricating a lithium-ion battery includes the steps of: dispersing the positive electrode active material formed by any of the above methods, a conductive material, and polyvinylidene fluoride in an organic solvent, thereby forming a positive electrode slurry; applying the positive electrode slurry on a positive electrode current collector and drying the positive electrode slurry, thereby forming the positive electrode; dispersing a graphite particle, a silicon particle, and poly(acrylic acid) in water, thereby forming a negative electrode slurry; applying the negative electrode slurry on a negative electrode current collector and drying the negative electrode slurry, thereby forming the negative electrode; and mixing a lithium salt, fluorinated cyclic carbonate, and fluorinated linear carbonate, thereby forming the electrolyte solution. The positive electrode and the negative electrode are stacked with the separator interposed therebetween to form a stack. The stack and the electrolyte solution are held in the exterior body.

In the above method for fabricating a lithium-ion battery, it is preferable that the lithium salt include LiPF₆, the fluorinated cyclic carbonate include fluoroethylene carbonate, and the fluorinated linear carbonate include methyl trifluoropropionate.

One embodiment of the present invention can provide a lithium-ion battery having excellent charge and discharge characteristics even in a low-temperature environment. Specifically, a positive electrode, a negative electrode, an electrolyte solution, or the like applicable to a lithium-ion battery with high discharge capacity and/or high discharge energy density even when discharge in a low-temperature environment can be provided. A positive electrode, a negative electrode, an electrolyte solution, and the like that can be used for a lithium-ion battery with high charge capacity and/or high charge energy density even when charge is performed in a low-temperature environment can be provided.

Note that the description of these effects does not preclude the existence of other effects. One embodiment of the present invention does not necessarily have all of these effects. Other effects can be derived from the description of the specification, the drawings, the claims, and the like.

### BRIEF DESCRIPTION OF THE DRAWINGS

FIGS. 1A to 1D illustrate a method for forming a positive electrode active material.

FIG. 2A is a cross-sectional schematic view of a heating furnace, FIG. 2B is a top view of a lid, and FIG. 2C is a cross-sectional schematic view illustrating the heights of a container, a lid, and an object to be heated.

FIG. 3A illustrates an example of a manufacturing apparatus. FIG. 3B illustrates the layout of rollers.

FIG. 4 illustrates an example of a manufacturing apparatus.

FIG. 5 shows a method for forming a positive electrode active material.

FIGS. 6A to 6C illustrate methods for forming a positive electrode active material.

FIG. 7 is a phase diagram showing a relation between temperature and compositions of lithium fluoride and magnesium fluoride.

FIG. 8 shows results of DSC analysis.

FIG. 9A is a cross-sectional view illustrating an internal structure of a lithium-ion battery, and FIG. 9B is a cross-sectional view illustrating a positive electrode active material, an electrolyte solution, and the like of the lithium-ion battery.

FIGS. 10A and 10B are cross-sectional views illustrating a positive electrode active material.

FIGS. 11A to 11F are cross-sectional views illustrating a positive electrode active material.

FIG. 12 illustrates crystal structures of a positive electrode active material.

FIG. 13 illustrates crystal structures of a conventional positive electrode active material.

FIG. 14 shows XRD patterns calculated from crystal structures.

FIG. 15 shows XRD patterns calculated from crystal structures.

FIG. 16 illustrates a method for forming a negative electrode active material.

FIGS. 17A to 17E illustrate structure examples of a battery.

FIGS. 18A to 18C illustrate structure examples of a battery.

FIGS. 19A to 19C illustrate structure examples of a battery.

FIGS. 20A to 20C illustrate structure examples of a battery.

FIG. 21 illustrates a method for processing a film.

FIGS. 22A to 22E illustrate methods for processing a film.

FIGS. 23A and 23B illustrate methods for processing a film. FIG. 23C is a perspective view of a curved battery.

FIGS. 24A and 24B illustrate methods for processing a film. FIG. 24C is a perspective view of a curved battery.

FIG. 25A is an exploded perspective view of a coin-type secondary battery, FIG. 25B is a perspective view of the coin-type secondary battery, and FIG. 25C is a cross-sectional perspective view of the coin-type secondary battery.

FIG. 26A illustrates an example of a cylindrical secondary battery. FIG. 26B illustrates the example of the cylindrical secondary battery. FIG. 26C illustrates an example of a plurality of cylindrical secondary batteries. FIG. 26D illustrates an example of a power storage system including the plurality of cylindrical secondary batteries.

FIGS. 27A and 27B illustrate examples of a secondary battery, and FIG. 27C illustrates the internal state of the secondary battery.

FIGS. 28A to 28C illustrate an example of a secondary battery.

FIGS. 29A and 29B each illustrate the appearance of a secondary battery.

FIGS. 30A to 30C illustrate a method for fabricating a secondary battery.

FIGS. 31A to 31H illustrate examples of electronic devices.

FIGS. 32A to 32D illustrate examples of electronic devices.

FIGS. 33A to 33C illustrate examples of electronic devices.

FIGS. 34A to 34C illustrate examples of vehicles.

FIGS. 35A to 35D illustrate examples of devices for space.

FIGS. 36A and 36B are graphs showing results of charge and discharge cycles in Example.

FIGS. 37A and 37B are graphs showing results of charge and discharge cycles in Example.

FIGS. 38A and 38B are graphs showing results of charge and discharge cycles in Example.

FIGS. 39A and 39B are graphs showing results of charge and discharge cycles in Example.

FIGS. 40A and 40B are graphs showing results of low-temperature charge and discharge tests in Example.

FIGS. 41A and 41B are graphs showing results of low-temperature charge and discharge tests in Example.

FIG. 42A is a photograph of a battery fabricated in Example, and FIGS. 42B and 42C are X-ray CT images before an impact test in Example.

FIG. 43 is a graph showing charge and discharge characteristics before the impact test in Example.

FIGS. 44A and 44B are photographs explaining the impact test in Example, and FIGS. 44C and 44D are X-ray CT images after the impact test in Example.

FIG. 45 is a graph showing charge and discharge characteristics after the impact test in Example.

FIGS. 46A to 46C are graphs showing the number of times of bending and discharge capacity in a bending test in Example.

### DETAILED DESCRIPTION OF THE INVENTION

Embodiments of the present invention will be described in detail with reference to the drawings as appropriate. However, the present invention is not limited to the description below, and it is easily understood by those skilled in the art that modes and details can be modified in various ways without departing from the spirit and scope of the present invention. Therefore, in the embodiments and examples of the present invention described below, reference numerals denoting the same portions are used in common in different drawings.

Ordinal numbers such as “first” and “second” in this specification and the like are used in order to avoid confusion among components and do not denote the order such as the order of steps or the stacking order. A term without an ordinal number in this specification and the like might be provided with an ordinal number in a claim in order to avoid confusion among components. A term with an ordinal number in this specification and the like might be provided with a different ordinal number in the scope of claims. Moreover, even when a term is provided with an ordinal number in this specification and the like, the ordinal number might be omitted in the scope of claims and the like.

Furthermore, the embodiments and examples described below can be implemented by being combined with any of the embodiments, examples, and the like described in this specification and the like unless otherwise mentioned.

In this specification and the like, a low-temperature environment refers to an environment at a temperature lower than or equal to 0° C., and a temperature lower than or equal to 0° C. is sometimes referred to as “below freezing”. In the case where a low-temperature environment is stated in this specification and the like, a given temperature lower than or equal to 0° C. can be selected. For example, in the case where a low-temperature environment is stated in this specification and the like, any one of lower than or equal to 0° C., lower than or equal to −10° C., lower than or equal to −20° C., lower than or equal to −30° C., lower than or equal to −40° C., lower than or equal to −50° C., lower than or equal to −60° C., lower than or equal to −80° C., and lower than or equal to −100° C. can be selected.

In this specification and the like, excellent charge and discharge characteristics in a low-temperature environment mean a small decrease in discharge capacity in a low-temperature environment with respect to the discharge capacity at 25° C.

In this specification and the like, a space group is represented using the short symbol of the international notation (or the Hermann-Mauguin notation). In addition, the Miller index is used for the expression of crystal planes and crystal orientations. An individual plane that shows a crystal plane is denoted by “( )”. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k).

In addition, a given integer of 1 or more is represented by h, k, i, or l in some cases. Examples of (001) include (001), (003), and (006).

The space group of a crystal structure is identified by XRD, electron diffraction, neutron diffraction, or the like. Thus, in this specification and the like, belonging to a space group or being a space group can be rephrased as being identified as a space group.

In this specification and the like, a theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material can be represented by x (occupancy rate of Li in lithium sites) in a compositional formula, e.g., LiₓCoO₂. In the case of a positive electrode active material in a lithium-ion battery, x can be represented by (theoretical capacity−charge capacity)/theoretical capacity. For example, when a lithium-ion battery using LiCoO₂ as a positive electrode active material is charged to 219.2 mAh/g per the positive electrode active material weight, the positive electrode active material can be represented by Li_{0.2}CoO₂, i.e., x=0.2. Note that “x in LiₓCoO₂ is small” means, for example, x≤0.24, and means, for example, 0.1<x≤0.24 in consideration of the practical range of using LiₓCoO₂ as the positive electrode active material of the lithium-ion battery.

Lithium cobalt oxide which almost satisfies the stoichiometric proportion is LiCoO₂ with x of 1. Even after discharge of a secondary battery ends, the lithium-ion battery can be called LiCoO₂ with x of 1. In general, in a lithium-ion battery using LiCoO₂, the discharge voltage rapidly decreases until the discharge voltage to be 2.5 V. For this reason, in this specification and the like, for example, a state in which voltage becomes 2.5 V (counter electrode is lithium) at current of 100 mA/g or lower per positive electrode active material weight is regarded as a state in which discharge ends with x of 1. Accordingly, for example, in order to obtain lithium cobalt oxide with x of 0.2, charge may be performed at 219.2 mAh/g per positive electrode active material weight in a state in which discharge ends.

Charge capacity and/or discharge capacity used for calculation of x in LiₓCoO₂ is preferably measured under the condition where there is no influence or small influence of a short circuit and/or decomposition of an electrolyte solution. For example, data of a lithium-ion battery that is measured while a sudden change in voltage that seems to be derived from a short circuit is not preferably used for calculation of x.

In this specification and the like, a “carbonate” refers to a compound containing at least one carbonic ester in its molecular structure and includes a cyclic carbonate and a linear carbonate in its category unless otherwise specified. The term “linear” carbonate includes both “straight-chain” and “branched-chain” carbonate.

In this specification and the like, the expression “including A and/or B” means including A, including B, and including A and B.

In this specification and the like, a full cell means a battery cell in which a positive electrode and a negative electrode other than metal are assembled. In this specification and the like, a half cell means a battery cell assembled using a lithium metal for a negative electrode (a counter electrode).

### Embodiment 1

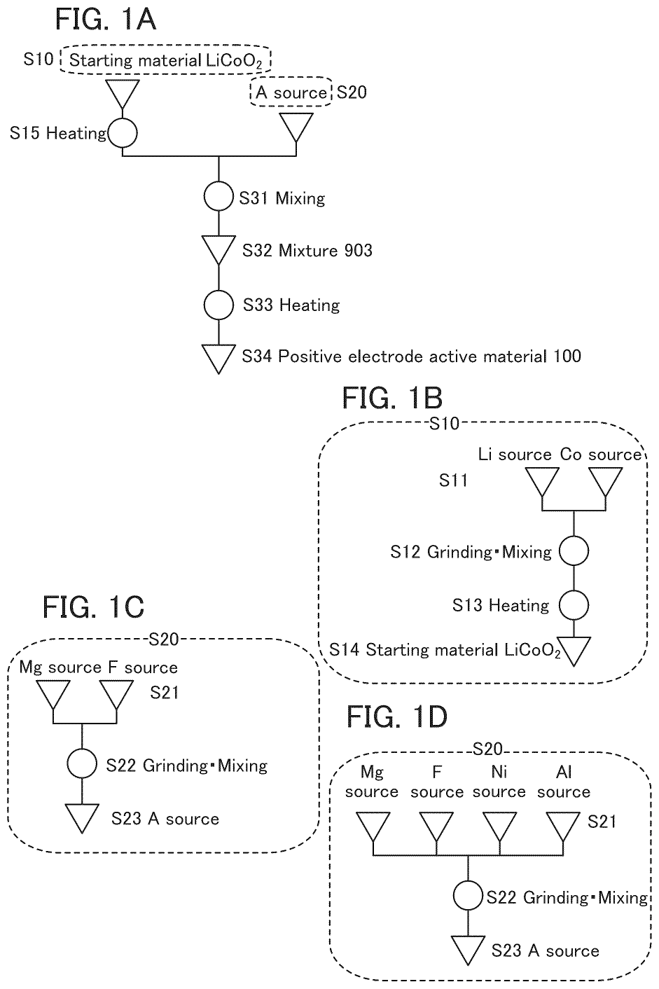

In this embodiment, a method for forming a positive electrode active material applicable to a lithium-ion battery having excellent charge and discharge characteristics even in a low-temperature environment is described with reference to FIGS. 1A to 1D, FIGS. 2A to 2C, FIGS. 3A and 3B, FIG. 4, FIG. 5, FIGS. 6A to 6C, FIG. 7, and FIG. 8. The features of the positive electrode active material applicable to a lithium-ion battery will be described in Embodiment 2.

### Example 1 of Formation Method of Positive Electrode Active Material

An example of a method for forming a positive electrode active material of one embodiment of the present invention (Example 1 of formation method of positive electrode active material) is described with reference to FIGS. 1A to 1D.

First, lithium cobalt oxide is prepared as a starting material in Step S10. The particle diameter (strictly, the median diameter (D50)) of the lithium cobalt oxide that is the starting material can be less than or equal to 10 μm (preferably less than or equal to 8 μm). Lithium cobalt oxide with a median diameter (D50) of less than or equal to 10 μm may be known or publicly used (in short, commercially available) lithium cobalt oxide or lithium cobalt oxide formed through Steps S11 to S14 shown FIG. 1B. As a typical example of the commercially available lithium cobalt oxide with a median diameter (D50) of less than or equal to 10 μm, lithium cobalt oxide produced by NIPPON CHEMICAL INDUSTRIAL CO., LTD. (product name: CELLSEED C-5H) can be given. Cellseed C-5H has a median diameter (D50) of approximately 7 μm. A method for forming lithium cobalt oxide with a median diameter (D50) of less than or equal to 10 μm through Steps S11 to S14 is described below.

### <Step S11>

In Step S11 shown in FIG. 1B, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity of higher than or equal to 99.99%, for example.

As the cobalt source, a cobalt-containing compound is preferably used and for example, cobalt hydroxide or tricobalt tetraoxide can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and increased reliability can be obtained.

### <Step S12>

Next, in Step S12 shown in FIG. 1B, the lithium source and the cobalt source are ground and mixed to form a mixed material. The grinding and mixing can be performed by a dry method or a wet method. To obtain lithium cobalt oxide with a median diameter (D50) of less than or equal to 10 μm as a starting material, the grinding and mixing by a wet method are preferred because a material can be crushed into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity of higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

### <Step S13>

Next, in Step S13 shown in FIG. 1B, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. and lower than or equal to 1000° C. An excessively low temperature might lead to insufficient decomposition and melting of the lithium source and the transition metal source. An excessively high temperature might lead to a defect due to evaporation of lithium from the lithium source and/or excessive reduction of cobalt, for example. An oxygen defect which could be induced by a change of trivalent cobalt into divalent cobalt due to excessive reduction, for example.

When the heating time is too short, lithium cobalt oxide is not synthesized, but when the heating time is too long, the productivity is lowered. Thus, the heating time is longer than or equal to 1 hour and shorter than or equal to 100 hours, preferably longer than or equal to 2 hours and shorter than or equal to 20 hours, still further preferably longer than or equal to 2 hours and shorter than or equal to 10 hours.

A temperature raising rate is preferably higher than or equal to 80° C./h and lower than or equal to 250° C./h although depending on the end-point temperature of the heating. For example, in the case of heating at 1000° C. for 10 hours, the temperature raising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flowing”.

In the case where the heating atmosphere is an oxygen-containing atmosphere, flowing is not necessarily performed. For example, a method may be employed in which the pressure in the reaction chamber is reduced, the reaction chamber is filled with oxygen, and the exit and entry of the oxygen are prevented. Such a method is called purging. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container holding an object to be heated at the time of heating is preferably a crucible made of aluminum oxide or a setter (also referred to as a saggar) made of aluminum oxide. Almost no impurities enter the crucible made of aluminum oxide. In this embodiment, a setter made of aluminum oxide with a purity of 99.9% is used. The crucible or the setter is preferably covered with a lid before heating, in which case volatilization of a material can be prevented.

The heated material is crushed as needed and may be made to pass through a sieve.

### <Step S14>

Through the above steps, lithium cobalt oxide (LiCoO₂) can be synthesized as Step S14 in FIG. 1B. The lithium cobalt oxide (LiCoO₂) in Step S14 is an oxide containing a plurality of metal elements in its structure and thus can be referred to as a composite oxide. A composite oxide in this specification and the like refers to an oxide containing a plurality of metal elements in its structure. Note that the lithium cobalt oxide (LiCoO₂) shown in Step S14 may be obtained after adjusting particle size distribution by performing a grinding step and a classification step after Step S13.

Although the example is described in which the composite oxide is formed by a solid phase method as in Steps S11 to S14, the composite oxide may be formed by a coprecipitation method. Alternatively, the composite oxide may be formed by a hydrothermal method.

Through Steps S11 to S14, lithium cobalt oxide that is a starting material of a positive electrode active material applicable to a lithium-ion battery having excellent charge and discharge characteristics even in a low-temperature environment can be obtained. Specifically, as the lithium cobalt oxide that is a starting material, lithium cobalt oxide with a median diameter (D50) of less than or equal to 10 μm can be obtained.

### <Step S15>

Next, as Step S15 in FIG. 1A, the lithium cobalt oxide that is a starting material is heated. The heating in Step S15 is the first heating performed on the lithium cobalt oxide and thus is sometimes referred to as the initial heating in this specification and the like. The heating is performed before Step S31 described below and thus is sometimes referred to as preheating or pretreatment.

By the initial heating, a lithium compound or the like unintentionally remains on a surface of the lithium cobalt oxide is extracted. In addition, an effect of increasing the crystallinity of an inner portion can be expected. Although the lithium source and/or the cobalt source prepared in Step S11 and the like might contain impurities, impurities in the lithium cobalt oxide that is a starting material can be reduced by the initial heating. The effect of increasing the crystallinity of the inner portion is, for example, an effect of reducing distortion, a shift, or the like derived from differential shrinkage or the like of the lithium cobalt oxide formed in Step S14.

Furthermore, through the initial heating, the surface of the lithium cobalt oxide becomes smooth. Furthermore, through the initial heating, a crack, a crystal defect, or the like included in the lithium cobalt oxide is reduced. A smooth surface of the lithium cobalt oxide in this specification and the like refers to a state where a particle of the lithium cobalt oxide has little unevenness on its surface and is rounded as a whole and its corner portion is rounded. A smooth surface also refers to a surface to which few foreign matters are attached. Foreign matters are deemed to cause unevenness and are preferably not attached to a surface.

For the initial heating, a lithium source, an additive element source, or a material functioning as a fusing agent is not necessarily separately prepared.

When the heating time in this step is too short, an efficient effect is not obtained, but when the heating time in this step is too long, the productivity is lowered. For an appropriate range of heating time, for example, any of the heating conditions described in Step S13 can be selected. The heating temperature in Step S15 is preferably lower than that in Step S13 so that the crystal structure of the composite oxide is maintained. The heating time in Step S15 is preferably shorter than that in Step S13 so that the crystal structure of the composite oxide is maintained. For example, the heating is preferably performed at higher than or equal to 700° C. and lower than or equal to 1000° C. (further preferably higher than or equal to 800° C. and lower than or equal to 900° C.) for longer than or equal to 1 hour and shorter than or equal to 20 hours (further preferably longer than or equal to 1 hour and shorter than or equal to 5 hours).

The heating in Step S13 might cause a temperature difference between the surface and the inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, it can be said that the surface of the lithium cobalt oxide becomes smooth, i.e., surface improvement is achieved. That is, performing Step S15 can reduce the differential shrinkage caused in the lithium cobalt oxide to make the surface of the composite oxide smooth.

Such differential shrinkage might cause a micro shift in the lithium cobalt oxide such as a shift in a crystal. To reduce this shift, Step S15 is preferably performed. Performing Step S15 can distribute a shift uniformly in the composite oxide (reduce the shift in a crystal or the like which is caused in the composite oxide or align crystal grains). As a result, the surface of the composite oxide becomes smooth.

Note that pre-synthesized lithium cobalt oxide with a median diameter (D50) of less than or equal to 12 μm, preferably less than or equal to 10 μm, further preferably less than or equal to 8 μm may be used in Step S10 as described above. In this case, Steps S11 to S13 can be skipped. Performing Step S15 on the pre-synthesized lithium cobalt oxide is useful and Step S15 is a step suitable for obtaining a smooth surface of lithium cobalt oxide.

Note that Step S15 is not essential in one embodiment of the present invention; thus, an embodiment in which Step S15 is skipped is also included in one embodiment of the present invention.

The positive electrode active material of one embodiment of the present invention preferably contains an additive element A. A method for adding the additive element A through the following steps is described.

### <Step S20>

Next, details of Step S20 of preparing the additive element A as an A source is described with reference to FIGS. 1C and 1D.

### <Step S21>

Step S20 shown in FIG. 1C includes Steps S21 to S23. In Step S21, the additive element A is prepared. Specific examples of the additive element A include one or more selected from magnesium, fluorine, nickel, aluminum, titanium, zirconium, vanadium, iron, manganese, chromium, niobium, arsenic, zinc, silicon, sulfur, phosphorus, boron, barium, bromine, and beryllium. FIG. 1C shows the case where a magnesium source (Mg source) and a fluorine source (F source) are prepared. Note that in Step S21, a lithium source may be separately prepared in addition to the additive element A.

When magnesium is selected as the additive element A, an additive element A source can be referred to as a magnesium source. As the magnesium source, magnesium fluoride (MgF₂), magnesium oxide (MgO), magnesium hydroxide (Mg(OH)₂), magnesium carbonate (MgCO₃), or the like can be used. Two or more of these magnesium sources may be used.

When fluorine is selected as the additive element A, an additive element A source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating process described later owing to its relatively low melting point of 848° C.

Magnesium fluoride can be used as both the fluorine source and the magnesium source. Lithium fluoride can be used also as a lithium source. As the lithium source that can be used in Step S21, lithium carbonate can be given.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), or the like may be used and mixed in the atmosphere in a heating step described later. Two or more of these fluorine sources may be used.

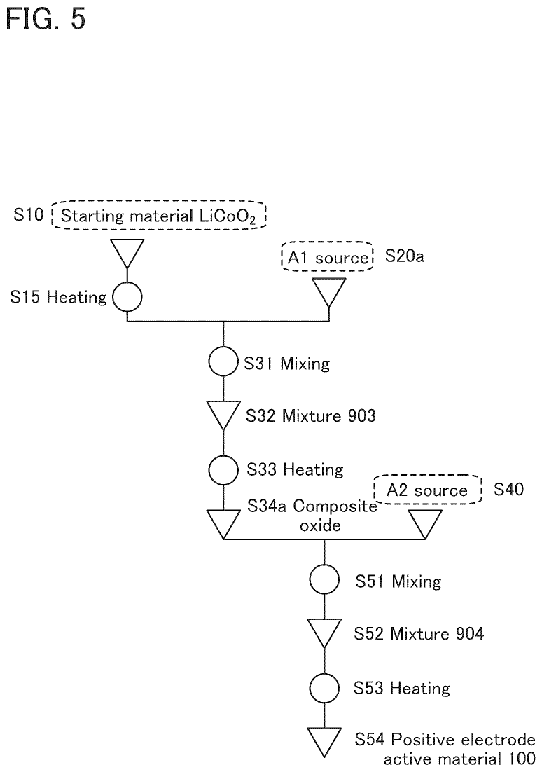

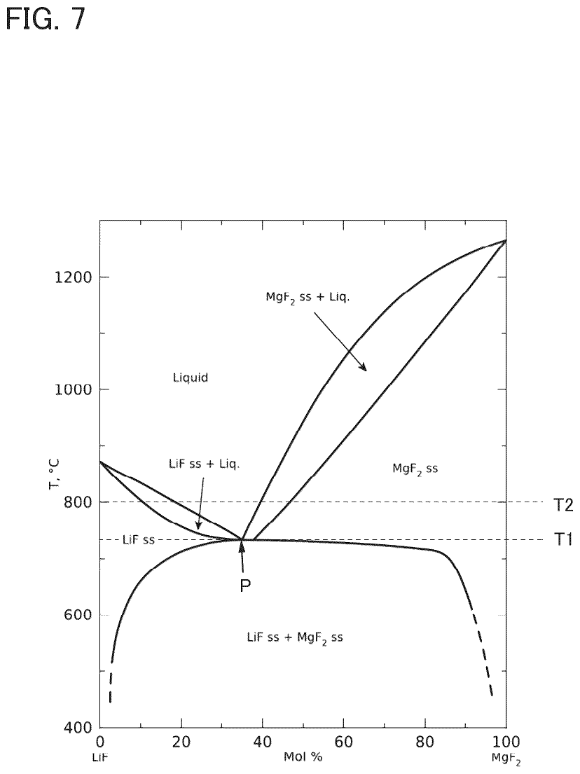

In this embodiment, lithium fluoride (LiF) is prepared as the fluorine source, and magnesium fluoride (MgF₂) is prepared as the fluorine source and the magnesium source. A fluorine compound (sometimes also referred to as fluoride) such as lithium fluoride that has a lower melting point than another additive element source can serve as a fusing agent (also referred to as a flux) for lowering the melting point of the other additive element source. In the case where the fluorine compound contains LiF and MgF₂, the eutectic point P of LiF and MgF₂ is around 742° C. (T1) as shown in FIG. 7 (cited from FIG. 5 of Non-Patent Document 1 and retouched). Thus, in the case where mixed fluoride that contains LiF and MgF₂ as fluoride is used as an additive element source, the heating temperature in the heating step following the mixing of the additive element is preferably set higher than or equal to 742° C.

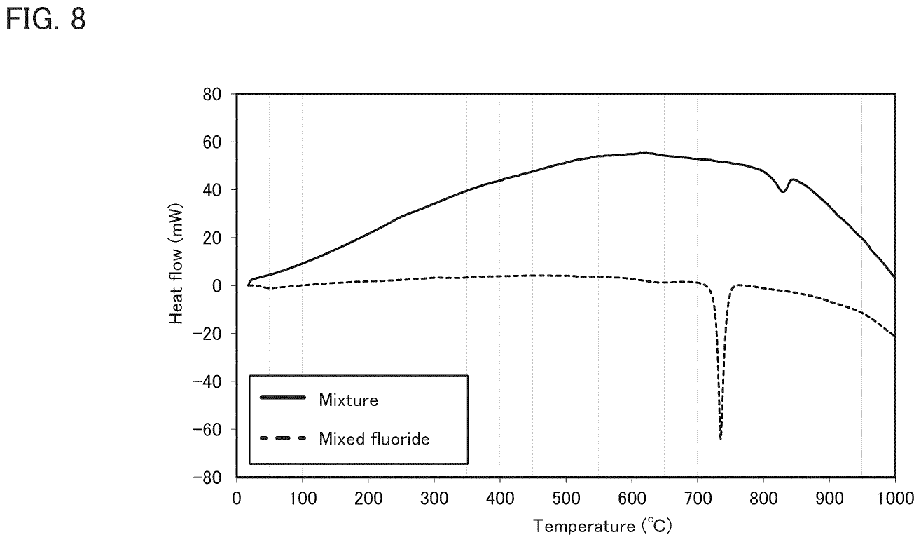

Here, differential scanning calorimetry measurement (DSC measurement) of mixed fluoride and a mixture is described with reference to FIG. 8. In FIG. 8, the curve denoted by mixed fluoride is a DSC measurement result of a mixture of LiF and MgF₂. LiF and MgF₂ are mixed in a molar ratio of LiF:MgF₂=1:3 to form the mixed fluoride. In FIG. 8, the curve denoted by mixture is a DSC measurement result of a mixture of lithium cobalt oxide, LiF, and MgF₂. Lithium cobalt oxide, LiF, and MgF₂ are mixed in a molar ratio of LiCoO₂:LiF:MgF₂=100:0.33:1 to form the mixture.

As shown in FIG. 8, the endothermic peak of the mixed fluoride is observed at around 735° C. The endothermic peak of the mixture is observed at around 830° C. Thus, the temperature of the heating (e.g., Step S33 to be described later) following the mixing of the additive element is preferably higher than or equal to 742° C., further preferably higher than or equal to 830° C. Alternatively, the temperature of the heating may be higher than or equal to 800° C. (T2 in FIG. 7), which is between the above temperatures.

In this embodiment, lithium fluoride (LiF) is prepared as the fluorine source, and magnesium fluoride (MgF₂) is prepared as the fluorine source and the magnesium source. When lithium fluoride (LiF) and magnesium fluoride (MgF₂) are mixed at a molar ratio of approximately 65:35, the effect of lowering the melting point is maximized. When the proportion of lithium fluoride is too high, the cycle performance might deteriorate because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that unless otherwise specified, the expression “an approximate value of a given value” in this specification and the like means greater than 0.9 times and smaller than 1.1 times the given value.

### <Step S22>

Next, in Step S22 shown in FIG. 1C, the magnesium source and the fluorine source are ground and mixed. Any of the conditions for the grinding and mixing that are described for Step S12 can be selected to perform Step S22.

### <Step S23>

Next, in Step S23 shown in FIG. 1C, the materials ground and mixed in the above step are collected to give the additive element A source (A source). Note that the additive element A source in Step S23 contains a plurality of starting materials and can also be referred to as a mixture.

As for the particle diameter of the mixture, its median diameter (D50) is preferably greater than or equal to 100 nm and less than or equal to 10 μm, further preferably greater than or equal to 300 nm and less than or equal to 5 μm. Also when one kind of material is used as the additive element A source, the median diameter (D50) is preferably greater than or equal to 100 nm and less than or equal to 10 μm, further preferably greater than or equal to 300 nm and less than or equal to 5 μm.

Such a pulverized mixture in Step S22 (which may contain only one kind of additive element) is easily attached to the surface of lithium cobalt oxide uniformly in a later step of mixing with the lithium cobalt oxide. The mixture is preferably attached uniformly to the surface of the lithium cobalt oxide, in which case an additive element is easily distributed or dispersed uniformly in the surface portion 100a of the composite oxide after heating.

### <Step S21>

A process different from that in FIG. 1C is described with reference to FIG. 1D. Step S20 shown in FIG. 1D includes Steps S21 to S23.

In Step S21 shown in FIG. 1D, four kinds of additive element A sources to be added to the lithium cobalt oxide are prepared. In other words, FIG. 1D is different from FIG. 1C in the kinds of the additive element A sources. A lithium source may be separately prepared in addition to the additive element A sources.

As the four kinds of additive element A sources, a magnesium source (Mg source), a fluorine source (F source), a nickel source (Ni source), and an aluminum source (Al source) are prepared. The magnesium source and the fluorine source can be selected from the compounds and the like described with reference to FIG. 1C. As the nickel source, nickel oxide, nickel hydroxide, or the like can be used. As the aluminum source, aluminum oxide, aluminum hydroxide, or the like can be used.

### <Step S22> and <Step S23>

Next, Steps S22 and S23 shown in FIG. 1D are similar to Steps S22 and S23 described with reference to FIG. 1C.

### <Step S31>

Next, in Step S31 shown in FIG. 1A, the lithium cobalt oxide obtained through Step S15 (initial heating) and the additive element A source (A source) are mixed. Here, the atomic ratio of cobalt Co in the lithium cobalt oxide obtained through Step S15 to magnesium Mg in the additive element A (Co:Mg) is preferably 100:y (0.1≤y≤6), further preferably 100:y (0.3≤y≤3). When the additive element A is added to the lithium cobalt oxide that has been subjected to the initial heating, the additive element A can be uniformly added. Thus, the initial heating (Step S15) is preferably performed not after the addition of the additive element A but before the addition of the additive element A.

When nickel is selected as the additive element A, the mixing in Step S31 is preferably performed such that the number of nickel atoms in the nickel source is greater than or equal to 0.05% and less than or equal to 4% of the number of cobalt atoms in the lithium cobalt oxide obtained through Step S15. When aluminum is selected as the additive element A, the mixing in Step S31 is preferably performed such that the number of aluminum atoms in the aluminum source is greater than or equal to 0.05% and less than or equal to 4% of the number of cobalt atoms in the lithium cobalt oxide obtained through Step S15.

The mixing in Step S31 is preferably performed under milder conditions than the grinding and mixing in Step S12, in order not to damage the shape of the lithium cobalt oxide. For example, a condition with a smaller number of rotations or a shorter time than that for the mixing in Step S12 is preferable. Furthermore, the mixing is preferably dry mixing. For example, a particle composing apparatus, a ball mill, or a bead mill can be used for the mixing.

As the particle composing apparatus, commercially available apparatuses such as Mechanofusion (registered trademark) and Nobilta (registered trademark) produced by Hosokawa Micron Ltd. are known. Mechanofusion includes a fixed blade in a cylindrical container, and can supply mechanical energy to powder and mix it by rotation of the cylindrical container. Moreover, Nobilta includes a rotating blade in a cylindrical container, and can supply mechanical energy to powder and mix it by rotation of the blade. In this embodiment, mixing is performed with Nobilta at 3000 rpm for 10 minutes.

### <Step S32>

Next, in Step S32 in FIG. 1A, the materials mixed in the above step are collected, whereby a mixture 903 is obtained. At the time of the collection, the materials may be crushed as needed and made to pass through a sieve.

### <Step S33>

Next, in Step S33 shown in FIG. 1A, the mixture 903 is heated. The heating temperature in Step S33 is preferably higher than or equal to 800° C. and lower than or equal to 1100° C., further preferably higher than or equal to 800° C. and lower than or equal to 950° C., still further preferably higher than or equal to 850° C. and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements included in the lithium cobalt oxide and the additive element A source occurs, and may be lower than the melting temperatures of these materials. In the case where an oxide is described as an example, solid phase diffusion occurs at the Tamman temperature T_{d} (0.757 times the melting temperature Tₘ); thus, the heating temperature in Step S33 is higher than or equal to 500° C.

Note that the reaction more easily proceeds at a temperature higher than or equal to the temperature at which one or more selected from the materials contained in the mixture 903 are melted. For example, in the case where LiF and MgF₂ are included in the additive element A source, the lower limit of the heating temperature in Step S33 is preferably higher than or equal to 742° C. because the eutectic point of LiF and MgF₂ is around 742° C. as described above.

The mixture 903 obtained by mixing such that LiCoO₂:LiF:MgF₂=100:0.33:1 (molar ratio) exhibits an endothermic peak at around 830° C. in differential scanning calorimetry (DSC) measurement as described above. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of the lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to the material functioning as a fusing agent, the heating temperature can be lower than the decomposition temperature of the lithium cobalt oxide, e.g., higher than or equal to 742° C. and lower than or equal to 950° C., which allows distribution of the additive element such as magnesium in the surface portion and formation of a positive electrode active material having favorable characteristics.

Since LiF in a gas phase has a specific gravity less than that of oxygen, heating might volatilize or sublimate LiF and, which might decrease LiF in the mixture 903. In this case, the function of a fusing agent deteriorates. Accordingly, heating is preferably performed while volatilization or sublimation of LiF is inhibited.

In view of this, the mixture 903 is preferably heated in an atmosphere containing LiF, i.e., the mixture 903 is preferably heated in a state where the partial pressure of LiF in a heating furnace is high. Such heating can inhibit volatilization or sublimation of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the additive element (e.g., fluorine), thereby hindering distribution of the additive element (e.g., magnesium and fluorine) in the surface portion.

Uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

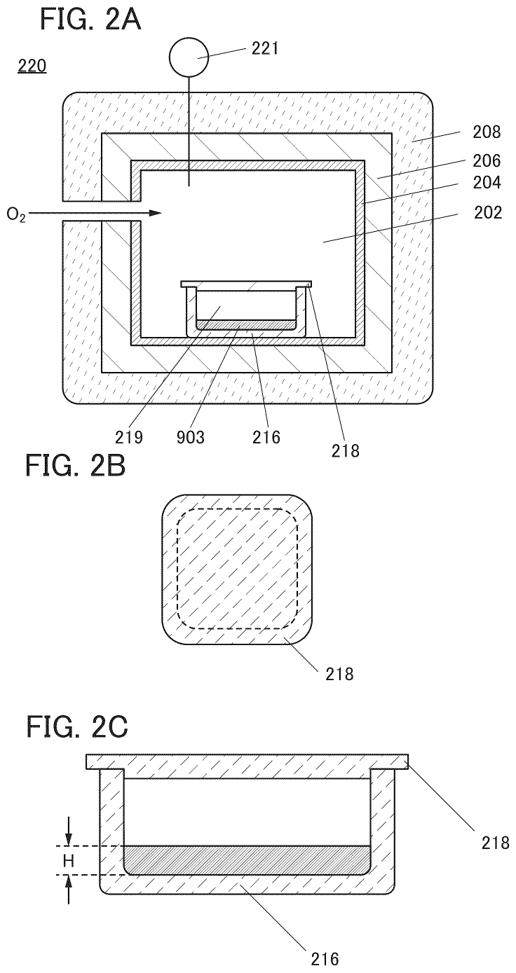

FIG. 2A illustrates an example of the case where Step S33 is performed in a heating furnace.

A heating furnace 220 illustrated in FIG. 2A includes a space 202 in the heating furnace, a hot plate 204, a pressure gauge 221, a heater unit 206, and a heat insulator 208. As a setter for holding an object to be heated, a container 216 and a lid 218 are shown, and heating is preferably performed with the container 216 covered with the lid 218. FIG. 2B is a top view of the lid 218, and FIG. 2C is a cross-sectional schematic view of the container 216 and the lid 218. An airtight space is formed only by putting the lid 218 on the container 216 and thus the container is not completely sealed; accordingly, the pressure in the container does not become abnormally high, which is safe. Since the additive element A source (typically, fluoride) is added to the container 216 in advance, the atmosphere in a space 219 formed by the container 216 and the lid 218 can be a fluoride-containing atmosphere. During the heating, the state of the space 219 is maintained with the lid put on the container such that the concentration of the gasified fluoride inside the space 219 is constant or is not reduced, in which case the additive element A, such as fluorine and magnesium, can be contained in the vicinity of the particle surface of the mixture 903. The atmosphere in the space 219, which is smaller in capacity than the space 202 in the heating furnace, can contain fluoride through volatilization of a smaller amount of fluoride. This means that the atmosphere in the reaction system can be a fluoride-containing atmosphere without a significant reduction in the amount of fluoride included in the mixture 903. In addition, the use of the lid 218 allows heating of the mixture 903 in a fluoride-containing atmosphere to be simply and inexpensively performed.

Thus, before the heating in the space 202 in the heating furnace is performed, the step of providing an atmosphere containing oxygen in the space 202 in the heating furnace and the step of placing the container 216 in which the mixture 903 is placed in the space 202 in the heating furnace are performed. The steps in this order enable the mixture 903 to be heated in an atmosphere containing oxygen and a fluoride. For example, flowing of a gas is performed during the heating (flowing). The gas can be introduced from below the space 202 in the heating furnace and exhausted to above the space 202 in the heating furnace. During the heating, the space 202 in the heating furnace may be sealed off to be a closed space so that the gas is not transferred to the outside (purging).

Although there is no particular limitation on a method for providing an atmosphere containing oxygen in the space 202 in the heating furnace, examples of the method include a method in which air is exhausted from the space 202 in the heating furnace and an oxygen gas or a gas containing oxygen such as dry air is then introduced, and a method in which an oxygen gas or a gas containing oxygen such as dry air is fed into the space 202 in the heating furnace for a certain period of time. In particular, introducing an oxygen gas after exhausting air from the space 202 in the heating furnace (oxygen replacement) is preferably performed. Note that the air in the space 202 in the heating furnace may be regarded as an atmosphere containing oxygen.

Alternatively, the additive element A source (typically, fluoride) that has been immersed in the inner walls of the container 216 and the lid 218 can be fluttered again by the heating to be attached to the mixture 903.

There is no particular limitation on the step of heating the heating furnace 220. The heating may be performed using a heating mechanism included in the heating furnace 220.

The conditions for holding the mixture 903 in the container 216 are described with reference to FIG. 2C. As illustrated in FIG. 2C, the mixture 903 is preferably held such that the top surface of the mixture 903 is flat with respect to the bottom surface of the container 216, in other words, the level H of the top surface of the mixture 903 is uniform. The level H of the top surface of the mixture 903 is preferably lower than or equal to 4.0 mm, further preferably lower than or equal to 2.0 mm. When the above condition is employed as the level H of the top surface of the mixture 903, oxygen in the atmosphere can reach the mixture 903 near the bottom surface of the container 216. By contrast, when the level H of the top surface of the mixture 903 is higher than 4.0 mm, the amount of oxygen reaching the mixture 903 near the bottom surface of the container 216 is insufficient, which degrades the battery characteristics of a battery including the positive electrode active material obtained through the step. When the level H of the top surface of the mixture 903 is too low, the amount of the mixture 903 that can be held in the container 216 is reduced, resulting in a reduction in productivity. Thus, the level H of the top surface of the mixture 903 is preferably greater than or equal to 0.5 mm or greater than or equal to 1.0 mm. From the above description, the level H of the top surface of the mixture 903 is preferably greater than or equal to 0.5 mm and lower than or equal to 4.0 mm, further preferably greater than or equal to 1.0 mm and lower than or equal to 2.0 mm.

The heating in Step S33 described above is preferably performed with the pressure in the furnace controlled using the pressure gauge 221. The furnace is preferably in an atmospheric pressure state or a pressurized state. Under pressure, for example, the surface of lithium cobalt oxide is probably likely to be melted. Accordingly, the surface of lithium cobalt oxide heated together with LiF and MgF₂ may be melted under pressure.

In addition, at the time of heating the mixture 903, the partial pressure of fluorine or a fluorine compound originating from the fluorine source or the like is preferably controlled to be within an appropriate range. The partial pressure can be controlled by performing the heating in this step with the container covered with the lid. Note that as described above, volatilization or sublimation of a material can be prevented with the lid.

In the formation method described in this embodiment, a material of the additive element A source (typically fluoride), e.g., LiF as the fluorine source, function as a fusing agent in some cases. Owing to the material functioning as a fusing agent, the heating temperature can be lower than the decomposition temperature of the lithium cobalt oxide, e.g., higher than or equal to 742° C. and lower than or equal to 950° C., which allows distribution of the additive element such as magnesium in the surface portion and formation of a positive electrode active material having favorable characteristics.

However, since LiF in a gas phase has a specific gravity less than that of oxygen, the heating might volatilize or sublimate LiF. In the case where LiF is volatilized, LiF in the mixture 903 decreases. As a result, the function of a fusing agent is degraded. Therefore, the heating needs to be performed while volatilization of LiF is inhibited. Note that even when LiF is not used as the fluorine source or the like, Li at the surface of lithium cobalt oxide and F of the fluorine source might react to produce LiF, which might be volatilized. Therefore, such inhibition of volatilization is needed also when a fluorine compound having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903. The container that is a setter is preferably covered with the lid to inhibit volatilization of LiF. Since the container that is a setter and the lid are exposed to high temperatures, the gap between the container used as a setter and the lid might be increased when the materials of the container and the lid have different thermal expansion coefficients. Therefore, the container that is a setter and the lid are preferably made of the same material.

### <Roller Hearth Kiln>

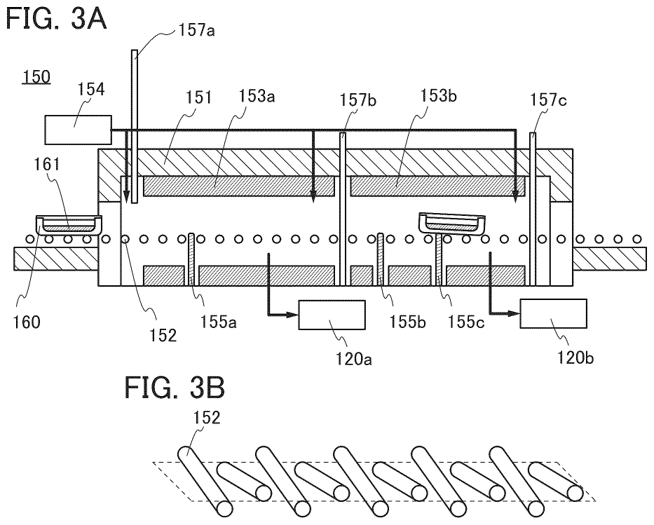

The manufacturing apparatus of one embodiment of the present invention may be a roller hearth kiln in which an object held in a container is successively processed. FIG. 3A is a schematic cross-sectional diagram of a roller hearth kiln 150. FIG. 3B illustrates rollers 152 included in the roller hearth kiln.

The roller hearth kiln 150 includes a kiln main body 151, the plurality of rollers 152, a heating unit 153a, a heating unit 153b, an atmosphere control unit 154, an adhesion preventing unit 155a, an adhesion preventing unit 155b, and an adhesion preventing unit 155c. The roller hearth kiln 150 preferably includes a measurement device 120a, a measurement device 120b, and at least one blocking board 157. FIG. 3A illustrates an example in which three blocking boards 157 (denoted as a blocking board 157a, a blocking board 157b, and a blocking board 157c) are included.

The kiln main body 151 has a tunnel-like shape. The plurality of rollers 152 have a function of transferring a container 160 containing an object to be heated 161. The plurality of rollers 152 make the container 160 pass through the tunnel-like kiln main body 151 to transfer it to the outside. Note that the description of the container 216 and the mixture 903 described with reference to FIG. 2C can be referred to for the container 160 and the object to be heated 161. That is, the level of the top surface of the object to be heated 161 held in the container 160 with respect to the bottom surface of the container 160 is preferably greater than or equal to 0.5 mm and less than or equal to 4.0 mm, further preferably greater than or equal to 1.0 mm and less than or equal to 2.0 mm.

The kiln main body 151 includes the upstream portion and the downstream portion along the transfer direction of the plurality of rollers 152. The kiln main body 151 includes the heating unit 153a in the upstream portion, and the heating unit 153b in the downstream portion. The blocking board 157b may be provided between the upstream portion and the downstream portion. By providing the blocking board 157b, the atmospheres in the upstream portion and the atmosphere in the downstream portion can be independently controlled. The blocking board 157b may be provided near the inlet of the kiln main body 151, and the blocking board 157c may be provided near the outlet. The provision of these facilitates control of the atmosphere inside the kiln main body 151.

The adhesion preventing unit 155 included in the roller hearth kiln 150 is, for example, a unit which vibrates the container 160. For example, the adhesion preventing unit may be a rod-like or a plate-like device provided between the plurality of rollers 152, like the three adhesion preventing units (the adhesion preventing unit 155a, the adhesion preventing unit 155b, and the adhesion preventing unit 155c) shown in FIG. 3A. The adhesion preventing unit 155a, the adhesion preventing unit 155b, and the adhesion preventing unit 155c may be fixed, or may be unfixed so as to vibrate the container 160. Although FIG. 3A shows the structure in which three adhesion preventing units 155 are provided, one embodiment of the present invention is not limited to this. The number of provided adhesion preventing units 155 may be one or two, or four or more.

The adhesion preventing unit included in the roller hearth kiln 150 may be the plurality of rollers 152 having different inclinations as shown in FIG. 3B.

For the heating units 153a and 153b, the atmosphere control unit 154, and the like, the description relating to FIG. 3A can be referred to. For the measurement device 120a and the measurement device 120b, the description relating to FIG. 3A can be referred to.

The roller hearth kiln 150 is preferable because the object is successively processed and thus the productivity is increased.

### <Cooling Unit of Roller Hearth Kiln>

A cooling unit may be provided in the roller hearth kiln.

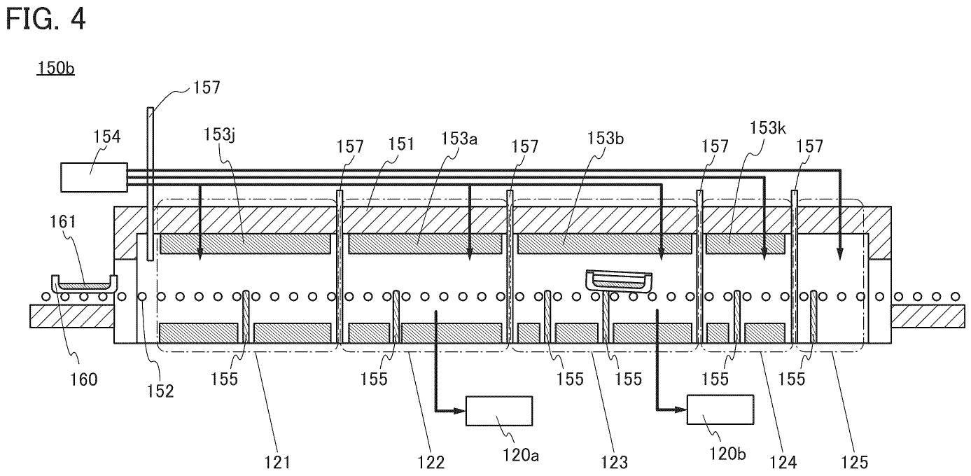

A roller hearth kiln 150b illustrated in FIG. 4 as an example includes a temperature rising zone 121, a first cooling zone 124, and a second cooling zone 125 in addition to the components of the roller hearth kiln 150 illustrated in FIG. 3A. A region which is positioned on the upstream side and heated by the heating unit 153a is referred to as a first retention zone 122, and a region which is positioned on the downstream side and heated by the heating unit 153b is referred to as a second retention zone 123.

The atmosphere control unit 154 preferably has a function of controlling the atmospheres of five zones (the temperature rising zone 121, the first retention zone 122, the second retention zone 123, the first cooling zone 124, and the second cooling zone 125). The respective gases are introduced to the five zones from the atmosphere control unit 154, for example. The kinds, temperatures, flow rates, and the like of the gases introduced to the five zones from the atmosphere control unit 154 may be different from one another.

Although FIG. 4 illustrates an example in which the five zones are separated by the blocking boards 157, a structure in which the blocking board is not provided between adjacent zones may be employed. For example, a structure in which a blocking board is not provided between the temperature rising zone 121 and the first retention zone 122 may be employed. For another example, a structure in which a blocking board is not provided between the first cooling zone and the second cooling zone may be employed.

The temperature rising zone 121 includes a heating unit 153j. Here, the temperature of the heating unit 153j preferably differs between the regions. For example, the temperature preferably increases gradually from the upstream side toward the downstream side. Specifically, a structure may be employed in which, for example, the heating unit 153j includes a plurality of blocks, a heater is provided in each block, and the temperature of the heater is increased sequentially from the blocks on the upstream side toward the blocks on the downstream side.

The first cooling zone 124 includes a heating unit 153k. Here, the heating unit 153k may have different temperatures depending on the region. For example, the temperature may decrease gradually from the upstream side toward the downstream side. Specifically, for example, the heating unit 153j includes a plurality of blocks, a heater is provided in each block, and the temperature of the heater is decreased sequentially from the blocks on the upstream side toward the blocks on the downstream side.

The second cooling zone 125 is a region at room temperature, for example. The temperature decreasing rate can be increased by cooling at room temperature.

In the first cooling zone 124 and the second cooling zone 125, cooling may be performed using cooling water. The use of cooling water can increase the temperature decreasing rate.

Note that in the roller hearth kiln of one embodiment of the present invention, either the first cooling zone 124 or the second cooling zone 125 may be omitted.

For example, with the structure where the second retention zone 123 and the second cooling zone are adjacent to each other without providing the first cooling zone 124, the temperature decreasing rate can be increased by performing cooling at room temperature immediately after the step for retaining temperature.

As the heating units 153j and 153k, a silicon carbide heater, a carbon heater, a metal heater, a molybdenum disilicide heater, or the like can be used, for example.

### <Step S34>

Next, the heated material is collected in Step S34 shown in FIG. 1A, in which crushing is performed as needed; thus, the positive electrode active material 100 is obtained. Here, the collected particles of the positive electrode active material 100 are preferably made to pass through a sieve. Through the above process, the positive electrode active material 100 (composite oxide) with a median diameter (D50) of less than or equal to 12 μm (preferably less than or equal to 10.5 μm, further preferably less than or equal to 8 μm) can be formed. Note that the positive electrode active material 100 contains the additive element A.

### Example 2 of Formation Method of Positive Electrode Active Material

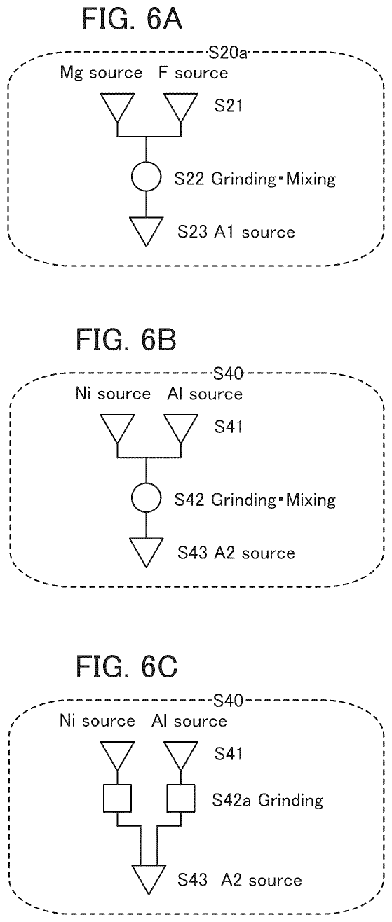

Another example of a formation method of a positive electrode active material of one embodiment of the present invention (Example 2 of formation method of positive electrode active material) is described with reference to FIG. 5 and FIGS. 6A to 6C. Although <Example 2 of formation method of positive electrode active material> is different from <Example 1 of formation method of positive electrode active material> above in the number of times of adding the additive element and a mixing method, for the description except for the above, the description of <Example 1 of formation method of positive electrode active material> can be referred to.

Steps S10 and S15 in FIG. 5 are performed as in FIG. 1A to prepare lithium cobalt oxide that has been subjected to the initial heating. Note that Step S15 is not essential in one embodiment of the present invention; thus, an embodiment in which Step S15 is skipped is also included in one embodiment of the present invention.

### <Step S20a>

Next, as shown in Step S20a, a first additive element A1 source (A1 source) is prepared. Details of Step S20a is described with reference to FIG. 6A.

### <Step S21>

In Step S21 shown in FIG. 6A, the first additive element A1 source (A1 source) is prepared. For the A1 source, any of the additive elements A described for Step S21 with reference to FIG. 1C can be used. For example, one or more elements selected from magnesium, fluorine, and calcium can be used as the additive element A1 source. FIG. 6A shows an example of using a magnesium source (Mg source) and a fluorine source (F source) as the additive element A1 source.

Steps S21 to S23 shown in FIG. 6A can be performed under conditions similar to those of Steps S21 to S23 shown in FIG. 1C, whereby the additive element A1 source (A1 source) can be obtained in Step S23.

Steps S31 to S33 shown in FIG. 5 can be performed under conditions similar to those of Steps S31 to S33 shown in FIG. 1A.

### <Step S34a>

Next, the material heated in Step S33 is collected to obtain lithium cobalt oxide containing the additive element A1. Here, the composite oxide is called a second composite oxide to be distinguished from the lithium cobalt oxide obtained through Step S15 (first composite oxide).

### <Step S40>

In Step S40 shown in FIG. 5, a second additive element A2 source (A2 source) is prepared. Step S40 is described with reference to FIGS. 6B and 6C.

### <Step S41>

In Step S40 shown in FIG. 6B, the second additive element A2 source (A2 source) is prepared. For the A2 source, any of the additive elements A described for Step S20 with reference to FIG. 1C can be used. For example, one or more elements selected from nickel, titanium, boron, zirconium, and aluminum can be suitably used as the additive element A2 source. FIG. 6B shows an example of using a nickel source (Ni source) and an aluminum source (A1 source) as the additive element A2 source.

Steps S41 to S43 shown in FIG. 6B can be performed under conditions similar to those of Steps S21 to S23 shown in FIG. 1C, whereby the additive element A2 source (A2 source) can be obtained in Step S43.

FIG. 6C showing Steps S41 to S43 is a variation example of FIG. 6B. A nickel source (Ni source) and an aluminum source (A1 source) are prepared in Step S41 shown in FIG. 6C and are separately ground in Step S42a. Accordingly, a plurality of second additive element A2 sources (A2 sources) are prepared in Step S43. As described above, Step S40 in FIG. 6C is different from Step S40 in FIG. 6B in that the additive element sources are separately ground in Step S42a.

### <Steps S51 to S53>

Next, Steps S51 to S53 shown in FIG. 5 can be performed under conditions similar to those of Steps S31 to S33 shown in FIG. 1A. The heating temperature in Step S53 of performing heating is preferably equal to or lower than the heating temperature in Step S33 shown in FIG. 5. The heating time in Step S53 is preferably shorter than that in Step S33. Specifically, the heating is preferably performed at higher than or equal to 800° C. and lower than or equal to 950° C., further preferably at higher than or equal to 820° C. and lower than or equal to 870° C., still further preferably at 850° C.±10° C. The heating time is preferably longer than or equal to 0.5 hours and shorter than or equal to 8 hours, further preferably longer than or equal to 1 hour and shorter than or equal to 5 hours.

When nickel is selected as the additive element A2, the mixing in Step S51 is preferably performed such that the number of nickel atoms in the nickel source is greater than or equal to 0.05% and less than or equal to 4% of the number of cobalt atoms in the lithium cobalt oxide obtained through Step S15. When aluminum is selected as the additive element A2, the mixing in Step S51 is preferably performed such that the number of aluminum atoms in the aluminum source is greater than or equal to 0.05% and less than or equal to 4% of the number of cobalt atoms in the lithium cobalt oxide obtained through Step S15.

### <Step S54>

Next, the heated material is collected in Step S54 shown in FIG. 5, in which crushing is performed as needed; thus, the positive electrode active material 100 is obtained. Through the above process, the positive electrode active material 100 (composite oxide) with a median diameter (D50) of less than or equal to 12 μm (preferably less than or equal to 10.5 μm, further preferably less than or equal to 8 μm) can be formed. Alternatively, the positive electrode active material 100 applicable to a lithium-ion battery having excellent charge and discharge characteristics even in a low-temperature environment can be formed. Note that the positive electrode active material 100 contains the additive elements A1 and A2.

As shown in FIG. 5 and FIGS. 6A to 6C, in Example 2 of the formation method above, introduction of the additive element to the lithium cobalt oxide is separated into introduction of the first additive element A1 and that of the second additive element A2. When the elements are separately introduced, the additive elements can be at different concentration distributions in the depth direction.

The contents in this embodiment can be freely combined with the contents in any of the other embodiments.

### Embodiment 2

In this embodiment, a lithium-ion battery having excellent charge and discharge characteristics even in a low-temperature environment is described.

### [Lithium-Ion Battery]

A lithium-ion battery of one embodiment of the present invention includes a positive electrode, a negative electrode, and an electrolyte solution. A separator is included between the positive electrode and the negative electrode. The lithium-ion battery further includes an exterior body for holding the positive electrode, the negative electrode, the electrolyte solution, and the like. Although a method for fabricating a lithium-ion battery is described in this embodiment, the order of forming the positive electrode, the negative electrode, and the electrolyte solution is not limited to the order described in this embodiment.

In this embodiment, description is made focusing on the structure of a lithium-ion battery required to achieve a lithium-ion battery with excellent charge and discharge characteristics even in a low-temperature environment (e.g., 0° C., −20° C., preferably −30° C., further preferably −40° C.). Specifically, a positive electrode active material that is contained in the positive electrode, a negative electrode active material layer, and the electrolyte solution are mainly described.

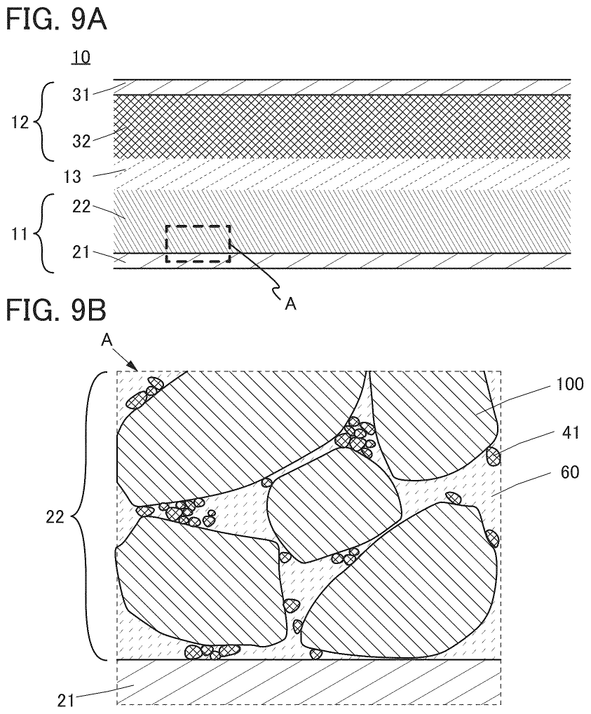

FIG. 9A is a schematic cross-sectional view illustrating an inner structure of a battery 10. The battery 10 includes a positive electrode 11, a negative electrode 12, and a separator 13. The positive electrode 11 includes a positive electrode current collector 21 and a positive electrode active material layer 22 over the positive electrode current collector 21, and the negative electrode 12 includes a negative electrode current collector 31 and a negative electrode active material layer 32. As illustrated, the positive electrode active material layer 22 and the negative electrode active material layer 32 are provided to face each other with the separator 13 therebetween. Although not illustrated in FIG. 9A, a space included in the positive electrode active material layer 22, a space included in the separator 13, and a space included in the negative electrode active material layer 32 are impregnated with the electrolyte solution.

FIG. 9B is an enlarged view illustrating a portion A surrounded by a dashed line in FIG. 9A.

The positive electrode active material layer 22 contains a positive electrode active material 100 and a conductive material 41. Although not illustrated, the positive electrode active material layer 22 may include a binder other than the positive electrode active material 100 and the conductive material 41.

The space included in the positive electrode active material layer 22 is preferably filled with an electrolyte solution 60 as illustrated. For example, the proportion of the space included in the positive electrode active material layer 22 filled with the electrolyte solution 60 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the space included in the positive electrode active material layer 22 refers to a region other than a solid component (e.g., a positive electrode active material or a conductive material) in the positive electrode active material layer 22.

Although detailed descriptions are omitted, the space included in the negative electrode active material layer 32 is preferably filled with the electrolyte solution 60 as in the case of the positive electrode active material layer 22. For example, the proportion of the space included in the negative electrode active material layer 32 filled with the electrolyte solution 60 is preferably higher than or equal to 60%, further preferably higher than or equal to 70%, still further preferably higher than or equal to 80%, yet further preferably higher than or equal to 90%, yet still further preferably higher than or equal to 95%, most preferably higher than or equal to 99%. Note that the space included in the negative electrode active material layer 32 refers to a region other than a solid component (e.g., a negative electrode active material or a conductive material) in the negative electrode active material layer 32.

By filling with the electrolyte solution 60 throughout the positive electrode active material layer 22 and the negative electrode active material layer 32 in this manner, a region where the electrolyte solution and each of the positive electrode active material and a negative electrode active material are in contact with each other can be increased. That is, a lithium-ion battery can have excellent charge characteristics and discharge characteristics in a low-temperature environment.

In charge at a low temperature, an energy barrier at the time of extracting lithium ions from a positive electrode active material tends to high. That is, it can be said that overvoltage required for extracting lithium ions from the positive electrode active material becomes larger as the temperature of charging environment becomes lower. That is, the positive electrode active material might be exposed to high voltage in charge at a low temperature. In other words, in charge at a low temperature, charge capacity might be decreased when the positive electrode active material is not exposed to high voltage.

Thus, a positive electrode active material that can withstand a high voltage and obtain high charge capacity in charge at a low temperature is preferably used for a positive electrode active material contained in a lithium-ion battery having excellent charge characteristics and discharge characteristics even in a low-temperature environment.

For an electrolyte contained in a lithium-ion battery having excellent charge characteristics and discharge characteristics in charge and/or discharge (charge and discharge) even in a low-temperature environment, a material with high lithium ion conductivity even in a low-temperature environment (e.g., 0° C., preferably −20° C., further preferably −30° C., still further preferably −40° C.) is preferably used.

A positive electrode active material and an electrolyte that are preferable for a lithium-ion battery having excellent charge characteristics and discharge characteristics even in a low-temperature environment are described in detail below.

### [Positive Electrode]

The positive electrode includes a positive electrode active material layer and a positive electrode current collector. The positive electrode active material layer contains a positive electrode active material and may further contain at least one of a conductive material and a binder.

### <Positive Electrode Active Material>

A positive electrode active material has functions of taking and releasing lithium ions in accordance with charge and discharge. For the positive electrode active material of one embodiment of the present invention, a material with less deterioration (or a material with slight increase in resistance) due to charge and/or discharge in a low-temperature environment even at high charge voltage (which is a voltage value with reference to a lithium metal unless otherwise specified) can be used. Specifically, a positive electrode active material (composite oxide) with a particle diameter (strictly, a median diameter (D50)) of less than or equal to 12 μm (preferably less than or equal to 10.5 μm, further preferably less than or equal to 8 μm) obtained by the formation method described in Embodiment 1 is preferably used. A positive electrode active material with a particle diameter greater than 12 μm and less than or equal to 20 μm may be used. This positive electrode active material is a material containing the additive element A described in Embodiment 1. In this embodiment, the additive element A is described in detail by being divided into an additive element X, an additive element Y, and an additive element Z. In other words, the positive electrode active material described in this embodiment contains one or more of the additive element X, the additive element Y, and the additive element Z. Details of the additive elements X, Y, and Z are described in <Contained element>. Note that the additive element X described in this embodiment corresponds to the additive element A1 described in Embodiment 1. The additive element Y and the additive element Z described in this embodiment correspond to the additive element A2 described in Embodiment 1.

The particle diameter can be measured with a particle size analyzer or the like using a laser diffraction and scattering method. The median diameter (D50) is a particle diameter when accumulation of particles accounts for 50% of a cumulative curve in a measurement result of the particle size distribution. The measurement of the size of a particle is not limited to laser diffraction particle size distribution measurement, and the major diameter of the cross section of the particle may be measured by scanning electron microscope (hereinafter referred to as SEM) analysis, transmission electron microscope (hereinafter referred to as TEM) analysis, or the like. Note that an example of a method for measuring the median diameter (D50) by SEM analysis, TEM analysis, or the like includes a method for measuring 20 or more particles to make a cumulative curve, and setting a particle diameter when the accumulation of particles accounts for 50% as the median diameter (D50).

The value of discharge capacity in a low-temperature environment, which is one of indices for evaluating low temperature characteristics, is preferably greater than or equal to 50% (further preferably greater than or equal to 60%, still further preferably greater than or equal to 70%, yet still further preferably greater than or equal to 80%, most preferably greater than or equal to 90%) of the value of discharge capacity at 20° C. Note that the above-described values are preferably obtained under the same measurement conditions except for the ambient temperature.

Alternatively, it is preferable to use a material with less deterioration (or a material with slight increase in resistance) due to charge and discharge even at a high charge voltage as the positive electrode active material, in which case the discharge capacity can be high even in a low-temperature environment.

Specifically, the discharge capacity under the condition where charge and discharge are performed at −40° C. is preferably greater than or equal to 60%, further preferably greater than or equal to 65%, still further preferably greater than or equal to 70%, yet further preferably greater than or equal to 75% of the discharge capacity under the condition where charge and discharge are performed at 25° C. Although the temperature employed here is −40° C., the temperature can be replaced with other low temperatures such as −20° C. or −30° C. As the above discharge condition, for example, discharge may be performed at a current rate of 0.1 C (1 C=200 mA/g (per weight of the positive electrode active material)). In the evaluation of the low temperature characteristics described above, the evaluation may be performed at a low rate as long as the measurement conditions except for the ambient temperature are the same.

The value of discharge energy density in a low-temperature environment, which is another index for evaluating low temperature characteristics, is preferably greater than or equal to 50% (further preferably greater than or equal to 60%, still further preferably greater than or equal to 70%, yet still further preferably greater than or equal to 80%, most preferably greater than or equal to 90%) of the value of discharge capacity at 20° C.

The ambient temperature described in this specification and the like refers to the temperature of a lithium-ion battery. In the measurement of the battery characteristics using a thermostatic bath, the ambient temperature can be regarded as the set temperature of the thermostatic bath. Thus, after a test cell to be measured (e.g., a test battery or a half cell) is provided in the thermostatic bath, a sufficient time (e.g., an hour or longer) break is preferably provided before the start of the measurement until the temperature of the test cell becomes substantially the same as the temperature in the thermostatic bath; however, the measurement is not necessarily limited to this method.

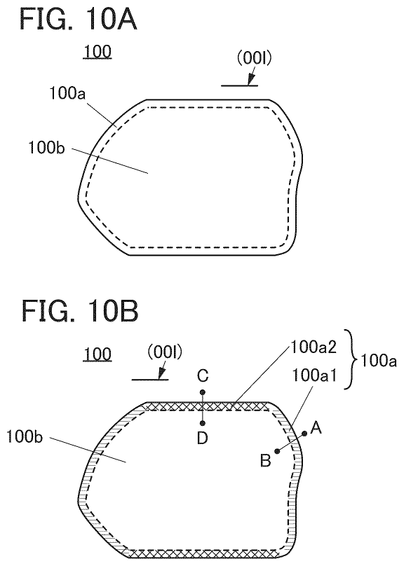

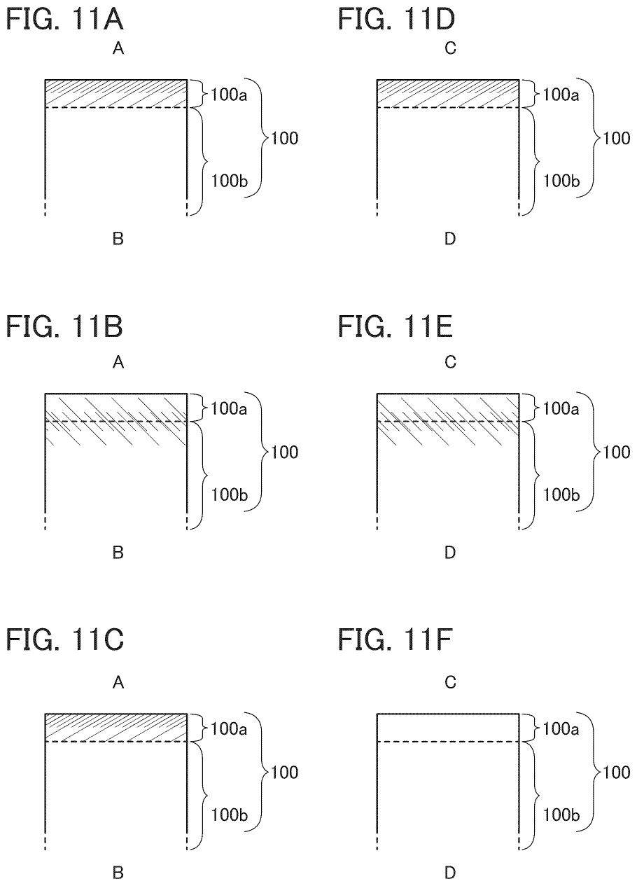

The positive electrode active material 100 of one embodiment of the present invention is described with reference to FIGS. 10A and 10B and FIGS. 11A to 11F. The positive electrode active material 100 hardly deteriorates due to repeated charge (at a high voltage with reference to a lithium metal) and discharge; thus, sufficient battery characteristics can be provided even in a low-temperature environment. In this embodiment, a high voltage is 4.6 V, preferably 4.65 V, further preferably 4.7 V with reference to a lithium metal.

FIGS. 10A and 10B are cross-sectional views of the positive electrode active material 100 of one embodiment of the present invention. FIGS. 11A to 11C illustrate enlarged views of a portion near the line A-B in FIG. 10B. FIGS. 11D to 11F illustrate enlarged views of a portion near the line C-D in FIG. 2B.

As illustrated in FIG. 10A, the positive electrode active material 100 includes a surface portion 100a and an inner portion 100b. Although the dashed line denotes a boundary between the surface portion 100a and the inner portion 100b in the diagram, a clear boundary does not exist.

The surface portion 100a of the positive electrode active material 100 refers to a region of 50 nm or less, preferably 35 nm or less, further preferably 20 nm or less in depth from the surface toward the inner portion, and most preferably 10 nm or less in depth in a perpendicular direction or a substantially perpendicular direction from the surface toward the inner portion. A region whose width becomes narrow from the surface toward the inner portion, specifically, a region with a width of 20 nm or less is referred to as a shell. Note that being “substantially perpendicular” includes being perpendicular, specifically being greater than or equal to 80° and less than or equal to 100°. A plane generated by a crack can be considered as a surface. The surface portion can be rephrased as the vicinity of a surface or a region in the vicinity of a surface.

The inner portion 100b refers to a region deeper than the surface portion 100a of the positive electrode active material. The inner portion 100b can be rephrased as an inner region or a core.

In the case where the positive electrode active material 100 has a layered rock-salt crystal structure of a space group R-3m, the surface portion 100a includes an edge region 100a1 and a basal region 100a2 as illustrated in FIG. 10B.

Note that in FIGS. 10A and 10B, the straight line denoted by (001) represents a (001) plane. The basal region 100a2 includes a particle surface (referred to as a basal plane) parallel or substantially parallel to the (001) plane. A particle surface other than the basal plane is referred to as an edge plane, and a region including the edge plane is referred to as the edge region 100a1. In the case where lithium cobalt oxide is used for the positive electrode active material 100, lithium ions can be inserted and extracted through the edge plane.

The surface of the positive electrode active material 100 refers to a surface of a composite oxide that includes the surface portion 100a and the inner portion 100b, for example. Thus, the positive electrode active material 100 does not contain a material to which a metal oxide that does not contain a lithium site contributing to charging and discharging, such as aluminum oxide (Al₂O₃), is attached, or a carbonate, a hydroxy group, or the like which is chemically adsorbed after formation of the positive electrode active material. The attached metal oxide refers to, for example, a metal oxide having a crystal orientation different from that of the inner portion 100b.

The crystal orientations in two regions being substantially aligned with each other can be determined, for example, from a transmission electron microscope (TEM) image, a scanning transmission electron microscope (STEM) image, a high-angle annular dark field scanning TEM (HAADF-STEM) image, an annular bright-field scanning transmission electron microscope (ABF-STEM) image, an electron diffraction pattern, or the like. It can be determined also from an FFT pattern of a TEM image or an FFT pattern of a STEM image or the like. Furthermore, X-ray diffraction (XRD), neutron diffraction, or the like can also be used for determination.

Furthermore, an electrolyte solution, a decomposition product of an electrolyte, an organic solvent, a binder, a conductive material, and a compound originating from any of these which are attached to the positive electrode active material 100 are not contained in the positive electrode active material. That is, the electrolyte solution, the decomposition product of the electrolyte, the organic solvent, the binder, the conductive material, and the compound originating from any of these which are attached to the positive electrode active material 100 are removed from the surface of the positive electrode active material.

Since the positive electrode active material 100 is a compound containing oxygen and a transition metal into and from which lithium can be inserted and extracted, an interface between a region where oxygen and the transition metal M (Co, Ni, Mn, Fe, or the like) that is oxidized or reduced due to insertion and extraction of lithium exist and a region where oxygen and the transition metal M do not exist may be considered as the surface of the positive electrode active material. A plane generated by slipping and/or a crack is also considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

### <Contained Element>

The positive electrode active material 100 contains lithium, cobalt, oxygen, and an additive element. The positive electrode active material 100 can contain lithium cobalt oxide (LiCoO₂) to which an additive element is added. Note that the positive electrode active material 100 of one embodiment of the present invention has a crystal structure described later, and thus the composition of the lithium cobalt oxide is not strictly limited to Li:Co:O=1:1:2.

As the additive element contained in the positive electrode active material 100, one or more selected from magnesium, fluorine, nickel, aluminum, titanium, zirconium, vanadium, iron, manganese, chromium, niobium, arsenic, zinc, silicon, sulfur, phosphorus, boron, barium, bromine, and beryllium are preferably used.

The additive element is preferably dissolved in the positive electrode active material 100. Such an additive element further stabilizes the crystal structure of the positive electrode active material 100 as described later.

When the positive electrode active material 100 is substantially free from manganese, for example, the above advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

The surface portion 100a, particularly the edge region including the edge plane, is a region from which lithium ions are extracted first in charge, and tends to have a lower lithium concentration than the inner portion 100b. It can also be said that some bonds of atoms on the surface of the particle of the positive electrode active material 100 in the surface portion 100a, particularly in the edge region, from which lithium ions are extracted, are cut. Therefore, the surface portion 100a is regarded as a region which is likely to be unstable and in which degradation of the crystal structure is likely to begin. Meanwhile, if the surface portion 100a, particularly the edge region, can be sufficiently stable, the layered structure, which is formed of octahedrons of cobalt and oxygen, of the inner portion 100b is unlikely to break even when x in LiₓCoO₂ is small, e.g., 0.24 or less. Moreover, when the surface portion 100a, particularly the edge region, can be sufficiently stable, a shift in layers formed of octahedrons of cobalt and oxygen in the inner portion 100b can be inhibited.

To obtain a stable composition and a stable crystal structure in the surface portion 100a, the surface portion 100a preferably contains the above-described additive element, further preferably contains a plurality of additive elements. The surface portion 100a preferably contains one or more selected from the additive elements at higher concentrations than those in the inner portion 100b. The edge region 100a1 preferably contains one or more selected from the additive elements at higher concentrations than those in the basal region 100a2.

Distribution of the additive elements is described. FIGS. 11A to 11C illustrate enlarged views of a portion near the line A-B in FIG. 10B and describe the edge region 100a1 of the positive electrode active material 100. FIGS. 11D to 11F illustrate enlarged views of a portion near the line C-D in FIG. 10B and describe the basal region 100a2 of the positive electrode active material 100.

For example, some of the additive elements, such as magnesium, fluorine, and titanium, preferably have a concentration gradient in which the concentration increases from the inner portion 100b toward the surface. In FIGS. 11A and 11D, the concentration gradient is visualized by hatching density. An additive element which has such a concentration gradient is referred to as the additive element X. Note that the concentration of magnesium, fluorine, titanium, or the like may be higher in the edge region 100a1 than in the basal region 100a2.

It is preferable that another additive element, such as aluminum, have a concentration gradient and have a concentration peak in a region deeper than that of the additive element X shown in FIGS. 11A and 11D. In FIGS. 11A and 11D, the concentration gradient and the peak region are visualized by hatching density. The concentration peak may be observed in the surface portion 100a or observed in a region deeper than the surface portion 100a. For example, the peak is preferably observed in a region that is 5 nm to 30 nm in depth from the surface toward the inner portion. An additive element which has such a concentration gradient is referred to as the additive element Y. Note that the concentration of aluminum or the like may be higher in the edge region 100a1 than in the basal region 100a2.

FIG. 11C shows dark hatching and FIG. 11F shows no hatching, which means that another additive element such as nickel clearly exists in the edge region 100a1 but does not substantially exist in the basal region 100a2 in some cases. The concentration of nickel or the like is preferably higher in the edge region 100a1 than in the basal region 100a2. Note that here, “clearly exist” means a case where the energy spectrum of characteristic X-ray of the element is detected in cross-sectional STEM-EDX analysis of the positive electrode active material 100. An additive element which has such distribution is referred to as the additive element Z.

Note that here, “not substantially exist” means a case where the energy spectrum of characteristic X-ray of the element is not detected in cross-sectional STEM-EDX analysis of the positive electrode active material 100. This phenomenon is also expressed that the element is below the lower detection limit in STEM-EDX analysis.

Magnesium, which is an example of the additive element X, is divalent, and a magnesium ion is more stable in lithium sites than in cobalt sites in a layered rock-salt crystal structure; thus, magnesium is likely to enter the lithium sites. An appropriate concentration of magnesium at the lithium sites of the surface portion 100a facilitates maintenance of the layered rock-salt crystal structure. This is probably because magnesium at the lithium sites serves as a column supporting the CoO₂ layers. Moreover, magnesium can inhibit extraction of oxygen therearound in a state where x in LiₓCoO₂ is, for example, 0.24 or less.

An appropriate concentration of magnesium can bring the above-described advantages without an adverse effect on insertion and extraction of lithium in charging and discharging. However, excess magnesium might adversely affect insertion and extraction of lithium. Furthermore, the effect of stabilizing the crystal structure might be reduced. This is probably because magnesium enters the cobalt sites as well as the lithium sites. Moreover, an excess magnesium compound (e.g., an oxide or a fluoride) which does not enter the lithium site or the cobalt site might be unevenly distributed in the surface of the positive electrode active material or the like to serve as a resistance component of a lithium-ion battery. As the magnesium concentration of the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. The number of magnesium atoms is preferably greater than or equal to 0.001 times and less than or equal to 0.1 times, further preferably greater than 0.01 times and less than 0.04 times, still further preferably approximately 0.02 times the number of cobalt atoms, for example. The amount of magnesium contained in the entire positive electrode active material 100 may be, for example, a value obtained by element analysis on the entire positive electrode active material 100 with glow discharge mass spectrometry (GD-MS), inductively coupled plasma mass spectrometry (ICP-MS), or the like or may be a value based on the ratio of the raw materials mixed in the process of forming the positive electrode active material 100.

Aluminum, which is an example of the additive element Y, can exist in a cobalt site in a layered rock-salt crystal structure. Since aluminum is a trivalent representative element and its valence does not change, lithium around aluminum is less likely to move even in charge and discharge. Thus, aluminum and lithium around aluminum serve as columns to suppress a change in the crystal structure. Furthermore, aluminum has an effect of inhibiting dissolution of cobalt around aluminum and improving continuous charging tolerance. Moreover, an Al—O bond is stronger than a Co—O bond and thus extraction of oxygen around aluminum can be inhibited. These effects improve thermal stability. Therefore, a lithium-ion battery that includes aluminum as the additive element can have a higher degree of safety. In addition, the positive electrode active material 100 having a crystal structure that is unlikely to be broken by repeated charge and discharge can be provided. Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% or greater than or equal to 0.1% and less than or equal to 4% of the number of cobalt atoms. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

Nickel, which is an example of the additive element Z, can exist in both the cobalt site and the lithium site. Nickel preferably exists in the cobalt site because a lower oxidation-reduction potential can be obtained as compared with the case where only cobalt exists in the cobalt site, leading to an increase in discharge capacity.

In addition, when nickel exists at a lithium site, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel at the lithium sites also serves as a column supporting the CoO₂ layers. Therefore, in particular, the crystal structure is expected to be more stable in a charged state at high temperatures, e.g., 45° C. or higher, which is preferable.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, in the positive electrode active material 100, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4% of the number of cobalt atoms. Alternatively, the number of nickel atoms is preferably greater than 0% and less than or equal to 2% of the number of cobalt atoms. Alternatively, the number of nickel atoms is preferably greater than or equal to 0.05% and less than or equal to 7.5% of the number of cobalt atoms. Alternatively, the number of nickel atoms is preferably greater than or equal to 0.05% and less than or equal to 2% of the number of cobalt atoms. Alternatively, the number of nickel atoms is preferably greater than or equal to 0.1% and less than or equal to 7.5% of the number of cobalt atoms. Alternatively, the number of nickel atoms is preferably greater than or equal to 0.1% and less than or equal to 4% of the number of cobalt atoms. The amount of nickel described here may be a value obtained by element analysis on the entire positive electrode active material with GD-MS, ICP-MS, or the like or may be a value based on the ratio of the raw materials mixed in the process of forming the positive electrode active material, for example.

When fluorine, which is a monovalent anion and is an example of the additive element X, is substituted for part of oxygen in the surface portion 100a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 100a of the positive electrode active material 100, lithium ions near fluorine are likely to be extracted and inserted smoothly. Thus, a lithium-ion battery including such a positive electrode active material 100 can have improved charge and discharge characteristics, improved large current characteristics, or the like. When fluorine exists in the surface portion 100a, which has a surface in contact with the electrolyte solution, the corrosion resistance to hydrofluoric acid can be effectively increased. As will be described in detail in the following embodiment, a fluoride such as lithium fluoride that has a lower melting point than another additive element source can serve as a fusing agent (also referred to as a flux) for lowering the melting point of the other additive element source.

An oxide of titanium, which is an example of the additive element X, is known to have superhydrophilicity. Accordingly, the positive electrode active material 100 that contains titanium oxide in the surface portion 100a can have good wettability with respect to a high-polarity solvent. In a secondary battery formed using this positive electrode active material 100, the positive electrode active material 100 and a high-polarity electrolyte solution can have favorable contact at the interface therebetween, which can reduce an increase in an internal resistance.

In the case where the surface portion 100a in FIG. 11A contains magnesium and the surface portion 100a in FIG. 11C contains nickel, i.e., the case where the surface portion 100a contains both magnesium and nickel, there is a possibility that divalent nickel can exist more stably in the vicinity of divalent magnesium. Thus, elution of magnesium can be inhibited even when x in LiₓCoO₂ is small. This can contribute to stabilization of the surface portion 100a.

A large number of additive elements Z are preferably contained in the edge region 100a1 (also referred to as preferentially contained, selectively contained, or the like) as illustrated in FIGS. 11C and 11F, in which case the stability of the crystal structure of the edge region 100a1 for insertion and extraction of lithium ions into/from the positive electrode active material 100 in charge and discharge of a lithium-ion battery is increased, which is preferable. In the case where the additive element Z has such distribution, for example, in the case where the positive electrode active material 100 is lithium cobalt oxide, an influence of adding the additive element Z, such as a decrease in discharge voltage or a decrease in discharge capacity, can be kept to the minimum, which is preferable.

When the plurality of additive elements are contained as described above, the effects of the additive elements can contribute synergistically to further stabilization of the surface portion 100a. In particular, magnesium, nickel, and aluminum are preferably contained, in which case a high effect of stabilizing the composition and the crystal structure can be obtained. In particular, the surface portion 100a of the positive electrode active material 100 preferably includes a region where distribution of aluminum is closer to the inner portion than distribution of magnesium. Furthermore, in addition to the above-described region where magnesium and aluminum are distributed, a region where the distribution of nickel and the distribution of magnesium overlap with each other is most preferably included in the edge region 100a1 in the surface portion 100a of the positive electrode active material 100.

### <Crystal Structure>

One embodiment of the present invention is a lithium-ion battery with improved battery characteristics in a low-temperature environment, and XRD measurement and the like for specifying a crystal structure and the like are performed at room temperature.

<x in LiₓCoO₂ being 1>

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt crystal structure is favorably used as a positive electrode active material of a lithium-ion battery because it has high discharge capacity and a two-dimensional diffusion path for lithium ions and is thus suitable for an insertion/extraction reaction of lithium ions. For this reason, it is preferable that the inner portion 100b, which accounts for the majority of the volume of the positive electrode active material 100, have a layered rock-salt crystal structure.

Meanwhile, the surface portion 100a of the positive electrode active material 100 of one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100b of the positive electrode active material 100 such as extraction of oxygen and/or inhibition of oxidative decomposition of an electrolyte solution on the surface of the positive electrode active material 100.

Accordingly, the surface portion 100a having a function of reinforcing preferably may have a crystal structure different from that of the inner portion 100b. For example, the surface portion 100a preferably has a more stable composition and a more stable crystal structure than those of the inner portion 100b at room temperature (25° C.). For example, at least part of the surface portion 100a of the positive electrode active material 100 of one embodiment of the present invention may have a rock-salt crystal structure. Alternatively, the surface portion 100a may have both a layered rock-salt crystal structure and a rock-salt crystal structure. Alternatively, the surface portion 100a preferably may have features of both a layered rock-salt crystal structure and a rock-salt crystal structure.

Having features of both a layered rock-salt crystal structure and a rock-salt crystal structure can be determined by electron diffraction, a TEM image, a cross-sectional STEM image, or the like.

It is preferable that some additive elements, in particular, magnesium, has a higher concentration in the surface portion 100a than in the inner portion 100b and is present randomly in the inner portion 100b at a low concentration. When aluminum is present at the lithium site of the inner portion 100b at an appropriate concentration, an effect of facilitating maintenance of the layered rock-salt crystal structure can be obtained in a manner similar to the above. When nickel is present in the inner portion 100b at an appropriate concentration, a shift in the layered structure formed of octahedrons of cobalt and oxygen can be suppressed in a manner similar to the above. Also in the case where both magnesium and nickel are contained, a synergistic effect of inhibiting elution of magnesium can be expected since divalent magnesium can be present more stably in the vicinity of divalent nickel.

It is preferable that the crystal structure continuously change from the inner portion 100b toward the surface owing to the above-described concentration gradient of magnesium. Alternatively, it is preferable that the orientations of a crystal in the surface portion 100a and a crystal in the inner portion 100b be substantially aligned with each other.

Note that in this specification and the like, a layered rock-salt crystal structure, which belongs to the space group R-3m, of a composite oxide containing lithium and a transition metal such as cobalt refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may be present. Moreover, in the layered rock-salt crystal structure, strictly, a lattice of the rock-salt crystal structure is distorted and orientations of crystals are substantially aligned with each other in some cases.

A rock-salt crystal structure refers to a structure in which a cubic crystal structure such as a crystal structure belonging to the space group Fm-3m is included and cations and anions are alternately arranged. Note that a cation or anion vacancy may be present.

There is no distinction among cation sites in a rock-salt crystal structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure.

Anions of a layered rock-salt crystal structure and anions of a rock-salt crystal structure form a cubic close-packed structure (face-centered cubic lattice structure). Anions of an O3′ type crystal, which is described later, are presumed to form a cubic close-packed structure. Thus, when a layered rock-salt crystal structure and a rock-salt crystal structure are in contact with each other, there is a crystal plane at which orientations of cubic close-packed structures formed of anions are aligned with each other.

The description can also be made as follows. An anion on the {111} plane of a cubic crystal structure has a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal structure and the O3′ type crystal structure to be described later is R-3m, which is different from the space group Fm-3m of a rock-salt crystal structure (the space group of a general rock-salt crystal); thus, the Miller index of the crystal plane satisfying the above conditions in the layered rock-salt crystal structure and the O3′ type crystal structure is different from that in the rock-salt crystal structure. In this specification, in the layered rock-salt crystal structure, the O3′ crystal structure, and the rock-salt crystal structure, a state where the orientations of the cubic close-packed structures formed of anions are aligned with each other may be referred to as a state where crystal orientations are substantially aligned with each other.

<<x in LiₓCoO₂ being Small>>

The crystal structure in a discharge state (a state where x in LiₓCoO₂ is small) of the positive electrode active material 100 of one embodiment of the present invention is different from that of a conventional positive electrode active material because the positive electrode active material 100 has the above-described magnesium distribution and/or crystal structure. Here, “x is small” means 0.1<x≤0.24.

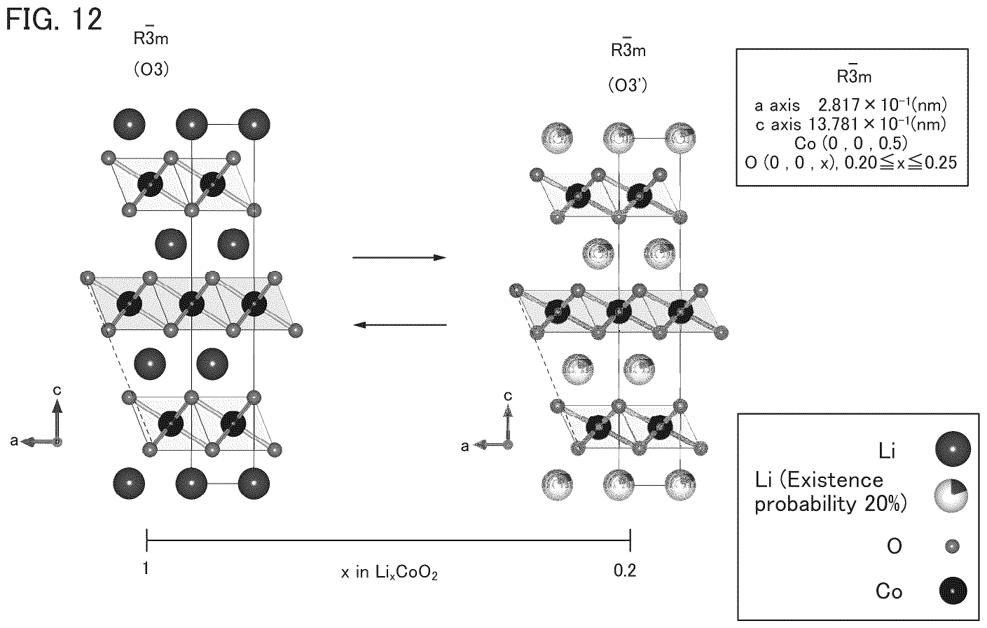

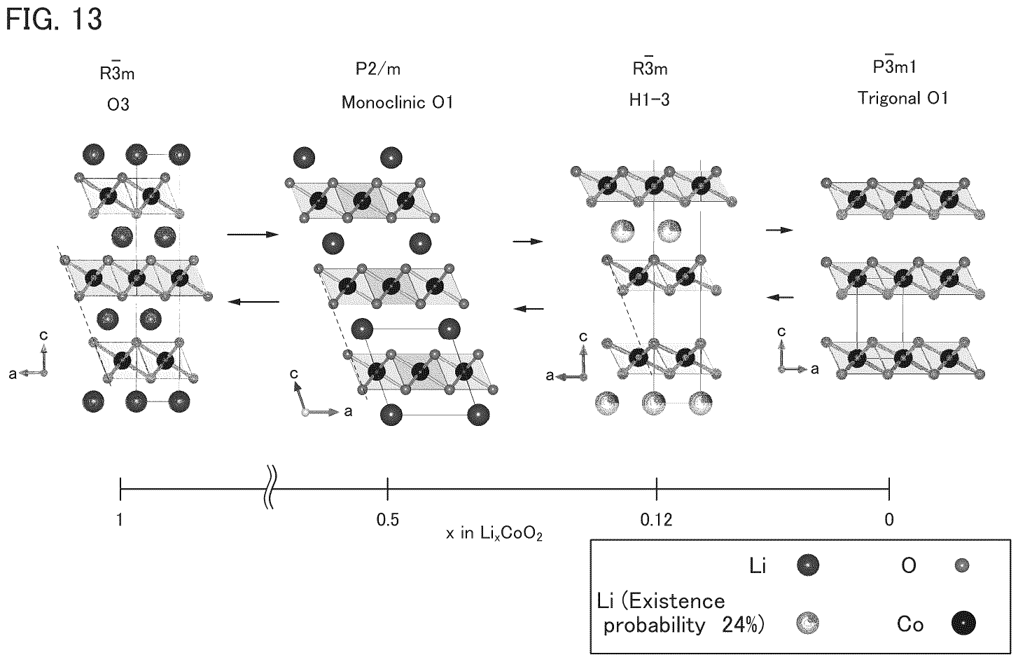

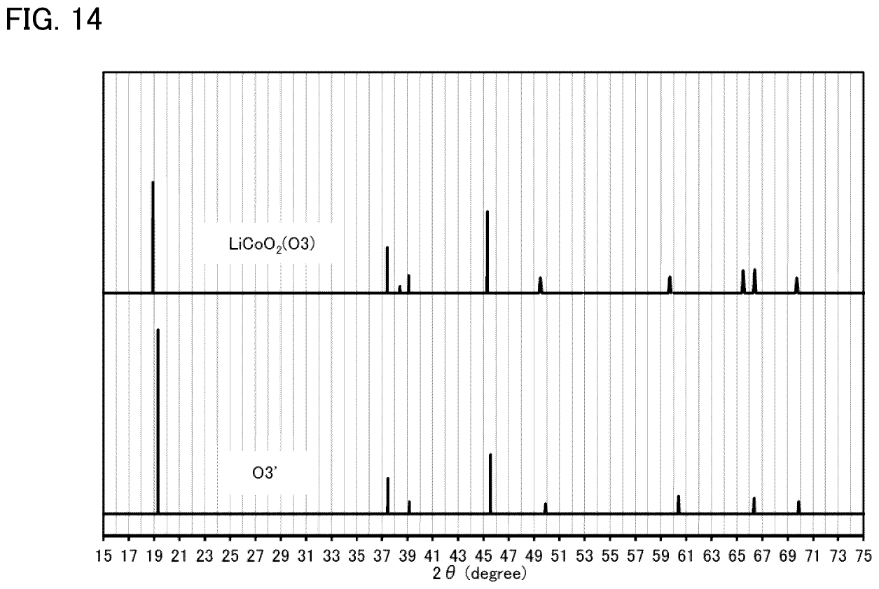

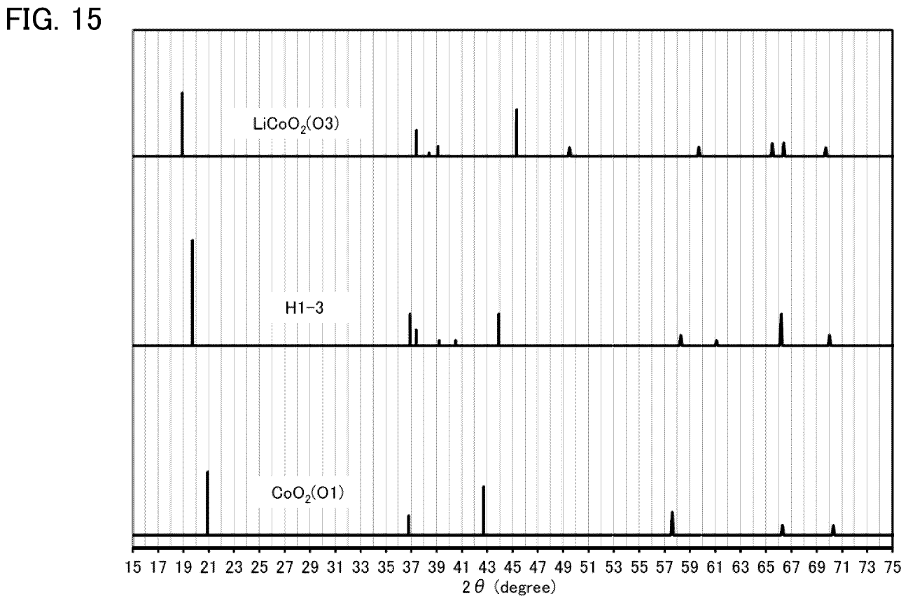

A conventional positive electrode active material and the positive electrode active material 100 of one embodiment of the present invention are compared, and changes in the crystal structures owing to a change in x in LiₓCoO₂ will be described with reference to FIG. 12, FIG. 13, FIG. 14, and FIG. 15.

A change in the crystal structure of the conventional positive electrode active material is shown in FIG. 13. The conventional positive electrode active material shown in FIG. 13 is lithium cobalt oxide (LiCoO₂) containing no magnesium.

In FIG. 13, the crystal structure of lithium cobalt oxide with x in LiₓCoO₂ being 1 is denoted by R-3m O3. In this crystal structure, lithium occupies octahedral sites and a unit cell includes three CoO₂ layers. Thus, this crystal structure is referred to as an O3 type structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3m1 and includes one CoO₂ layer in a unit cell. Hence, this crystal structure is referred to as an O1 type structure or a trigonal O1 type structure in some cases. Moreover, in some cases, this crystal structure is referred to as a hexagonal O1 type structure when a trigonal crystal system is converted into a composite hexagonal lattice.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as an R-3m O3 type structure are alternately stacked. Thus, this crystal structure is sometimes referred to as an H1-3 type structure. Note that the number of cobalt atoms per unit cell in the actual H1-3 type structure is twice that in other structures. However, in this specification including FIG. 13, the c-axis of the H1-3 type structure is half that of the unit cell for easy comparison with the other crystal structures.

For the H1-3 type structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that O1 and O2 are each an oxygen atom. A preferred unit cell for representing a crystal structure in a positive electrode active material can be selected by Rietveld analysis of XRD patterns, for example. In this case, a unit cell is selected such that the value of goodness of fit (GOF) is small, specifically, GOF is close to 1.

When charge that makes x in LiₓCoO₂ be 0.24 or less and discharge are repeated, the crystal structure of conventional lithium cobalt oxide repeatedly changes between the R-3m O3 type structure in a discharged state and the H1-3 type structure (i.e., an unbalanced phase change).

However, there is a large shift in the CoO₂ layers between these two crystal structures. As denoted by the dotted lines and the arrows in FIG. 13, the CoO₂ layer in the H1-3 type structure largely shifts from that in the structure belonging to R-3m O3 in a discharged state. Such a dynamic structural change can adversely affect the stability of the crystal structure.

A difference in volume between the two crystal structures is also large. The percentage of volume change between the R-3m O3 type structure in a discharged state and the H1-3 type structure that contain the same number of cobalt atoms is greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charge that makes x be 0.24 or less and discharge are repeated, the crystal structure of conventional lithium cobalt oxide is gradually broken. The broken crystal structure triggers degradation of the cycle performance. This is because the broken crystal structure has a smaller number of sites which lithium can occupy stably and makes it difficult to insert and extract lithium.

Meanwhile, in the positive electrode active material 100 of one embodiment of the present invention shown in FIG. 12, a change in the crystal structure between a discharged state with x in LiₓCoO₂ of 1 and a state with x of 0.24 or less, specifically a state with x of 0.2 (this is sometimes referred to as Li existence probability of 20%), is smaller than that in a conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charge that makes x be 0.24 or less and discharge are repeated, and obtain excellent cycle performance. In addition, the positive electrode active material 100 of one embodiment of the present invention with x in LiₓCoO₂ of 0.24 or less can have a more stable crystal structure than a conventional positive electrode active material. Thus, in the positive electrode active material 100 of one embodiment of the present invention, a short circuit is less likely to occur in a state where x in LiₓCoO₂ is kept at 0.24 or less. This is preferable because the safety of a lithium-ion battery is further improved.

FIG. 12 shows crystal structures of the inner portion 100b of the positive electrode active material 100 in a state where x in LiₓCoO₂ is 1 and approximately 0.2. The inner portion 100b, accounting for the majority of the volume of the positive electrode active material 100, largely contributes to charge and discharge and is accordingly a portion where a shift in CoO₂ layers and a volume change matter most.

The positive electrode active material 100 with x of 1 has the R-3m O3 type structure, which is the same as that of conventional lithium cobalt oxide.

However, in a state where x is 0.24 or less, e.g., approximately 0.2 or approximately 0.12, the positive electrode active material 100 has a crystal structure different from the H1-3 type structure of conventional lithium cobalt oxide.

The positive electrode active material 100 of one embodiment of the present invention with x of approximately 0.2 has a trigonal crystal structure belonging to the space group R-3m. The symmetry of the CoO₂ layers of this structure is the same as that of the O3 type structure. Thus, this crystal structure is referred to as an O3′ type structure. Although the positive electrode active material 100 of one embodiment of the present invention with x of approximately 0.2 does not have a spinel structure, an XRD pattern similar to that of the spinel structure appears in some cases, and this crystal structure is referred to as a pseudo-spinel structure in some cases. In FIG. 12, this crystal structure is denoted by R-3m O3′.

Note that in the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811 (×10⁻¹ nm), typically, c=13.781 (×10⁻¹ nm).

In the O3′ type structure, an ion of cobalt, magnesium, or the like occupies a site coordinated to six oxygen atoms. Note that a light element such as lithium sometimes occupies a site coordinated to four oxygen atoms.

As denoted by the dotted lines in FIG. 12, the CoO₂ layers hardly shift between the R-3m (O3) type structure in a discharged state and the O3′ type structure.

The percentage of volume change between the R-3m (O3) type structure in a discharged state and the O3′ type structure that contain the same number of cobalt atoms is 2.5% or less, specifically 2.2% or less, typically 1.8%.

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is reduced. Thus, the crystal structure of the positive electrode active material 100 is less likely to break even when charge that makes x be 0.24 or less and discharge are repeated. Therefore, a decrease in charge and discharge capacity of the positive electrode active material 100 in charge-discharge cycles is reduced. Furthermore, the positive electrode active material 100 can stably use a large amount of lithium than a conventional positive electrode active material and thus has large discharge capacity per weight and per volume. Thus, with the use of the positive electrode active material 100, a lithium-ion battery with large discharge capacity per weight and per volume can be fabricated.

Note that the positive electrode active material 100 actually has the O3′ type structure in some cases when x in LiₓCoO₂ is greater than or equal to 0.15 and less than or equal to 0.24, and is assumed to have the O3′ type structure even when x is greater than 0.24 and less than or equal to 0.27. However, the crystal structure is influenced by not only x in LiₓCoO₂ but also the number of charge-discharge cycles, a charge current and a discharge current, temperature, an electrolyte solution, and the like, so that the range of x is not limited to the above.

Hence, when x in LiₓCoO₂ in the positive electrode active material 100 is greater than 0.1 and less than or equal to 0.24, not all of the inner portion 100b of the positive electrode active material 100 has to have the O3′ type structure. Some of the particles may have another crystal structure or be amorphous.

In order to make x in LiₓCoO₂ small, charge at a high charge voltage is necessary in general. Therefore, the state where x in LiₓCoO₂ is small can be rephrased as a state where charge at a high charge voltage has been performed.

That is, the positive electrode active material 100 of one embodiment of the present invention is preferable because the R-3m O3 structure having symmetry can be maintained even when charge at a high charge voltage, e.g., 4.6 V or higher is performed at 25° C. Moreover, the positive electrode active material 100 of one embodiment of the present invention is preferable because the O3′ type structure can be obtained when charge at a higher charge voltage, e.g., a voltage higher than or equal to 4.65 V and lower than or equal to 4.7 V is performed at 25° C.

At a far higher charge voltage, the H1-3 type structure is eventually observed in the positive electrode active material 100 in some cases. As described above, the crystal structure is influenced by the number of charge-discharge cycles, a charge current and a discharge current, an electrolyte solution, and the like, so that the positive electrode active material 100 of one embodiment of the present invention may sometimes have the O3′ type structure even at a lower charge voltage, e.g., a charge voltage of higher than or equal to 4.5 V and lower than 4.6 V at 25° C.

Note that in the case where graphite is used as a negative electrode active material in a lithium-ion battery, the voltage of the lithium-ion battery is lower than the above-mentioned voltages by the potential of graphite. The potential of graphite is approximately 0.05 V to 0.2 V with reference to the potential of a lithium metal. Therefore, in the case of a lithium-ion battery using graphite as a negative electrode active material, a similar crystal structure is obtained at a voltage corresponding to a difference between the above-described voltage and the potential of the graphite. Therefore, in the case of a secondary battery using graphite as a negative electrode active material, a similar crystal structure is obtained at a voltage corresponding to a difference between the voltage in the case where a lithium metal is used as the negative electrode active material and the potential of the graphite.

Although lithium occupies all lithium sites in the O3′ type structure with an equal probability in the illustration of FIG. 12, the present invention is not limited thereto. Lithium may exist unevenly in only some of the lithium sites. For example, lithium may be symmetrically present as in the monoclinic O1 type structure (Li_{0.5}CoO₂) in FIG. 13. Distribution of lithium can be analyzed by neutron diffraction, for example.

To obtain the O3′ type structure, a plurality of portions of the surface portion 100a of the positive electrode active material 100 preferably have similar concentration gradients of magnesium. In other words, it is preferable that the reinforcement derived from magnesium uniformly occur in the surface portion 100a. Even when the surface portion 100a partly has reinforcement, stress might be concentrated on parts that do not have reinforcement. The concentration of stress on part of the positive electrode active material 100 might cause defects such as cracks from that part, leading to cracking of the positive electrode active material and a decrease in discharge capacity. Note that the magnesium does not necessarily have similar concentration gradients throughout the surface portion 100a of the positive electrode active material 100.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to the (001) plane. As already described above, the (001) plane is referred to as a basal plane, and a plane, where a diffusion path of lithium ions is exposed, other than the (001) plane is referred to as an edge plane.

The CoO₂ layer is relatively stable and thus, the surface of the positive electrode active material 100 is more stable when having the (001) orientation. A main diffusion path of lithium ions in charging and discharging is not exposed at the (001) plane.

By contrast, a diffusion path of lithium ions is exposed at a surface other than the (001) plane. Thus, the surface other than the (001) plane and the surface portion 100a thereof easily lose stability because they are regions where extraction of lithium ions starts as well as important regions for maintaining a diffusion path of lithium ions. It is thus extremely important to reinforce the surface other than the (001) plane and the surface portion 100a for maintaining the crystal structure of the whole positive electrode active material 100.

### <Analysis Method>

Whether or not a positive electrode active material is the positive electrode active material 100 of one embodiment of the present invention, which has the O3′ type structure when x in LiₓCoO₂ is small, can be determined by analyzing a positive electrode including the positive electrode active material with small x in LiₓCoO₂ by XRD, electron diffraction, neutron diffraction, electron spin resonance (ESR), nuclear magnetic resonance (NMR), or the like. Among some kinds of XRD, powder XRD is preferable because by the powder XRD, diffraction peaks appearing in powder XRD patterns reflect the crystal structure of the inner portion 100b of the positive electrode active material 100, which accounts for the majority of the volume of the positive electrode active material 100.

In addition, in a state where x in LiₓCoO₂ is too small, e.g., 0.1 or less, or charge voltage is higher than 4.9 V, the positive electrode active material 100 of the present invention might have the H1-3 structure or the trigonal O1 structure. Thus, to determine whether or not a positive electrode active material is the positive electrode active material 100 of one embodiment of the present invention, analysis of the crystal structure by XRD and other methods and data such as charge capacity or charge voltage are needed.

Note that the crystal structure of a positive electrode active material in a state with small x may be changed when the positive electrode active material is exposed to the air. For example, the O3′ type structure changes into the H1-3 type structure in some cases. For that reason, all samples to be used for analysis of the crystal structure are preferably handled in an inert atmosphere such as an argon atmosphere.

Whether the additive element contained in a positive electrode active material has the above-described distribution can be determined by analysis using XPS, EDX, electron probe microanalysis (EPMA), or the like.

The crystal structure of the surface portion 100a, the crystal grain boundary, or the like can be analyzed by electron diffraction of a cross section of the positive electrode active material 100, for example.

### <<Charge Method>>

Whether or not a composite oxide is the positive electrode active material 100 of one embodiment of the present invention can be determined by charging a CR2032 coin cell (with a diameter of 20 mm and a height of 3.2 mm) that is formed using the composite oxide for a positive electrode and a lithium metal for a counter electrode, for example. The coin cell includes an electrolyte solution, a separator, a positive electrode can, and a negative electrode can.

More specifically, a positive electrode can be formed by application of a slurry in which the positive electrode active material, a conductive material, and a binder are mixed to a positive electrode current collector made of aluminum foil.

A lithium metal can be used for a counter electrode.

As a lithium salt, 1 mol/L lithium hexafluorophosphate (LiPF₆) can be used. As the electrolyte, a mixed solvent in which ethylene carbonate (EC) and diethyl carbonate (DEC) are mixed at a volume ratio of 3:7 can be used. As an additive agent, vinylene carbonate (VC) mixed in the mixed solvent at 2 wt % can be used.

As a separator, a 25-μm-thick polypropylene porous film can be used.

Stainless steel (SUS) can be used for a positive electrode can and a negative electrode can.

The coin cell fabricated with the above conditions is charged with a given voltage (e.g., 4.5 V, 4.55 V, 4.6 V, 4.65 V, 4.7 V, 4.75 V, or 4.8 V). The charge method is not particularly limited as long as charge with a given voltage can be performed for sufficient time. For example, in the case of CCCV charge, current in the CC charge can be higher than or equal to 20 mA/g and lower than or equal to 100 mA/g per weight of the positive electrode active material. The CV charge can be terminated at a current higher than or equal to 2 mA/g and lower than or equal to 10 mA/g per weight of the positive electrode active material. To observe a phase change of the positive electrode active material, charge with such a small current value is preferably performed. The temperature is set to 25° C. After the charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the taken positive electrode active material is preferably enclosed in an argon atmosphere for various analyses to be performed later. For example, XRD can be performed on the positive electrode active material enclosed in an airtight container with an argon atmosphere. After the charge is completed, the positive electrode is preferably taken out immediately and analyzed. Specifically, the positive electrode is preferably analyzed within 1 hour after the completion of the charge, further preferably 30 minutes after the completion of the charge.

In the case where the crystal structure in a charged state after multiple charge-discharge cycles is analyzed, the conditions of the multiple charge-discharge cycles may be different from the above-described charge conditions. For example, the charge can be performed in the following manner: constant current charge to a freely selected voltage (e.g., 4.6 V, 4.65 V, 4.7 V, 4.75 V, or 4.8 V) at a current value per weight of the positive electrode active material of higher than or equal to 20 mA/g and lower than or equal to 100 mA/g is performed and then, constant voltage charge is performed until the current value per weight of the positive electrode active material becomes higher than or equal to 2 mA/g and lower than or equal to 10 mA/g. As the discharge, constant current discharge can be performed at higher than or equal to 20 mA/g and lower than or equal to 100 mA/g until the discharge voltage reaches 2.5 V.

Also in the case where the crystal structure in a discharged state after the multiple charge-discharge cycles is analyzed, constant current discharge can be performed at a current value per weight of the positive electrode active material of higher than or equal to 20 mA/g and lower than or equal to 100 mA/g until the discharge voltage reaches 2.5 V, for example.

### <XRD>

The apparatus and conditions adopted in the XRD measurement are not particularly limited as long as appropriate adjustment and calibration are performed. The measurement can be performed with the apparatus and conditions as described below, for example.
XRD apparatus: D8 ADVANCE produced by Bruker AXS
X-ray: Cu Kα
Output: 40 kV, 40 mA
Angle of divergence: Div. Slit, 0.5°
Detector: LynxEye
Scanning method: 2θ/θ continuous scan
Measurement range (2θ): from 15° to 90°
Step width (2θ): 0.01°
Counting time: one second/step
Rotation of sample stage: 15 rpm
In the adjustment and calibration, a standard sintered alumina plate SRM 1976 from National Institute of Standards and Technology (NIST) can be used as a standard sample, for example.

In the case where the measurement sample is a powder, the sample can be set by, for example, being put on a glass sample holder or being sprinkled on a reflection-free silicon plate to which grease is applied. In the case where the measurement sample is a positive electrode, the positive electrode can be set by being attached to a substrate with a double-sided adhesive tape such that the heights of the positive electrode active material layer and the measurement plane required by the apparatus are aligned.

Characteristic X-rays may be monochromatized with the use of a filter or the like or may be monochromatized with XRD data analysis software after an XRD pattern is obtained. For example, a peak due to CuKα₂ radiation can be eliminated and only a peak due to CuKα₁ radiation can be extracted by using DIFFRAC.EVA (XRD data analysis software produced by Bruker Corporation). This software can also be used to eliminate the background, for example.

Data processing for a 2θ value of a diffraction peak in this specification and the like is described. First, a calculation model is fitted for an XRD pattern with the use of crystal structure analysis software to obtain a pattern after calculation. Then, the 2θ value at which a peak top of the diffraction peak appears in the pattern after the calculation is defined as the 2θ value of the diffraction peak. There is no particular limitation on the crystal structure analysis software used for the fitting; for example, it is possible to use TOPAS ver. 3 (crystal structure analysis software produced by Bruker Corporation).

FIG. 14 and FIG. 15 show ideal powder XRD patterns with CuKα₁ radiation that are calculated from models of the O3′ type structure and the H1-3 type structure. For comparison, ideal XRD patterns calculated from the crystal structure of LiCoO₂ (O3) with x in LiₓCoO₂ of 1 and the trigonal O1 type structure with x of 0 are also shown. Note that the patterns of LiCoO₂ (O3) and CoO₂ (O1) are made on the basis of crystal structure data obtained from the Inorganic Crystal Structure Database (ICSD) with Reflex Powder Diffraction, which is a module of Materials Studio (BIOVIA). The 2θ range is from 15° to 75°, the step size is 0.01, the wavelength λ1 is 1.540562×10⁻¹⁰ m, the wavelength λ2 is not set, and a single monochromator is used. XRD patterns of the H1-3 type structure are made from crystal structure data of the H1-3 type structure shown in FIG. 15 in a manner similar to the above-described method. The O3′ type structure was estimated from the XRD pattern of the positive electrode active material of one embodiment of the present invention, the crystal structure was fitted with TOPAS Version 3 (crystal structure analysis software produced by Bruker Corporation), and the XRD pattern of the O3′ type structure was made in a similar manner to other structures.

As shown in FIG. 14, the O3′ type structure exhibits diffraction peaks at 2θ of 19.25±0.12° (greater than or equal to 19.13° and less than or equal to 19.37°) and 2θ of 45.47±0.100 (greater than or equal to 45.37° and less than or equal to 45.57°).

However, as shown in FIG. 15, the H1-3 type structure and the trigonal O1 type structure do not exhibit peaks at these positions. Thus, the diffraction peaks at 2θ of 19.25±0.12° (greater than or equal to 19.13° and less than or equal to 19.37°) and 2θ of 45.47±0.10° (greater than or equal to 45.37° and less than or equal to 45.57°) in a state where x in LiₓCoO₂ is small can be the features of the positive electrode active material 100 of one embodiment of the present invention.

It can be said that, the position of an XRD diffraction peak exhibited by the crystal structure with x of 1 is close to that of an XRD diffraction peak exhibited by the crystal structure with x of 0.24 or less. More specifically, it can be said that in the 2θ range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material 100 of one embodiment of the present invention has the O3′ type structure when x in LiₓCoO₂ is small, not all the particles necessarily have the O3′ type structure. Some of the particles may have another crystal structure or be amorphous. Note that when the XRD patterns are subjected to the Rietveld analysis, the O3′ type structure preferably accounts for greater than or equal to 50%, further preferably greater than or equal to 60%, still further preferably greater than or equal to 66% of the positive electrode active material. The positive electrode active material in which the O3′ type structure accounts for greater than or equal to 50%, preferably greater than or equal to 60%, further preferably greater than or equal to 66% can have sufficiently good cycle performance.

Sharpness of a diffraction peak in an XRD pattern indicates the degree of crystallinity. Thus, it is preferable that the diffraction peaks after charge be sharp or in other words, have a narrow half width. Even peaks that are derived from the same crystal phase have different half widths depending on the XRD measurement conditions or the 2θ value. In the case of the above-described measurement conditions, the peak observed in the 2θ range of greater than or equal to 43° and less than or equal to 46° preferably has a half width less than or equal to 0.2°, further preferably less than or equal to 0.15°, still further preferably less than or equal to 0.12°, for example. A narrow half width and high crystallinity contribute to stabilization of the crystal structure after charge. By contrast, the conventional LiCoO₂ has a small crystallite size and exhibits a broad and small peak although it can partly have a structure similar to the O3′ type structure.

### <<X-Ray Photoelectron Spectroscopy (XPS)>>

In an inorganic oxide, a region ranging from the surface to a depth of approximately 2 nm to 8 nm (normally, less than or equal to 5 nm) can be analyzed by XPS using monochromatic aluminum Kα radiation as an X-ray source; thus, the concentrations of elements in approximately half the depth of the surface portion 100a can be quantitatively analyzed by XPS. The bonding states of the elements can be analyzed by narrow scanning. The quantitative accuracy of XPS is about ±1 atomic % in many cases. The lower detection limit is approximately ±1 atomic % but depends on the element.

The concentration of the additive element may be compared using the ratio of the additive element to cobalt. The use of the ratio of the additive element to cobalt is preferable because it enables comparison while reducing the influence of a carbonate or the like which is chemically adsorbed after formation of the positive electrode active material. For example, the atomic ratio of magnesium to cobalt (Mg/Co) in the XPS analysis is preferably greater than or equal to 0.400, further preferably greater than or equal to 0.500, still further preferably greater than or equal to 0.600, yet still further preferably greater than or equal to 0.700, yet still further preferably greater than or equal to 0.800, yet still further preferably greater than or equal to 0.900, yet still further preferably greater than or equal to 1.000. The ratio Mg/Co is preferably less than or equal to 2.000, further preferably less than or equal to 1.500, still further preferably less than or equal to 1.400, yet still further preferably less than or equal to 1.300, yet still further preferably less than or equal to 1.200.

For example, the atomic ratio of nickel to cobalt (Ni/Co) in the XPS analysis is preferably greater than or equal to 0.05, further preferably greater than or equal to 0.06, still further preferably greater than or equal to 0.07, yet still further preferably greater than or equal to 0.08, yet still further preferably greater than or equal to 0.09. The ratio Ni/Co is preferably less than or equal to 0.200, further preferably less than or equal to 0.150, still further preferably less than or equal to 0.140, yet still further preferably less than or equal to 0.130, yet still further preferably less than or equal to 0.120, yet still further preferably less than or equal to 0.110.

For example, the atomic ratio of fluorine to cobalt (F/Co) in the XPS analysis is preferably greater than or equal to 0.100, further preferably greater than or equal to 0.200, still further preferably greater than or equal to 0.300, yet still further preferably greater than or equal to 0.400, yet still further preferably greater than or equal to 0.500, yet still further preferably greater than or equal to 0.600, yet still further preferably greater than or equal to 0.700. The ratio F/Co is preferably less than or equal to 1.500, further preferably less than or equal to 1.200, still further preferably less than or equal to 1.100, yet still further preferably less than or equal to 1.000, yet still further preferably less than or equal to 0.900.

When the ratio is within the above range, it can be said that the additive element is not attached to the surface of the positive electrode active material 100 in a narrow range but widely distributed at a preferable concentration in the surface portion 100a of the positive electrode active material 100. That is, when the ratios are within the above ranges in the XPS analysis results of the positive electrode active material 100, the crystal structure is less likely to be broken even when charge that makes x be 0.24 or less and discharge are repeated, so that excellent cycle performance can be achieved.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This bonding energy is different from that of lithium fluoride (685 eV) and that of magnesium fluoride (686 eV).

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This value is different from the bonding energy of magnesium fluoride (1305 eV) and is close to that of magnesium oxide.

### <EDX>

One or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using FIB or the like and analyzing the cross section using EDX, EPMA, or the like.

EDX measurement for two-dimensional evaluation of an area by area scan is referred to as EDX area analysis. EDX measurement for evaluation of the atomic concentration distribution in a positive electrode active material by line scan is referred to as EDX line analysis. Furthermore, extracting data of a linear region from EDX area analysis is referred to as EDX line analysis in some cases. The measurement of a region without scanning is referred to as point analysis.

By EDX area analysis (e.g., element mapping), the concentrations of the additive element in the surface portion 100a, the inner portion 100b, the vicinity of the crystal grain boundary, and the like of the positive electrode active material 100 can be quantitatively analyzed. By EDX line analysis, the concentration distribution and the highest concentration of the additive element can be analyzed. An analysis method after a sample is thinned by FIB or the like is preferred because the method makes it possible to analyze the concentration distribution in the depth direction from the surface toward the center in a specific region of the positive electrode active material regardless of the distribution in the front-back direction. To increase the spatial resolution in STEM-EDX line analysis, the beam diameter of an electron beam (also referred to as a beam diameter or a probe diameter) is preferably small. The beam diameter in STEM-EDX line analysis is preferably less than or equal to 0.3 nm, further preferably less than or equal to 0.2 nm, still further preferably less than or equal to 0.1 nm.

EDX area analysis or EDX point analysis of the positive electrode active material 100 of one embodiment of the present invention preferably reveals that the concentration of each additive element, in particular, the additive element X in the surface portion 100a is higher than that in the inner portion 100b.

In STEM-EDX line analysis or the like, it is sometimes difficult to precisely determine the surface because a steep change in the detected amount of the characteristic X-ray of an element is not seen in principle or due to a measurement error. Therefore, when STEM-EDX line analysis or the like in the depth direction is described, the reference point of the surface is a point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background or a point where the detected amount of the characteristic X-ray of oxygen is equal to 50% of the sum of the average value O_{AVE} of the detected amounts of the characteristic X-ray of oxygen in the inner portion and the average value O_{BG} of the detected amounts of the characteristic X-ray of oxygen of the background. Note that when the position of the point where the detected amount of the characteristic X-ray of the transition metal M is equal to 50% of the sum of the average value of the detected amounts of the characteristic X-ray of the transition metal M in the inner portion and the average value of the detected amounts of the characteristic X-ray of the transition metal M of the background is different from the position of the point where the detected amount of the characteristic X-ray of oxygen is equal to 50% of the sum of the average value of the detected amounts of the characteristic X-ray of oxygen in the inner portion and the average value of the detected amounts of the characteristic X-ray of oxygen of the background, the difference is probably due to the influence of a carbonate, a metal oxide containing oxygen, or the like, which is attached to the surface. Thus, in such a case, the point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background can be employed as the position of the surface of the positive electrode active material. In the case of a positive electrode active material containing a plurality of the transition metals M, the reference point can be determined using M_{AVE} and M_{BG} of the element whose detected amount of the characteristic X-ray in the inner portion is larger than that of any other element.

The average value M_{BG} of the amount of the background transition metal M can be calculated by averaging the amount in the range greater than or equal to 2 nm, preferably greater than or equal to 3 nm, which is outside a portion in the vicinity of the portion at which the amount of the detected transition metal M begins to increase, for example. The average value M_{AVE} of the amount of the detected transition metal M in the inner portion can be calculated by averaging the amount in the range greater than or equal to 2 nm, preferably greater than or equal to 3 nm in a region where the count numbers of the transition metals M and oxygen atoms are saturated and stabilized, e.g., a portion that is greater than or equal to 30 nm, preferably greater than 50 nm in depth from the portion where the amount of the detected transition metal M begins to increase, for example. The average value O_{BG} of the amount of background oxygen and the average value O_{AVE} of the amount of detected oxygen in the inner portion can be calculated in a similar manner.

The surface of the positive electrode active material 100 in, for example, a cross-sectional STEM image is a boundary between a region where an image derived from the crystal structure of the positive electrode active material is observed and a region where the image is not observed. The surface of the positive electrode active material 100 is also determined as the outermost surface of a region where an atomic column derived from an atomic nucleus of, among metal elements which constitute the positive electrode active material, a metal element that has a larger atomic number than lithium is observed in the cross-sectional STEM image. The surface in a STEM image or the like may be determined by using additionally analysis with higher spatial resolution.

A peak in STEM-EDX line analysis refers to the local maximum value of a projecting shape appearing in the graph of the characteristic X-ray intensity of each element or the maximum value of the characteristic X-ray of each element. As a noise in STEM-EDX line analysis, a measured value having a half width smaller than or equal to spatial resolution (R), for example, smaller than or equal to R/2 can be given.

For example, EDX area analysis or EDX point analysis of the positive electrode active material 100 containing magnesium as the additive element preferably reveals that the magnesium concentration in the surface portion 100a is higher than that in the inner portion 100b. In the EDX line analysis, a peak of the magnesium concentration in the surface portion 100a is preferably observed in a region extending, toward the center of the positive electrode active material 100, from the surface thereof to a depth of 3 nm, further preferably 1 nm, still further preferably 0.5 nm. Alternatively, the peak is preferably observed in a region from the surface to a depth of less than or equal to ±1 nm. Furthermore, the magnesium concentration preferably attenuates, at a depth of 1 nm from the point where the concentration reaches the peak, to less than or equal to 60% of the peak concentration. The magnesium concentration preferably attenuates, at a depth of 2 nm from the point where the concentration reaches the peak, to less than or equal to 30% of the peak concentration. Here, a “peak of concentration” refers to the local maximum value of the concentration. Note that due to the influence of spatial resolution in the EDX line analysis, the position where the peak of the magnesium concentration exists sometimes has a negative value as a depth from the surface toward the inner portion.

When the positive electrode active material 100 contains magnesium and fluorine as the additive elements, the distribution of fluorine preferably overlaps with the distribution of magnesium. For example, a difference in the depth direction between a peak of the fluorine concentration and a peak of the magnesium concentration is preferably within 10 nm, further preferably within 3 nm, still further preferably within 1 nm.

In the EDX line analysis, a peak of the fluorine concentration in the surface portion 100a is preferably observed in a region ranging from the surface of the positive electrode active material 100 to a depth of 3 nm, further preferably a depth of 1 nm, still further preferably a depth of 0.5 nm toward the center of the positive electrode active material 100. Alternatively, the peak is preferably observed in a region from the surface to a depth of less than or equal to ±1 nm. It is further preferable that a peak of the magnesium concentration be observed slightly closer to the inner portion than the peak of the fluorine concentration is, in which case resistance to hydrofluoric acid is increased. For example, it is preferable that the peak of the magnesium concentration be observed closer to the inner portion than the peak of the fluorine concentration is by 0.5 nm or more, further preferably 1.5 nm or more.

In the positive electrode active material 100 containing nickel as the additive element, a peak of the nickel concentration in the surface portion 100a is preferably observed in a region extending, toward the center of the positive electrode active material 100, from the surface thereof to a depth of 3 nm, further preferably 1 nm, still further preferably 0.5 nm. Alternatively, the peak is preferably observed in a region from the surface to a depth of less than or equal to ±1 nm. When the positive electrode active material 100 contains magnesium and nickel, the distribution of nickel preferably overlaps with the distribution of magnesium. For example, a difference in the depth direction between a peak of the nickel concentration and a peak of the magnesium concentration is preferably within 10 nm, further preferably within 3 nm, still further preferably within 1 nm.

In the case where the positive electrode active material 100 contains aluminum as the additive element, in the EDX line analysis, the peak of the magnesium concentration, the nickel concentration, or the fluorine concentration is preferably closer to the surface than the peak of the aluminum concentration is in the surface portion 100a. For example, the peak of the aluminum concentration is preferably observed in a region ranging from the surface of the positive electrode active material 100 to a depth of from 0.5 nm to 50 nm, both inclusive, further preferably a depth of from 3 nm and to 30 nm, both inclusive, toward the center of the positive electrode active material 100.

EDX line, area, or point analysis of the positive electrode active material 100 preferably reveals that the atomic ratio of magnesium to cobalt (Mg/Co) at a peak of the magnesium concentration is preferably greater than or equal to 0.05 and less than or equal to 0.6, further preferably greater than or equal to 0.1 and less than or equal to 0.4. The atomic ratio of aluminum to cobalt (Al/Co) at a peak of the aluminum concentration is preferably greater than or equal to 0.01 and less than or equal to 0.6, further preferably greater than or equal to 0.05 and less than or equal to 0.45. The atomic ratio of nickel to cobalt (Ni/Co) at a peak of the nickel concentration is preferably greater than or equal to 0 and less than or equal to 0.2, further preferably greater than or equal to 0.01 and less than or equal to 0.1, still further preferably greater than or equal to 0.05 and less than or equal to 0.1. The atomic ratio of fluorine to cobalt (F/Co) at a peak of the fluorine concentration is preferably greater than or equal to 0 and less than or equal to 1.6, further preferably greater than or equal to 0.1 and less than or equal to 1.4.

Although the analyses are described above, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

### <Positive Electrode Current Collector>

For the positive electrode current collector, metal foil can be used. The positive electrode can be formed by applying slurry onto metal foil and drying the slurry. Note that pressing may be performed after drying. The positive electrode is a component obtained by forming an active material layer over the positive electrode current collector 21.

The current collector can be formed using a material that has high conductivity, such as a metal like stainless steel, gold, platinum, aluminum, or titanium, or an alloy thereof. It is preferable that a material used for the positive electrode current collector not be dissolved at the potential of the positive electrode. It is also possible to use an aluminum alloy to which an element that improves heat resistance, such as silicon, titanium, neodymium, scandium, or molybdenum, is added. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### <Positive Electrode Binder>

A binder that can be used for the positive electrode is described.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

Alternatively, as the binder, a material such as polystyrene, poly(methyl acrylate), poly(methyl methacrylate) (abbreviation: PMMA), sodium polyacrylate, polyvinyl alcohol (abbreviation: PVA), polyethylene oxide (abbreviation: PEO), polypropylene oxide, polyimide, polyvinyl chloride, polytetrafluoroethylene, polyethylene, polypropylene, polyisobutylene, polyethylene terephthalate, nylon, polyvinylidene fluoride (abbreviation: PVDF), polyacrylonitrile (abbreviation: PAN), ethylene-propylene-diene polymer, polyvinyl acetate, or nitrocellulose is preferably used.

In addition to the binder, a thickener is preferably used in some cases. For the thickener, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used.

In the case where the binder that covers the active material surface or the binder in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferable that the passivation film can conduct lithium ions while suppressing electrical conduction.

### <Conductive Material>

The conductive material that can be used for the positive electrode and the negative electrode is also referred to as a conductivity-imparting agent or a conductive additive and is preferably a carbon material. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following: a case where covalent bonding occurs, a case where bonding with the Van der Waals force occurs, a case where a conductive material covers part of the surface of an active material, a case where a conductive material is embedded in surface roughness of an active material, and a case where an active material and a conductive material are electrically connected to each other without being in contact with each other.

As the conductive material, for example, one or more of carbon black such as acetylene black (AB) or furnace black, graphite such as artificial graphite or natural graphite, a carbon fiber such as a carbon nanofiber or a carbon nanotube, and a graphene compound can be used.

The contact between acetylene black and another active material or the like hardly becomes surface contact and tends to be point contact. Thus, in the case where the active material and acetylene black are mixed, it is probable that a large amount of acetylene black is used to reduce contact resistance; however, the discharge capacity of the secondary battery is decreased because the proportion of the active material is reduced. Moreover, acetylene black is a material that easily aggregates, and a slurry is preferably formed using a dispersant or the like such that acetylene black is uniformly dispersed.

In view of the above, in the negative electrode, the weight ratio of acetylene black is preferably lower than or equal to the weight ratio of silicon particles used for the negative electrode active material. In other words, when the weight ratio relationship is satisfied, the acetylene black can be mixed to exhibit high dispersibility, and the proportion of silicon particles is not reduced. Therefore, the discharge capacity of the secondary battery can be increased.

Examples of the carbon fiber include a mesophase pitch-based carbon fiber and an isotropic pitch-based carbon fiber. As the carbon fiber, a carbon nanofiber, a carbon nanotube, or the like can be used. Carbon nanotube can be formed by, for example, a vapor deposition method. As the carbon fiber, VGCF (registered trademark) may be used.

Examples of the above-described graphene include graphene, multilayer graphene, and multi graphene. Examples of the above-described graphene compound include graphene oxide, multilayer graphene oxide, multi graphene oxide, reduced graphene oxide, reduced multilayer graphene oxide, reduced multi graphene oxide, and graphene quantum dots. A graphene contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. Graphene preferably has hardness and a bent shape. The graphene compound may have a hole in a carbon ring, a ring larger than a six-membered ring (e.g., a seven-membered ring), or a functional group. The graphene compound is soft and may be rounded like a carbon nanofiber, for example.

Graphene or a graphene compound is capable of making surface contact with an active material or the like; thus, the amount of graphene or a graphene compound can be smaller than that of a normal conductive material. This can increase the proportion of the active material in the active material layer, resulting in increased discharge capacity of the secondary battery.

The contact between the carbon fiber and the active material or the like is surface contact and the fiber length of the carbon fiber is longer than the fiber diameter thereof; thus, the carbon fiber can function as an appropriate electrical path between the isolated active materials or the like. Accordingly, the amount of the carbon fiber can be smaller than that of a normal conductive material. This can increase the proportion of the active material in the active material layer, resulting in increased discharge capacity of the secondary battery.

### <Electrolyte Solution>

As one mode of an electrolyte solution, an electrolyte solution containing a solvent and an electrolyte dissolved in the solvent can be used. As a solvent for the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio. In the case where two or more kinds of them are included, the solvent is referred to as a mixed solvent in some cases.

As another mode of the electrolyte solution, one or more ionic liquids (room temperature molten salts) that are unlikely to burn and volatize can be used as the solvent. In this case, a power storage device can be prevented from exploding or catching fire even when a power storage device internally shorts out or the internal temperature increases owing to overcharge or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion. Specifically, for example, 1-ethyl-3-methylimidazolium bis(fluorosulfonyl)amide (abbreviation: EMI-FSA) can be used.

As the electrolyte dissolved in the solvent (also referred to as a lithium salt), for example, one of lithium salts such as LiPF₆, LiN(FSO₂)₂ (lithium bis(fluorosulfonyl)amide, LiFSA), LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (chemical formula: Li(C₂O₄)₂, abbreviation: LiBOB) can be used, or two or more of these lithium salts can be used in an appropriate combination in an appropriate ratio.

An additive agent may be mixed in a mixed solvent in which a lithium salt is dissolved. Examples of the additive agent include vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile. The concentration of such an additive agent in the mixed solvent where an e lithium salt is dissolved, is, for example, higher than or equal to 0.1 wt % and lower than or equal to 5 wt %.

### Example 1 of Electrolyte Solution

For a mixed solvent used in a lithium-ion battery of the present invention, a material having excellent lithium ion conductivity even when charge and/or discharge are/is performed in a low-temperature environment can be used.

Examples of the electrolyte solution are described below. Note that the electrolyte solution described in this embodiment is a solution in which a lithium salt is dissolved in a mixed solvent, and the mixed solvent is a liquid at room temperature. Note that the mixed solvent is not limited to being a liquid at room temperature, and a solid electrolyte that becomes a solid at room temperature can also be used. Alternatively, a semi-solid electrolyte containing both a liquid and a solid at room temperature can be used. A semi-solid electrolyte includes a gelled electrolyte.

A mixed solvent of the electrolyte solution of one embodiment of the present invention preferably contains two or more selected from a fluorinated cyclic carbonate and a fluorinated linear carbonate.

As the fluorinated cyclic carbonate, fluoroethylene carbonate (FEC or F1EC), difluoroethylene carbonate (DFEC or F2EC), trifluoroethylene carbonate (F3EC), or tetrafluoroethylene carbonate (F₄EC) can be used, for example. Note that DFEC has isomers such as a cis-4,5 isomer and a trans-4,5 isomer. Each of these fluorinated cyclic carbonates includes a substituent with an electron-withdrawing property and is thus presumed to allow the solvation energy of a lithium ion to be low.

Structural Formula (H10) below represents FEC. The substituent with an electron-withdrawing property in FEC is an F group.

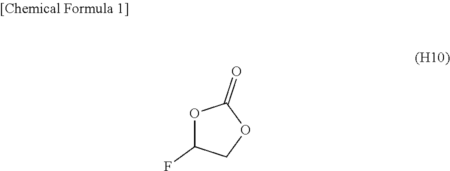

An example of the fluorinated linear carbonate is methyl 3,3,3-trifluoropropionate. Structural Formula (H22) below represents methyl 3,3,3-trifluoropropionate. An abbreviation of methyl 3,3,3-trifluoropropionate is MTFP. The substituent with an electron-withdrawing property in MTFP is a CF₃ group.

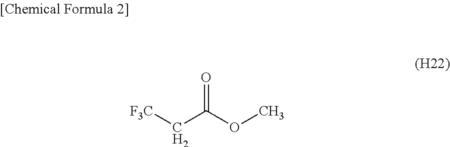

An example of the fluorinated linear carbonate is trifluoromethyl 3,3,3-trifluoropropionate. Structural Formula (H23) shown below represents trifluoromethyl 3,3,3-trifluoropropionate. The substituent with an electron-withdrawing property is a CF₃ group.

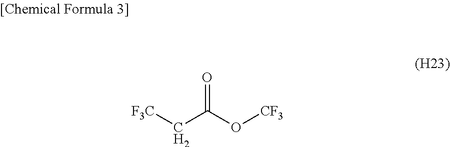 [SMILES: O=C(CC(F)(F)F)OC(F)(F)F]

An example of the fluorinated linear carbonate is trifluoromethyl propionate. Structural Formula (H24) shown below represents trifluoromethyl propionate. The substituent with an electron-withdrawing property is a CF₃ group.

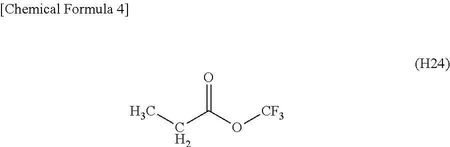

An example of the fluorinated linear carbonate is methyl 2,2-difluoropropionate. Structural Formula (H25) shown below represents methyl 2,2-difluoropropionate. The substituent with an electron-withdrawing property is a CF₂ group.

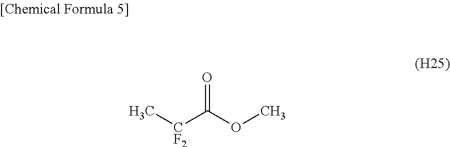

### <FEC and MTFP>

The mixed solvent described in this embodiment preferably contains FEC and MTFP. The reason for this is as follows.

FEC, which is a cyclic carbonate, has a high dielectric constant and thus has an effect of promoting dissociation of a lithium salt when used in an organic solvent. Meanwhile, because FEC includes the substituent with an electron-withdrawing property, a lithium ion is desolvated with FEC more easily than with ethylene carbonate (EC). Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is a linear carbonate, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP), which does not include a substituent with an electron-withdrawing property, MTFP may solvate a lithium ion when used for the electrolyte solution.

It is preferable that the above-described organic solvent be highly purified and contain a small amount of dust particles or molecules other than constituent molecules of the organic solvent (hereinafter also simply referred to as impurities and include oxygen (O₂), water (H₂O), and moisture). It is preferable that the organic solvent pass through appropriate purification and generation of a reaction by-product in synthesis be inhibited. Specifically, the impurity concentration in the electrolyte is less than or equal to 100 ppm, preferably less than or equal to 50 ppm, further preferably less than 10 ppm. The concentration of moisture in the impurity can be detected by Karl Fischer titration.

Furthermore, it is preferable that peaks attributed to impurities in the above organic solvent be hardly observed by NMR measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002. An apparatus used for the NMR measurement is not particularly limited, and for example, “AVANCE III 400” produced by Bruker Corporation can be used. Among the five peaks of acetonitrile derived from acetonitrile-d3 used in a solvent in the 1H-NMR measurement, the center peak can be 1.94 ppm.

For example, in the case of MTFP, it is known that when 1H-NMR is measured using an acetonitrile-d3 solvent, four peaks appear at δ of greater than or equal to 3.29 ppm and less than or equal to 3.43 ppm. However, in the case where another peak appears in the vicinity of the above range, for example, another peak appears at δ of greater than or equal to 3.24 ppm and less than or equal to 3.29 ppm, the peak is probably derived from impurities. Accordingly, when the ratio (integral ratio) of a peak area greater than or equal to 3.24 ppm and less than or equal to 3.29 ppm to a peak area greater than or equal to 3.29 ppm and less than or equal to 3.43 ppm is less than or equal to 0.005, preferably less than or equal to 0.002, peaks attributed to impurities are hardly observed.

The HOMO levels, the solvation energy, the measured melting points, and the like are collectively shown in the table below.

TABLE 1

| Organic compound | | | | |
|---|---|---|---|---|
| (abbreviation) | FEC | MTFP | EC | MP |
| Structural formula | 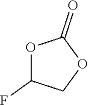 | 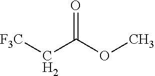 | 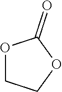 | 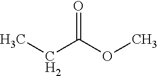 |
| HOMO level [eV] | −8.71 | −8.15 | −8.23 | −7.56 |
| Solvation energy [eV] | 5.39 | 4.33 to 5.38 | 5.79 | 4.45 to 5.22 |
| Measured value of | 17 | Unknown | 38 | −87.5 |
| melting point [° C.] | | | | |

FEC and MTFP having the above-described physical properties are preferably mixed in the volume ratio of x:100−x (where 5≤x≤30, preferably 10≤x≤20) on the assumption that a mixed organic solvent containing FEC and MTFP accounts for 100 vol %. In other words, MTFP and FEC are preferably mixed such that the amount of MTFP is larger than that of FEC in the mixed solvent. Note that the volume ratio may be the volume ratio measured before mixing of the mixed solvent, and the temperature at the time of mixing may be room temperature (typically 25° C.). The mixed solvent in which FEC and MTFP are mixed is preferable because the viscosity that enables a lithium-ion battery to operate is exhibited and appropriate viscosity is maintained even in a low-temperature environment.

A general solvent used for a lithium-ion battery is solidified at approximately −20° C.; thus, it is difficult to fabricate a lithium-ion battery that can be charged and discharged at −30° C., preferably at −40° C. However, the mixed solvent described as an example in this embodiment can have a freezing point lower than or equal to −30° C., preferably lower than or equal to −40° C., so that a lithium-ion battery that can be charged and discharged even in a low-temperature environment can be achieved. As a result, a lithium-ion battery capable of being charged and discharged in a wide temperature range including at least a low-temperature environment can be achieved.

Although FEC is described above as a typical example, the following also apply to any of the organic compounds described above as the fluorinated cyclic carbonate: having an effect of promoting dissociation of a lithium salt; having low solvation energy that brings easy disconnection of a bond between a lithium ion and a solvent; and having high viscosity and being difficult to use alone below freezing.

Although MTFP is described above as a typical example, any of the organic compounds described as the fluorinated linear carbonate can be regarded as having an effect of lowering or maintaining the viscosity of the electrolyte solution of one embodiment of the present invention. Therefore, a lithium-ion battery that can be charged and discharged in a low-temperature environment can be provided as long as the mixed solvent of one embodiment of the present invention contains a fluorinated cyclic carbonate and a fluorinated linear carbonate.

### Example 2 of Electrolyte Solution

As a mixed solvent of an electrolyte solution of another embodiment of the present invention, ethyl methyl carbonate (EMC), and dimethyl carbonate (DMC) in the electrolyte solution, it is possible to use a mixed organic solvent in which the volume ratio between EC, EMC, and DMC is x:y:100−x−y (where 5≤x≤35 and 0<y<65) on the assumption that the total content of EC, EMC, and DMC is 100 vol %. More specifically, a mixed solvent containing EC, EMC, and DMC in the ratio of 30:35:35 by volume can be used. Note that the volume ratio may be the volume ratio measured before mixing of the mixed solvent, and the temperature at the time of mixing may be room temperature (typically 25° C.).

EC is cyclic carbonate and has high dielectric constant, and thus has an effect of promoting dissociation of a lithium salt. Meanwhile, the EC has high viscosity and has a high freezing point (melting point) of 38° C.; thus, it is difficult to use in a low-temperature environment when EC is used alone as the solvent. Then, the organic solvent specifically described in one embodiment of the present invention includes not only EC but also EMC and DMC. EMC is a chain-like carbonate and has an effect of decreasing the viscosity of the electrolyte solution, and the freezing point is −54° C. In addition, DMC is also a chain-like carbonate and has an effect of decreasing the viscosity of the electrolyte solution, the freezing point is −43° C. An electrolyte solution formed using a mixed solvent in a volume ratio of x:y:100−x−y (note that 5≤x≤35 and 0<y<65) with a total content of these three solvents of EC, EMC, and DMC having such physical properties of 100 vol % has a characteristic in which the freezing point is lower than or equal to −40° C.

A general electrolyte solution used for a lithium-ion battery is solidified at approximately −20° C.; thus, it is difficult to fabricate a battery that can be charged and discharged at −40° C. Since the electrolyte solution described as an example in this embodiment has a freezing point at lower than or equal to −40° C., a lithium-ion battery that can be charged and discharged even in a low-temperature environment such as at −40° C. can be obtained.

A lithium salt can be used for an electrolyte dissolved in the solvent. For example, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination in an appropriate ratio. The lithium salt dissolved in the solvent is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the solvent. A specific usage example is that LiPF₆ is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the solvent.

The mixed solvent is preferably highly purified and contains a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

In order to form a coating film (solid electrolyte interphase film) at the interface between the electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithiumbis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

In Example 2 of electrolyte solution, the material described in Example 1 of electrolyte solution can be used for the lithium salt. Also for the additive agent, the material described in Example 1 of electrolyte solution can be used.

Although an example of an electrolyte solution that can be used for the lithium-ion battery of one embodiment of the present invention is described above, the electrolyte solution that can be used for the lithium-ion battery of one embodiment of the present invention should not be construed as being limited to the example. Another material can be used as long as it has high lithium ion conductivity even when the lithium-ion battery is charged and discharged in a low-temperature environment.

### [Negative Electrode]

The negative electrode includes a negative electrode active material layer and a negative electrode current collector. The negative electrode active material layer includes a negative electrode active material.

### <Negative Electrode Binder>

As a binder of the negative electrode of one embodiment of the present invention, a polymer including a carboxy group is preferably used. It can be said that the carboxy group includes two basic oxygen atoms, one acidic hydrogen atom, and one electrophilic carbon atom. It can also be said that the carboxy group includes OH, which is a hydroxy group, and C═O, which is a carbonyl group, and is a group having a polarity. When the binder includes a group having a polarity, such as a carboxy group, interaction with a lithium ion serving as a carrier ion is expected, and lithium ions are drawn, for example; thus, insertion of lithium ions in the negative electrode active material might be aided. Note that the carboxy group can be specified by FT-IR or the like.

Examples of a polymer including a carboxy group include polyglutamic acid (sometimes referred to as PGA), poly(acrylic acid) (sometimes referred to as PAA), and alginic acid (sometimes referred to as polysaccharide). Alternatively, polyamino acid may be used as the polymer including a carboxy group; specifically, polyornithine or polysarcosine may be used for the binder. Furthermore, as a polymer including a ketone group, polyaspartic acid may be used for the binder. Alternatively, a binary copolymer (copolymer) may be used as the polymer including a ketone group; a copolymer of acrylic acid and maleic acid or a copolymer of acrylic acid and sulfonic acid may be used for the binder. Use of such materials for a binder of a negative electrode also brings an effect of reducing the amount of the binder mixed in the negative electrode.

Among the above-described polymers, polyglutamic acid or poly(acrylic acid) is particularly preferable as the binder used for the negative electrode. The structural formula of polyglutamic acid is shown below.

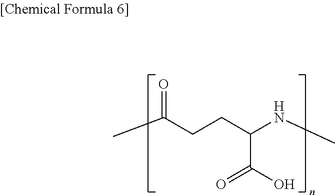

Polyglutamic acid contains nitrogen in addition to the carboxy group as shown in the structural formula. The nitrogen includes an unshared electron pair and thus is expected to interact with a lithium ion serving as a carrier ion. For example, the unshared electron pair possibly draws lithium ions to aid insertion of lithium ions into the negative electrode active material.

As is apparent from the structural formula, the polyglutamic acid includes C═O, which is a carbonyl group, in addition to a carboxy group. When the binder includes a group having a polarity, such as a carbonyl group, interaction with a lithium ion serving as a carrier ion is expected, and insertion and extraction of lithium ions in the negative electrode active material might be aided.

As the polyglutamic acid, either straight-chain γ-polyglutamic acid or cross-linked γ-polyglutamic acid may be used for the binder, and these acids are collectively referred to as a structure including γ-polyglutamic acid as a main component. Note that the cross-linked γ-polyglutamic acid is more suitable for the binder because it has a net-like structure. Furthermore, the molecular weight of the polyglutamic acid is preferably greater than or equal to 1 million, further preferably greater than or equal to 3 million, still further preferably greater than or equal to 10 million and less than or equal to 50 million.

Depending on the formation method, polyglutamic acid can be referred to as γ-polyglutamic acid containing another element (e.g., Ca, Al, Na, Mg, Fe, Si, or S) as a main component. That is, polyglutamic acid may be neutralized with an alkali metal ion, for example, a lithium ion or a sodium ion.

Such polyglutamic acid has hydrophilicity and thus deionized water can be used as the solvent, which is suitable for formation of a slurry.

Next, the structural formula of poly(acrylic acid) is shown below.

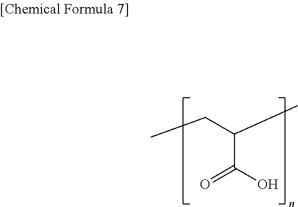

As is apparent from the structural formula, poly(acrylic acid) includes a carboxy group.

A material in which poly(acrylic acid) is cross-linked may be used. A cross-link structure, i.e., a net-like structure, can be formed, which is preferable because the function of the binder can be enhanced.

### <Negative Electrode Active Material>

The negative electrode of one embodiment of the present invention contains both a carbon particle and a silicon particle as the negative electrode active material. As the carbon particle, graphite, carbon having a layered structure like graphite, amorphous carbon, hard carbon, or a carbon fiber is used. As the carbon particle used in this specification, specifically, a graphite particle is preferably used.

Examples of graphite include artificial graphite and natural graphite. Examples of artificial graphite include mesocarbon microbeads (MCMB), coke-based artificial graphite, and pitch-based artificial graphite. For example, MCMB is preferably used because it may have a spherical shape. Moreover, MCMB is preferably used because it can relatively easily have a small surface area. Examples of natural graphite include flake graphite and spherical natural graphite.

The average particle diameter of graphite particles of one embodiment of the present invention is preferably greater than or equal to 1 μm, further preferably greater than or equal to 5 μm, still further preferably greater than or equal to 10 μm, yet still further preferably greater than or equal to 20 μm. The graphite particle is preferably mixed with the silicon particle to be used for the negative electrode.

The average particle diameter of graphite particles can be measured with a particle size distribution analyzer or the like using a laser diffraction and scattering method. In this specification and the like, the average particle diameter of graphite particles can be calculated as the median diameter (D50).

The specific surface area of the graphite particle is preferably greater than or equal to 0.5 m²/g and less than or equal to 3 m²/g. The specific surface area can be measured by a BET method. The specific surface area by a BET method is a value measured by a nitrogen gas adsorption one-point BET method, and a micromeritics automatic surface area and porosimetry analyzer Tristar II3020 (produced by SHIMADZU CORPORATION) can be used as a measuring instrument.

As the silicon particle, a silicon particle with an average particle diameter of 100 nm or in the vicinity thereof is preferably used, which is referred to as a nanosilicon particle in some cases. The capacity of silicon per weight is 4200 mAh/g, which is greater than or equal to ten times the capacity of graphite, 372 mAh/g (per active material weight). In the case of a negative electrode using only silicon, there is a problem of drastic cycle deterioration caused by expansion and contraction in charge and discharge. Thus, in order to inhibit cycle degradation, nanosilicon particles, i.e., silicon miniaturized to have the above-described average particle diameter, are suitable.

The average particle diameter of silicon particles can be measured with a particle size distribution analyzer or the like using a laser diffraction and scattering method. In this specification and the like, the average particle diameter of silicon particles can be calculated as the median diameter (D50).

In order to obtain silicon particles to be used, it is preferable that a silicon source material be ground and particle diameters be adjusted to be uniform. Through the adjustment, silicon particles with an average particle diameter of less than 1 μm can be obtained. Note that the average particle diameter is preferably less than 1 μm because the negative electrode active material layer might be thick in the case where the average particle diameter is large. The silicon particle is formed using a silicon-based material; specifically, the silicon particle contains at least one of silicon, silicon oxide, and a silicon alloy.

The specific surface area of the silicon particle is preferably greater than or equal to 10 m²/g and less than or equal to 35 m²/g, further preferably greater than or equal to 10 m²/g and less than or equal to 15 m²/g. The specific surface area can be measured by a BET method. The specific surface area by a BET method is a value measured by a nitrogen gas adsorption one-point BET method, and a micromeritics automatic surface area and porosimetry analyzer Tristar II3020 (produced by SHIMADZU CORPORATION) can be used as a measuring instrument.

The negative electrode active material of one embodiment of the present invention contains both graphite particles and silicon particles, achieving a lithium-ion battery with high discharge capacity. Furthermore, since the average particle diameter of graphite particles is different from the average particle diameter of silicon particles, when these particles are mixed and used for a negative electrode, the carried amount of the negative electrode active material can be increased. In this specification, the carried amount refers to the weight of a negative electrode active material per unit surface area of a negative electrode current collector. The carried amount of a negative electrode active material can be obtained in accordance with the capacity of a positive electrode. When the carried amount is small, output characteristics of the lithium-ion battery can be increased but the discharge capacity is decreased. Thus, the carried amount of a negative electrode active material is preferably larger than or equal to 1.5 mg/cm².

In the negative electrode active material layer of one embodiment of the present invention, the weight ratio of graphite particles is preferably higher than the weight ratio of silicon particles; for example, the weight ratio of graphite particles is preferably greater than or equal to 5 times and less than or equal to 15 times the weight ratio of silicon particles. In other words, the silicon weight ratio in the total weight of the powder materials forming the negative electrode active material is greater than or equal to 7.5 wt % and less than or equal to 37.5 wt %.

When the negative electrode active material layer is formed, a conductive material may be added.

In a lithium-ion battery, a negative electrode active material layer can be formed on one surface or both surfaces of the negative electrode current collector. The negative electrode active material layer is completed through applying slurry onto the negative electrode current collector, drying, and the like.

Note that in this specification, the weight ratio of the raw materials may be regarded as the compounding ratio of the raw materials mixed when the slurry is formed. That is, the weight ratio of the negative electrode active material is the compounding ratio (wt %) of the negative electrode active material with respect to the total weight of the negative electrode active material and the binder in the slurry or the total weight of the negative electrode active material, the binder, and the conductive material. The weight ratio and the compounding ratio can be understood by replacing the negative electrode active material with the binder.

The weight ratio of the binder is preferably smaller than the weight ratio of graphite particles. In addition, in order to obtain an effect as the binder, the weight ratio of the binder is preferably larger than 5 wt %.

### <Negative Electrode Current Collector>

For the negative electrode current collector, copper or the like can be used in addition to a material similar to that for the positive electrode current collector. Note that a metal that is alloyed with lithium ions, such as aluminum, cannot be used for the negative electrode current collector.

### <Method for Forming Negative Electrode Active Material Layer>

Here, a method for forming the negative electrode active material layer is described. The slurry of the negative electrode of one embodiment of the present invention is preferably formed by mixing graphite particles, silicon particles, and a binder including a carboxy group, adding a solvent thereto, and mixing them. In the slurry of one embodiment of the present invention, the graphite particles, the silicon particles, and the binder including a carboxy group can be mixed at the same time, which is preferable because the process can be simplified. Furthermore, in the formation of the slurry, the graphite particles, the silicon particles, the binder including a carboxy group, and the solvent can be mixed at the same time. Moreover, in the formation of the slurry, the conductive material can also be mixed at the same time. As the conductive material, the above-described conductive material can be used, and for example, acetylene black is preferably used.

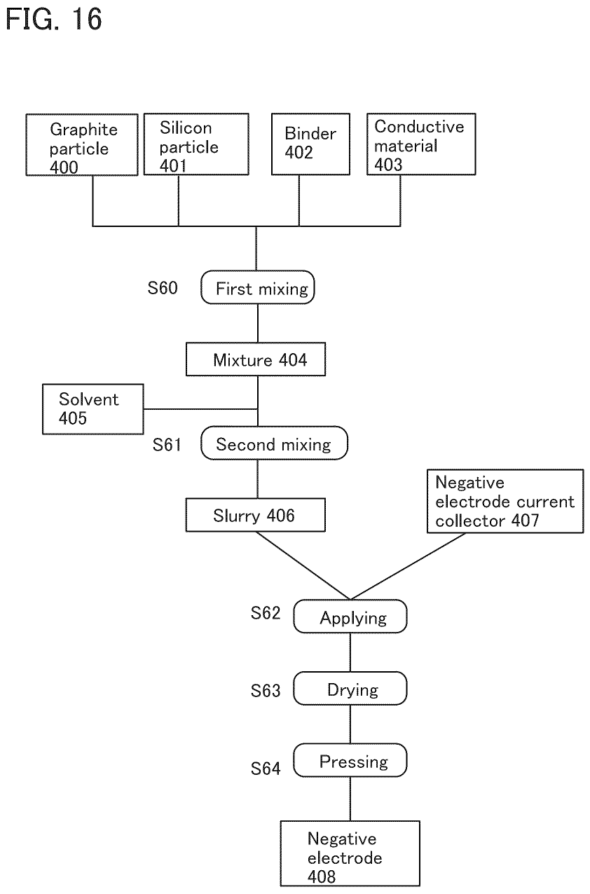

FIG. 16 illustrates an example of a formation process of the negative electrode active material layer.

First, a graphite particle 400, a silicon particle 401, a binder 402, and a conductive material 403 are prepared. As the binder, a polymer including a carboxy group is used.

### <Step S60>

The above-described raw materials are weighed, and first mixing in Step S60 in FIG. 16 is performed. Specifically, the weight ratio of the silicon particle 401 in the total weight of powders mixed in the first mixing is greater than or equal to 7.5 wt % and less than or equal to 37.5 wt %, and the weight ratio of the binder 402 in the total weight is greater than or equal to 10 wt % and less than or equal to 50 wt %. Furthermore, the weight ratio of the conductive material 403 in the total weight is greater than or equal to 0 wt % and less than or equal to 20 wt %. Note that acetylene black is preferably used as the conductive material 403 that satisfies the above weight ratio.

For example, the silicon particle 401, the graphite particle 400, the binder 402, and the conductive material 403 are weighed such that the weight ratio becomes 3:5:1:1. Alternatively, for example, the conductive material is not used and the silicon particle 401, the graphite particle 400, and the binder 402 are weighed such that the weight ratio becomes 3:5:1. The graphite particle 400, the silicon particle 401, and the binder 402 may be weighed such that the weight ratio of the graphite particle 400 to the silicon particle 401 and the binder 402 is 9:1:1.

### <Mixing of Mixture 404 and Solvent 405>

In one embodiment of the present invention, since all the raw materials are powders in Step S60, mixing is performed before the solvent is added, whereby a mixture 404 is obtained. When the powders are mixed with each other, they can be uniformly mixed. After that, a solvent 405 is preferably added. Deionized water is preferably used as the solvent 405.

### <Step S61>

After the solvent 405 is added, second mixing in Step S61 in FIG. 16 is performed to form a slurry 406. The second mixing may also be referred to as slurry preparation.

The slurry 406 is a material solution that is used to form an active material layer over the current collector and includes at least an active material, a binder, and a solvent, and may further include a conductive additive. The slurry may also be referred to as a slurry for an electrode or an active material slurry.

Then, as Step S62 in FIG. 16, the slurry 406 is applied onto a negative electrode current collector 407. After that, drying is performed in Step S63 in FIG. 16. As the drying, pre-drying and main drying may be performed. That is, the drying step is performed twice, and the conditions of the earlier drying step are milder. For example, drying can be performed with a drying machine at higher than or equal to 40° C. and lower than or equal to 60° C. for longer than or equal to 10 minutes and shorter than or equal to an hour, which can be pre-drying. Then, as the main drying, drying can be performed with a drying machine at higher than 60° C. and lower than or equal to 90° C. for longer than or equal to 30 minutes and shorter than or equal to 1.5 hours. Pressing may be performed at the same time as drying.

After the drying, pressing is performed in Step S64 in FIG. 16. Although a roller press machine can be used in the pressing, the temperatures of rollers positioned vertically can be higher than or equal to 100° C. and lower than or equal to 150° C. That is, heating may be performed at the same time as the pressing. The linear pressure during the pressing is preferably higher than or equal to 0.3 MPa and lower than or equal to 1 MPa. The lithium-ion battery can operate even when the pressing is omitted.

Through the above-described steps, a negative electrode 408 in which the negative electrode active material layer is provided over the negative electrode current collector 407 can be formed.

A lithium-ion battery including the negative electrode 408 obtained in this manner has high discharge capacity and shows excellent cycle performance.

Note that the silicon particles are preferably prevented from being oxidized. For example, in the formation of the slurry, mixing is preferably performed such that the silicon particles are not oxidized.

The contents in this embodiment can be freely combined with the contents in any of the other embodiments.

### [Separator]

The separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator in high-voltage charging can be suppressed and thus the reliability of the secondary battery can be improved. When the separator is coated with the fluorine-based material, the separator is easily brought into close contact with the electrode, resulting in high output characteristics. When the separator is coated with the polyamide-based material, in particular, aramid, heat resistance is improved; thus, the safety of the secondary battery is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Example of Electrode Stack]

A structural example of a stack including a plurality of electrodes is described below.

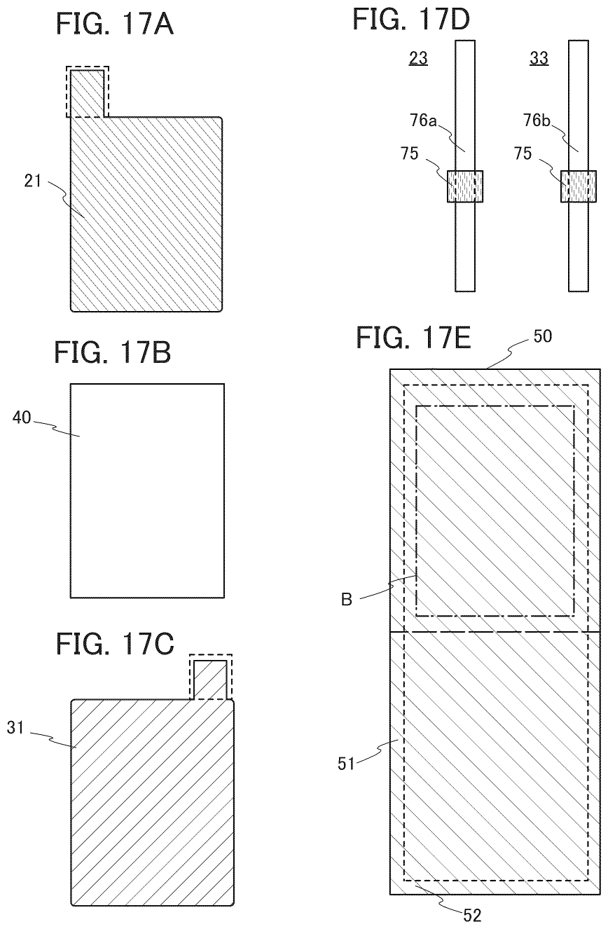

FIG. 17A shows a top view of the positive electrode current collector 21, FIG. 17B shows a top view of the separator 40, FIG. 17C shows a top view of the negative electrode current collector 31, FIG. 17D shows a top view of a positive electrode lead 23 and a negative electrode lead 33, and FIG. 17E shows a top view of a film-like exterior body 50. The positive electrode lead 23 includes a sealing layer 75 and a lead metal 76a, and the negative electrode lead 33 includes the sealing layer 75 and a lead metal 76b.

The dimensions in the drawings of FIGS. 17A to 17E are substantially the same, and a region B surrounded by a dashed-dotted line in FIG. 17E has substantially the same dimensions as the separator in FIG. 17B. A region between a dashed line and the edge in FIG. 17E becomes a sealing portion 51 and a sealing portion 52.

The protruding portion of the positive electrode current collector 21 (a dashed line portion in FIG. 17A) and the protruding portion of the negative electrode current collector 31 (a dashed line portion in FIG. 17C) are referred to as tab portions.

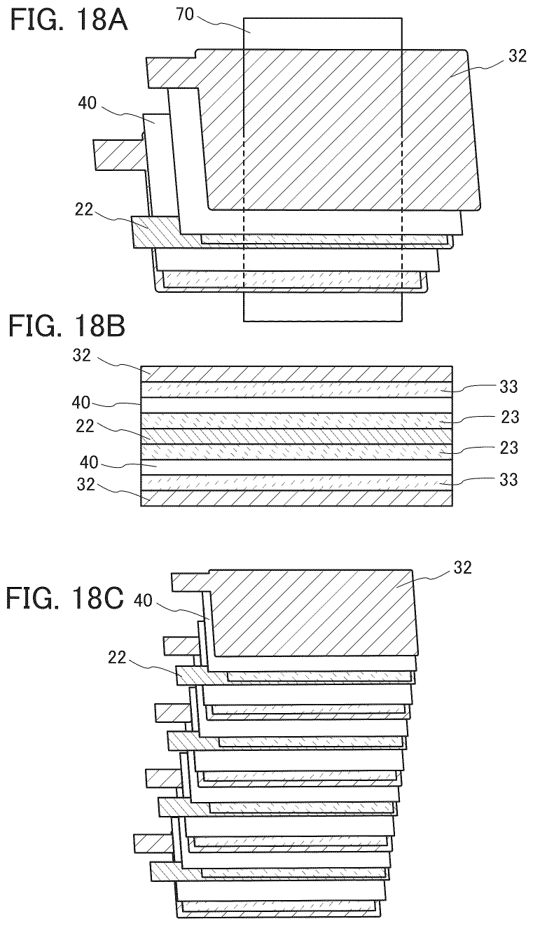

FIG. 18A is an example in which the positive electrode active material layer 22 is provided on both surfaces of the positive electrode current collector 21. Specifically, the negative electrode current collector 31, the negative electrode active material layer 32, the separator 40, the positive electrode active material layer 22, the positive electrode current collector 21, the positive electrode active material layer 22, the separator 40, the negative electrode active material layer 32, and the negative electrode current collector 31 are stacked in this order. FIG. 18B shows a cross-sectional view of the stacked-layer structure taken along a plane 70.

Although FIG. 18A illustrates an example in which two separators are used, a structure may be employed in which one separator is folded and both ends are sealed to form a bag-like shape, and the positive electrode current collector 21 is held therein. The positive electrode active material layer 22 is formed on both surfaces of the positive electrode current collector 21 held in the separator having a bag-like shape.

The negative electrode active material layer 32 can be provided on both surfaces of the negative electrode current collector 31. FIG. 18C illustrates an example of a secondary battery in which three negative electrode current collectors 31 each provided with the negative electrode active material layers 32 on both surfaces, four positive electrode current collectors 21 each provided with the positive electrode active material layers 22 on both surfaces, and eight separators 40 are sandwiched between two negative electrode current collectors 31 each provided with the negative electrode active material layer 32 on one surface. In this case, four separators each having a bag-like shape may be used instead of eight separators.

The capacity of the secondary battery can be increased by increasing the number of stacks. In addition, when the positive electrode active material layers 22 are provided on both surfaces of the positive electrode current collector 21 and the negative electrode active material layers 32 are provided on both surfaces of the negative electrode current collector 31, the thickness of the secondary battery can be made small.

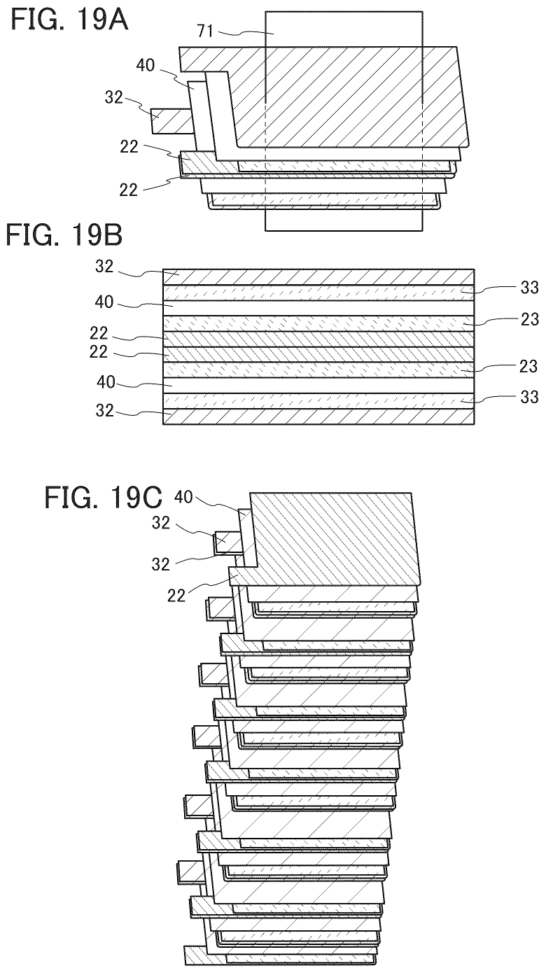

FIG. 19A shows a diagram of a secondary battery in which the positive electrode active material layer 22 is provided on one surface of the positive electrode current collector 21 and the negative electrode active material layer 32 is provided on one surface of the negative electrode current collector 31. Specifically, the negative electrode active material layer 32 is provided on one surface of the negative electrode current collector 31 and the separator 40 is stacked in contact with the negative electrode active material layer 32. The positive electrode active material layer 22 provided on one surface of the positive electrode current collector 22 is in contact with the surface of the separator 40 that is not in contact with the negative electrode active material layer 32. Another positive electrode current collector 22 whose one surface is provided with the positive electrode active material layer 22 is in contact with the surface of the positive electrode current collector 22. In that case, the positive electrode current collectors 21 are provided such that the surfaces not provided with the positive electrode active material layers 22 face each other. Then, another separator 40 is formed, and the negative electrode active material layer 32 provided on one surface of the negative electrode current collector 31 is stacked in contact with the separator. FIG. 19B shows a cross-sectional view of the stacked-layer structure in FIG. 19A taken along a plane 86.

Although two separators are used in FIG. 19A, a structure may be employed in which one separator is folded and both ends are sealed to form a bag-like shape, and two positive electrode current collectors 21 each provided with the positive electrode active material layer 22 on one surface are provided between the facing portions of the separator.

In FIG. 19C, a plurality of the stacked-layer structures each of which is illustrated in FIG. 19A are stacked. In FIG. 19C, the negative electrode current collectors 31 are provided such that the surfaces not provided with the negative electrode active material layers 32 face each other. FIG. 19C illustrates a state where twelve positive electrode current collectors 21, twelve negative electrode current collectors 31, and twelve separators 40 are stacked.

A secondary battery with a structure in which the positive electrode active material layer 22 is provided on one surface of the positive electrode current collector 21 and the negative electrode active material layer 32 is provided on one surface of the negative electrode current collector 31 has a larger thickness than a secondary battery with a structure in which the positive electrode active material layers 22 are provided on both surfaces of the positive electrode current collector 22 and the negative electrode active material layers 32 are provided on both surfaces of the negative electrode current collector 31. However, the surface of the positive electrode current collector 22 on which the positive electrode active material layer 22 is not provided faces the surface of another positive electrode current collector 22 on which the positive electrode active material layer 22 is not provided; as a result, the current collectors are in contact with each other. Similarly, the surface of the negative electrode current collector 31 on which the negative electrode active material layer 32 is not provided faces the surface of another negative electrode current collector 31 on which the negative electrode active material layer 32 is not provided; as a result, the current collectors are in contact with each other. For example, in the case where treatment for improving slidability is performed on the surface of the positive electrode current collector 21 on which the positive electrode active material layer 22 is not provided and/or the surface of the negative electrode current collector 31 on which the negative electrode active material layer 32 is not provided, friction force on the contact surfaces of the current collectors is not so strong and the contact surfaces of the current collectors can easily slide on each other. That is, the current collectors in the secondary battery slide on each other at the time of bending the secondary battery; thus, the secondary battery can be easily bent. As the treatment for improving slidability which is performed on the current collectors, fluororesin (e.g., polytetrafluoroethylene) coating, graphene coating, graphene compound coating, or the like can be used, for example.

The plurality of positive electrode current collectors 21 are stacked as illustrated in FIGS. 18A to 18C or FIGS. 19A to 19C and are all fixed and electrically connected to each other. Similarly, the plurality of negative electrode current collectors 31 are all fixed and electrically connected to each other.

Here, it is preferable that the positive electrode lead 23 and the plurality of positive electrode current collectors 21 be fixed and electrically connected to each other at the same time. Similarly, it is preferable that the negative electrode lead 33 and the plurality of negative electrode current collectors 31 be fixed and electrically connected to each other at the same time. When a plurality of current collectors and an electrode lead are connected at the same time in this manner, fabrication can be performed efficiently.

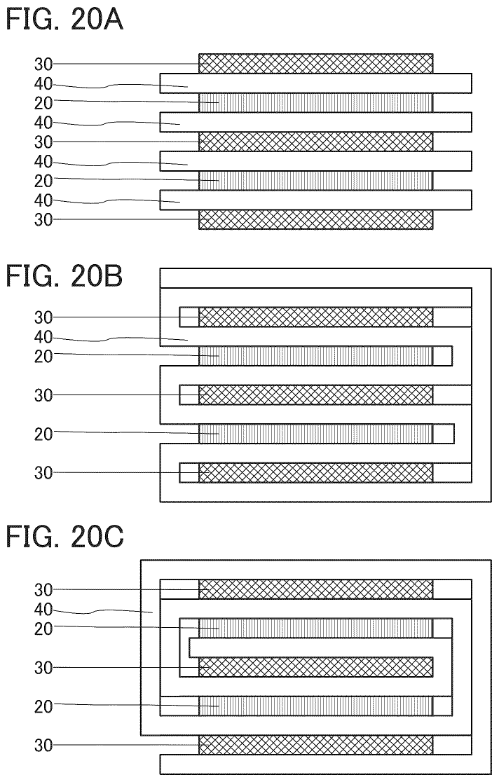

The separators 40 preferably have a shape that helps prevent an electrical short circuit between the positive electrode 20 and the negative electrode 30. For example, the width of each of the separators 40 is preferably larger than those of the positive electrode 20 and the negative electrode 30 as illustrated in FIG. 20A, in which case the positive electrode 20 and the negative electrode 30 are less likely to come in contact with each other even when the relative positions thereof are shifted because of a change in shape such as bending. As illustrated in FIG. 20B, one separator 40 is preferably folded into an accordion-like shape, or as illustrated in FIG. 20C, one separator 40 is preferably wrapped around the positive electrodes 20 and the negative electrodes 30 alternately, in which case the positive electrode 20 and the negative electrode 30 do not come in contact with each other even when the relative positions thereof are shifted. FIGS. 20B and 20C each illustrate an example in which the separator 40 is provided to partly cover the side surface of a stacked-layer structure of the positive electrodes 20 and the negative electrodes 30.

Although the drawings of FIG. 20 do not illustrate the details of the positive electrode 20 and the negative electrode 30, the above description can be referred to for formation methods thereof. Although an example in which one positive electrodes 20 and one negative electrodes 30 are alternately arranged is described here, two positive electrodes 20 or two negative electrodes 30 may be adjacent to each other as illustrated in FIGS. 19A to 19C.

Although a structure example in which one rectangle film is folded in half and two end portions are made to overlap with each other for sealing is described in this embodiment, the shape of the film is not limited to a rectangle. A polygon such as a triangle, a square, or a pentagon or any symmetric shape other than a rectangle, such as a circle or a star, may be employed.

The stack described with reference to any of FIGS. 18A to 18C, FIGS. 19A to 19C, and FIGS. 20A to 20C and the electrolyte solution described above are held in the exterior body and the exterior body is sealed, whereby the lithium-ion battery can be fabricated.

### [Exterior Body]

For an exterior body included in the battery, a resin material or a metal material such as aluminum, stainless steel, or titanium can be used, for example. A film-like exterior body can also be used. As the film, for example, it is possible to use a film having a three-layer structure in which a highly flexible metal thin film or metal foil of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a film with a multilayer structure can be referred to as a laminated film. At this time, the laminated film is sometimes referred to as an aluminum laminated film, a stainless steel laminated film, a titanium laminated film, a copper laminated film, a nickel laminated film, or the like using the material name of the metal layer included in the laminated film.

The material or thickness of the metal layer included in the laminated film sometimes affects the flexibility of a battery. As an exterior body used for a highly flexible (bendable) battery, for example, an aluminum laminated film including a polypropylene layer, an aluminum layer, and nylon is preferably used. Here, the thickness of the aluminum layer is preferably smaller than or equal to 50 μm, further preferably smaller than or equal to 40 μm, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is desirably larger than or equal to 10 μm.

A graphene sheet may be substituted for the above metal layer of the laminated film. As the graphene sheet, a multilayer graphene sheet with a thickness greater than or equal to 100 nm and less than or equal to 30 μm, preferably greater than or equal to 200 nm and less than or equal to 20 μm can be used. The graphene sheet is flexible and has a gas barrier property with the interlayer distance of graphene of 0.34 nm and thus is suitable as a film used for the exterior body of the secondary battery.

### [Method for Processing Film Having Depressed Portion and Projecting Portion]

Next, a method for processing a film that can be used for the exterior body is described. As the film, the above-described laminated film can be used.

As the laminated film, a stacked-layer film can be used, for example. As the stacked-layer film, for example, a metal film including a heat-seal layer on one surface or both surfaces can be used. As an adhesive layer, a heat-seal resin film containing polypropylene, polyethylene, or the like can be used. In this embodiment, an aluminum laminated film in which a surface of aluminum foil is provided with a nylon resin and the rear surface of the aluminum foil is provided with a stack of an acid-proof polypropylene film and a polypropylene film is used.

Then, the film is embossed. As a result, the film having projections and depressions can be formed. The film includes a plurality of projections and depressions, thereby having a wave pattern that can be visually recognized.

Embossing, which is a kind of pressing, will be described below.

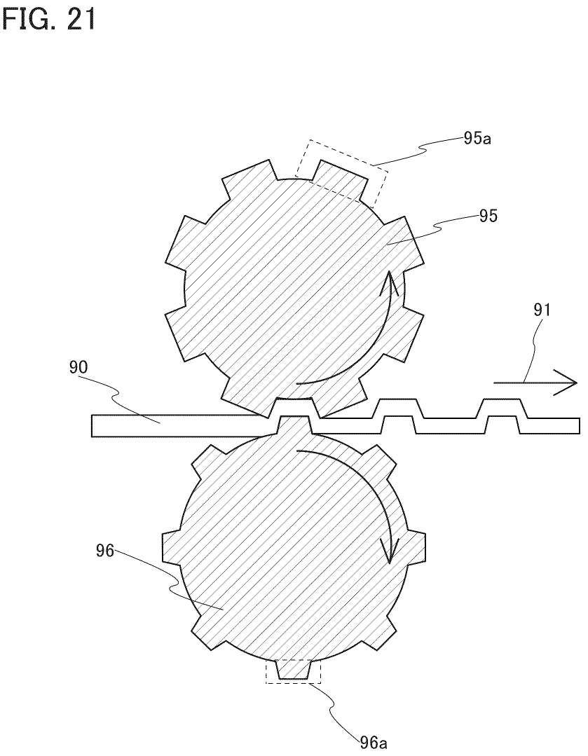

FIG. 21 is a cross-sectional view illustrating an example of embossing. Note that embossing, which is a kind of pressing, refers to processing for forming projections and depressions corresponding to projections and depressions of an embossing roll on a film by bringing the embossing roll whose surface has projections and depressions into contact with the film with pressure. Note that the embossing roll is a roll whose surface is patterned.

FIG. 21 illustrates an example in which both surfaces of a film are embossed. FIG. 21 illustrates a forming method of a film having projections whose top portions are on one surface side.

FIG. 21 illustrates the state where a film 90 is sandwiched between an embossing roll 95 in contact with one surface of the film and an embossing roll 96 in contact with the other surface and the film 90 is being transferred in a direction 91. The surface of the film is patterned by pressure or heat. The surface of the film may be patterned by pressure and heat.

As the embossing roll, a metal roll, a ceramic roll, a plastic roll, a rubber roll, an organic resin roll, a lumber roll, or the like can be used as appropriate.

In FIG. 21, embossing is performed using the male embossing roll 96 and the female embossing roll 95. The male embossing roll 96 has a plurality of projections 96a. The projections correspond to projections formed on a film to be processed. The female embossing roll 95 has a plurality of projections 95a. Between adjacent projections 95a, a depression is positioned into which a projection formed on the film by the projection 96a of the male embossing roll 96 fits. Successive embossing by which the film 90 partly stands out and debossing by which the film 90 is partly indented can form a projection and a flat portion successively. In this manner, a pattern can be formed on the film 90.

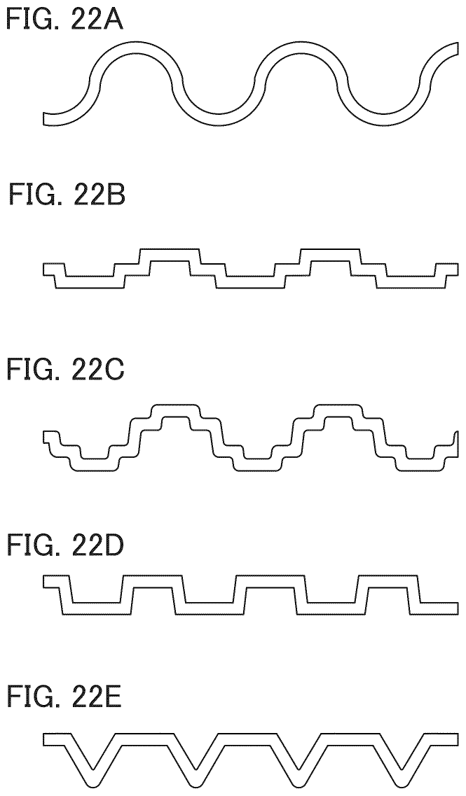

Next, a film having a plurality of projections with a shape different from that in FIG. 21 is described with reference to FIGS. 22A to 22E. The shape of projections of the embossing roll 95 and the embossing roll 96 in FIG. 21 is changed to a shape different from that in FIG. 21, whereby embossing into various cross-sectional shapes illustrated in FIGS. 22A to 22E can be performed.

FIG. 22A is a schematic cross-sectional view of an embossment having a wave shape, and FIGS. 22B to 22E are modification examples of FIG. 22A. FIGS. 22B and 22C are diagrams illustrating examples of forming a stepwise wave shape, FIG. 22D is a diagram illustrating an example of forming a rectangular wave shape, and FIG. 22E is a diagram illustrating an example of forming a wave shape with acute troughs and trapezoidal crests.

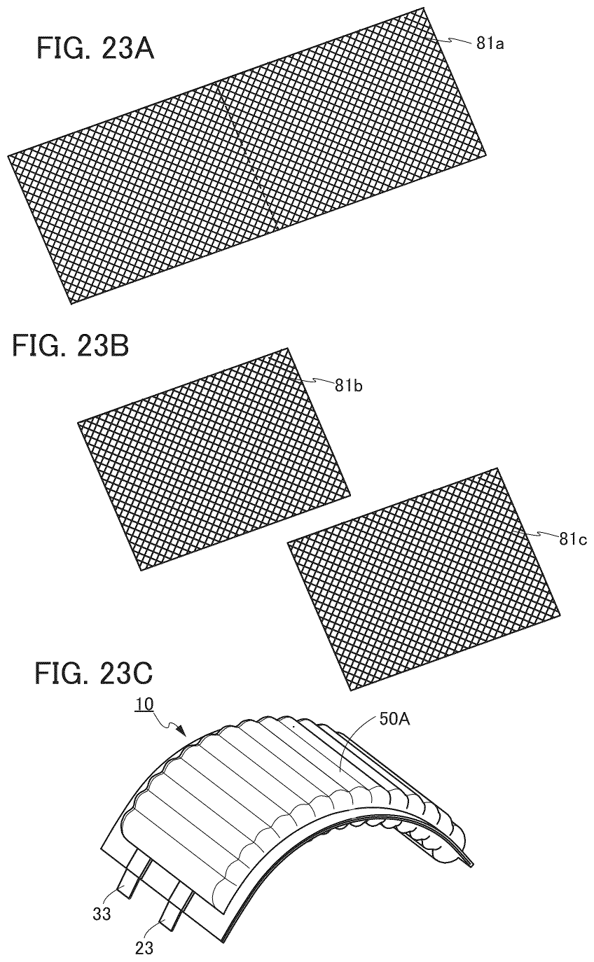

FIGS. 23A and 23B are bird's eye views illustrating the completed shapes obtained by performing the embossing illustrated in FIG. 21 and FIGS. 22A to 22E twice with different orientations of the film 90. Specifically, embossing is performed on the film 90 in a first direction, and then embossing is performed on the film 90 in a second direction that is rotated 90° with respect to the first direction, whereby a film 81 (a film 81a, a film 81b, and a film 81c) having an embossed shape (also referred to as an alternating wave shape) illustrated in FIGS. 23A and 23B can be obtained. Note that when a secondary battery is fabricated using one film 81a, the film 81a having an alternating wave shape has an external shape illustrated in FIG. 23A and can be used by being folded in two along a dashed line portion. When a secondary battery is fabricated using two films (the film 81b and the film 81c), the plurality of films (the film 81b and the film 81c) each having an alternating wave shape have an external shape illustrated in FIG. 23B, and the film 81b and the film 81c can overlap with each other to be used.

When processing is performed using the embossing rolls in the aforementioned manner, an apparatus can be small. Furthermore, a film before being cut can be processed, achieving excellent mass productivity. Note that a film processing method is not limited to processing using embossing rolls; a film may be processed by pressing a pair of embossing plates having a surface with projections and depressions against the film. In that case, one of the embossing plates may be flat and the film may be processed in a plurality of steps.

FIG. 23C is a perspective view illustrating a state where the battery 10, which is fabricated using a laminated film obtained by wave-type embossing in one direction for an exterior body 50A, is curved. When the laminated film obtained by wave-type embossing in one direction is used for the exterior body in this manner, the battery can be easily bent in one direction.

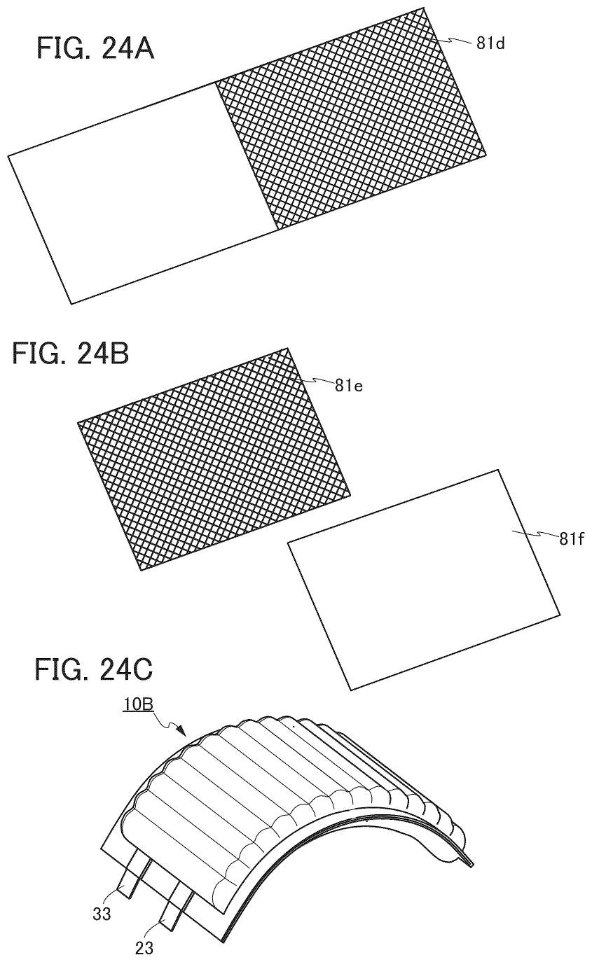

In the above-described structure example of the secondary battery, the example is described in which the exterior body on one surface of the secondary battery and the exterior body on the other surface thereof have the same embossed shape; however, the structure of the secondary battery of one embodiment of the present invention is not limited thereto. For example, a secondary battery one surface of which is provided with an exterior body having an embossed shape and the other surface of which is provided with an exterior body not having an embossed shape can be used, as illustrated in FIGS. 24A to 24C. Alternatively, the exterior body on one surface of the secondary battery and the exterior body on the other surface thereof may have different embossed shapes. For example, like a film 81d in FIG. 24A, one film having a region with an embossed shape and a region with no embossed shape may be used as the exterior body of the secondary battery. Alternatively, as illustrated in FIG. 24B, a film 81e having an embossed shape and a film 81f having no embossed shape may be used as the exterior body. FIG. 24C illustrates a structure example of a battery 10B, which is different from the battery illustrated in FIG. 23C in that the exterior body has an embossed shape on one surface of the battery and does not have an embossed shape on the other surface of the battery.

The contents in this embodiment can be freely combined with the contents in any of the other embodiments.

### Embodiment 3

In this embodiment, examples of a shape of a secondary battery capable of including the above-described positive electrode active material of one embodiment of the present invention, which are different from the above-described shape of the secondary battery, will be described.

### [Coin-Type Secondary Battery]

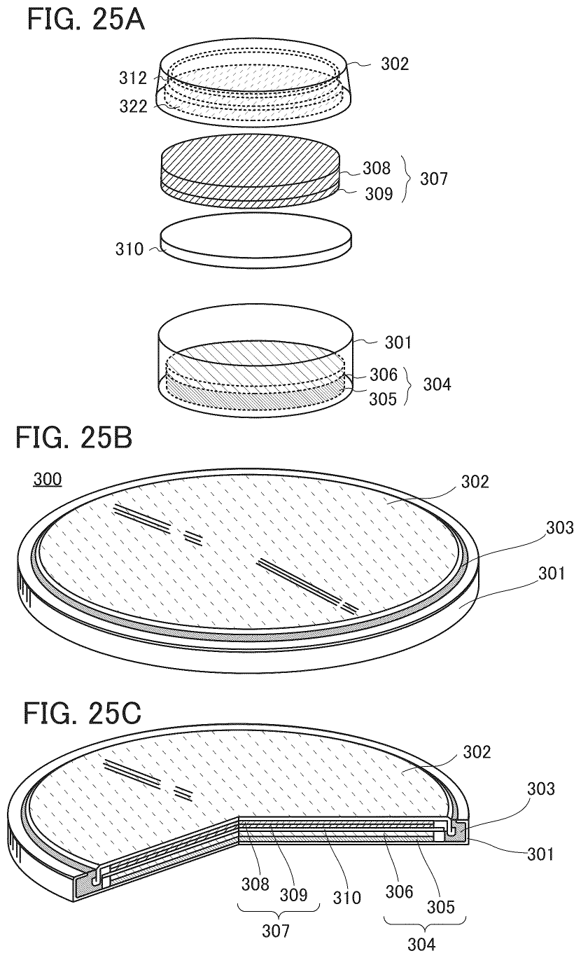

An example of a coin-type secondary battery is described. FIG. 25A, FIG. 25B, and FIG. 25C are an exploded perspective view, an external view, and a cross-sectional view of a coin-type (single-layer flat) secondary battery. Coin-type secondary batteries are mainly used in small electronic devices.

For easy understanding, FIG. 25A is a schematic view illustrating overlap (a vertical relation and a positional relation) between components. Thus, FIG. 25A and FIG. 25B do not completely correspond with each other.

In FIG. 25A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 25A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 is a stack in which a positive electrode active material layer 306 is formed over a positive electrode current collector 305.

FIG. 25B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and a lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 25C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

When the above-described negative electrode, positive electrode, electrolyte solution, and the like employ the structures described in the above embodiments, a coin-type secondary battery with excellent discharge capacity even in a low-temperature environment can be obtained.

### [Cylindrical Secondary Battery]

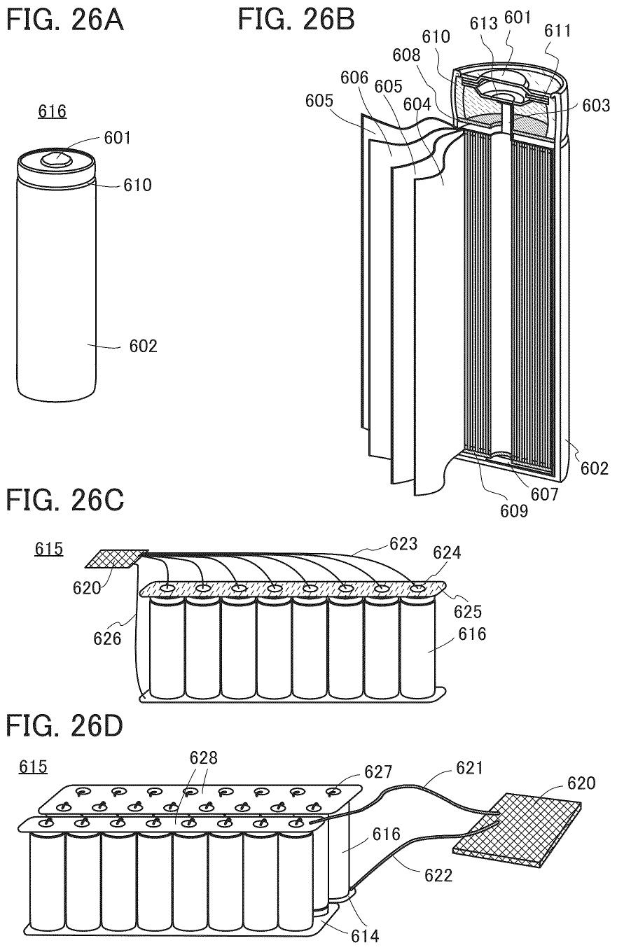

An example of a cylindrical secondary battery is described with reference to FIG. 26A. As illustrated in FIG. 26A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 26B schematically illustrates a cross section of a cylindrical secondary battery. The cylindrical secondary battery illustrated in FIG. 26B includes the positive electrode cap (battery cap) 601 on the top surface and the battery can (outer can) 602 on the side and bottom surfaces. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is closed and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. The inside of the battery can 602 provided with the battery element is filled with a electrolyte solution (not illustrated). As the electrolyte solution, an electrolyte solution similar to that for the coin-type secondary battery can be used.

Since the positive electrode and the negative electrode of the cylindrical storage battery are wound, active materials are preferably formed on both sides of the current collectors.

When the above-described negative electrode, positive electrode, electrolyte solution, and the like employ the structures described in the above embodiments, a cylindrical secondary battery with excellent discharge capacity even in a low-temperature environment can be obtained.

A positive electrode terminal (positive electrode current collecting lead) 603 is connected to the positive electrode 604, and a negative electrode terminal (negative electrode current collecting lead) 607 is connected to the negative electrode 606. The positive electrode terminal 603 can be formed using a metal material such as aluminum. The negative electrode terminal 607 can be formed using a metal material such as copper. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 26C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charge and discharge control circuit for performing charging, discharging, and the like or a protection circuit for preventing overcharge and/or overdischarge can be used.

FIG. 26D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 26D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

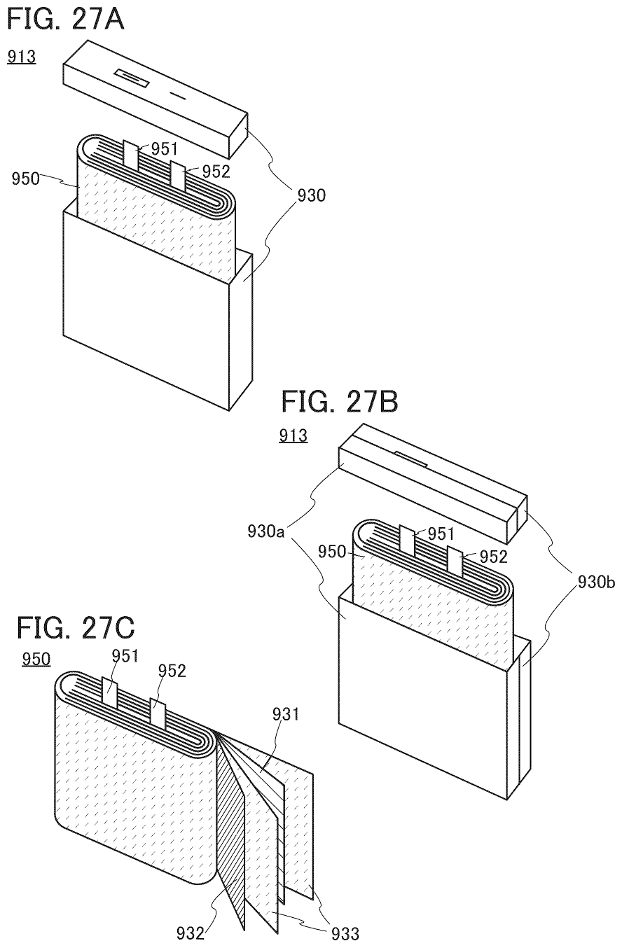

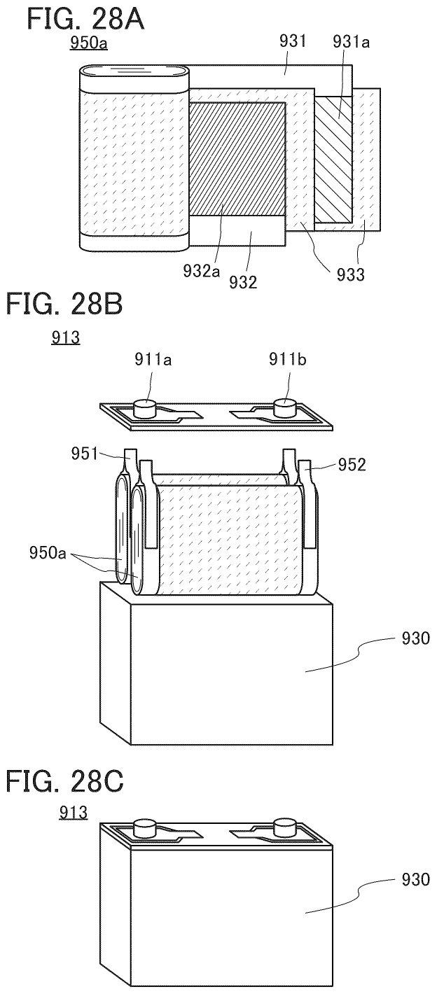

Structure examples of secondary batteries are described with reference to FIGS. 27A to 27C and FIGS. 28A to 28C.

A secondary battery 913 illustrated in FIG. 27A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 27A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 27B, the housing 930 in FIG. 27A may be formed using a plurality of materials. For example, in the secondary battery 913 in FIG. 27B, a housing 930a and a housing 930b are attached to each other, and the wound body 950 is provided in a region surrounded by the housing 930a and the housing 930b.

For each of the housing 930a and the housing 930b, a metal material (e.g., aluminum) can be used or an organic resin can be used in addition to the metal material, in consideration of the gas permeability.

FIG. 27C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Note that a plurality of stacks each including the negative electrode 931, the positive electrode 932, and the separators 933 may be overlaid.

As illustrated in FIGS. 28A to 28C, the secondary battery 913 may include a wound body 950a. The wound body 950a illustrated in FIG. 28A includes the negative electrode 931, the positive electrode 932, and the separators 933. The negative electrode 931 includes a negative electrode active material layer 931a. The positive electrode 932 includes a positive electrode active material layer 932a.

When the above-described negative electrode, positive electrode, electrolyte solution, and the like employ the structures described in the above embodiments, a secondary battery with excellent discharge capacity even in a low-temperature environment can be obtained.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 28B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 28C, the wound body 950a and an electrolyte solution are covered with the housing 930, whereby the secondary battery 913 is completed. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 28B, the secondary battery 913 may include a plurality of wound bodies 950a. The use of the plurality of wound bodies 950a enables the secondary battery 913 to have higher discharge capacity. The description of the secondary battery 913 in FIGS. 27A to 27C can be referred to for the other components of the secondary battery 913 in FIGS. 28A and 28B.

### <Laminated Secondary Battery>

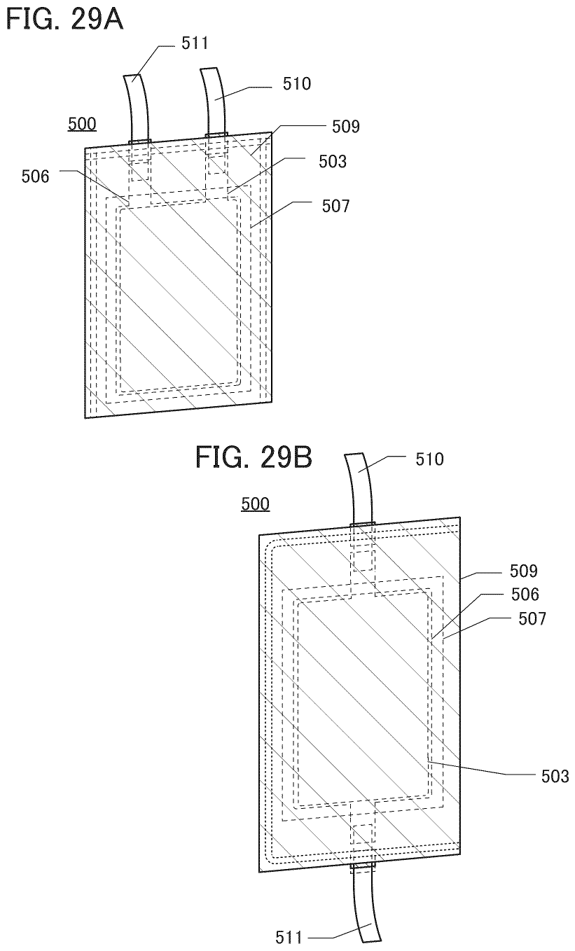

Next, examples of the appearance of a laminated secondary battery are illustrated in FIGS. 29A and 29B. FIGS. 29A and 29B each illustrate a positive electrode 503, a negative electrode 506, a separator 507, an exterior body 509, a positive electrode lead electrode 510, and a negative electrode lead electrode 511.

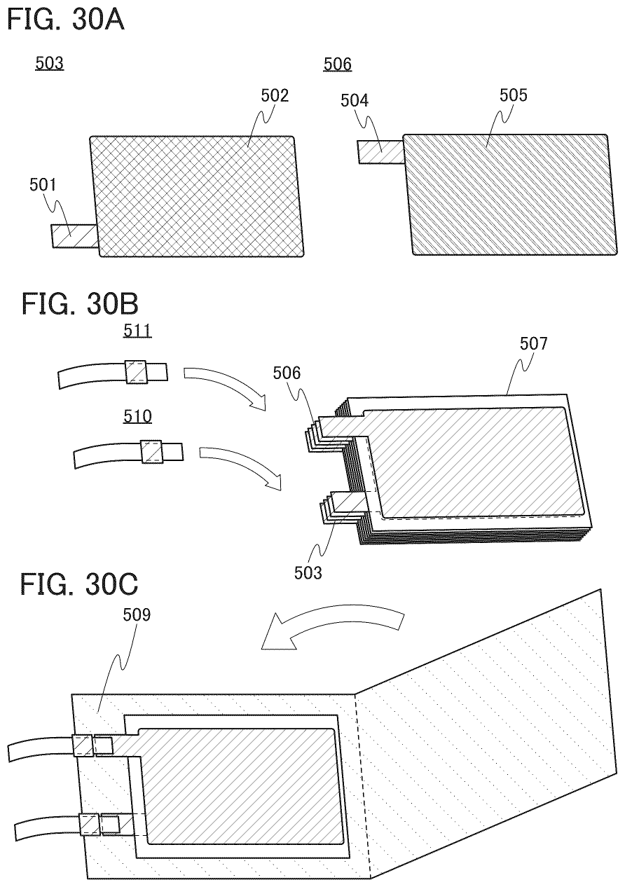

FIG. 30A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to those illustrated in FIG. 30A.

When the above-described negative electrode, positive electrode, electrolyte solution, and the like employ the structures described in the above embodiments, a laminated secondary battery with excellent discharge capacity even in a low-temperature environment can be obtained.

### <Method for Fabricating Laminated Secondary Battery>

An example of a method for fabricating the laminated secondary battery having the appearance illustrated in FIG. 29A will be described with reference to FIGS. 30B and 30C.

First, the negative electrode 506, the separator 507, and the positive electrode 503 are stacked. FIG. 30B illustrates the negative electrodes 506, the separators 507, and the positive electrodes 503 that are stacked. The secondary battery described here as an example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 30C. Then, the outer edges of the exterior body 509 are bonded to each other. The bonding can be performed by thermocompression, for example. At this time, a part (or one side) of the exterior body 509 is left unbonded (to provide an inlet) so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The contents in this embodiment can be freely combined with the contents in any of the other embodiments.

### Embodiment 4

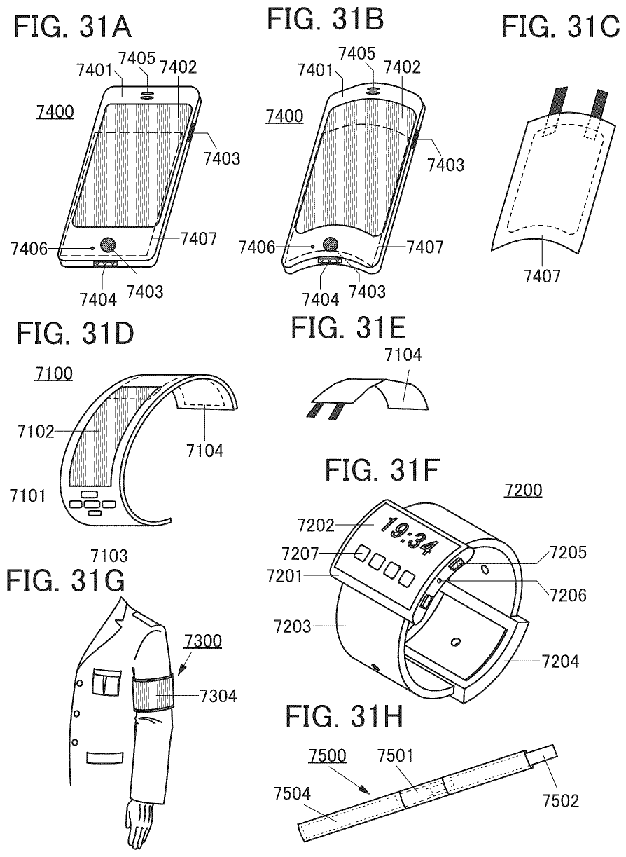

In this embodiment, examples of electronic devices each including the secondary battery of one embodiment of the present invention are described with reference to FIGS. 31A to 31H, FIGS. 32A to 32D, and FIGS. 33A to 33C.

FIGS. 31A to 31G show examples of electronic devices each including the secondary battery containing a positive electrode active material described in the above embodiment. Examples of electronic devices each including a secondary battery include television devices (also referred to as televisions or television receivers), monitors of computers or the like, digital cameras, digital video cameras, digital photo frames, cellular phones (also referred to as mobile phones or mobile phone devices), portable game machines, portable information terminals, audio reproducing devices, and large game machines such as pachinko machines.

A flexible secondary battery can also be incorporated along a curved inside/outside wall surface of a house, a building, or the like or a curved interior/exterior surface of an automobile.

FIG. 31A illustrates an example of a mobile phone. A mobile phone 7400 is provided with a display portion 7402 incorporated in a housing 7401, operation buttons 7403, an external connection port 7404, a speaker 7405, a microphone 7406, and the like. The mobile phone 7400 includes a secondary battery 7407. By using the secondary battery of one embodiment of the present invention as the secondary battery 7407, a lightweight long-life mobile phone can be provided.

FIG. 31B illustrates the mobile phone 7400 in a state of being bent. When the whole mobile phone 7400 is bent by the external force, the secondary battery 7407 included in the mobile phone 7400 is also bent. FIG. 31C illustrates the secondary battery 7407 that is being bent in that state. The secondary battery 7407 is a thin storage battery. The secondary battery 7407 is fixed in a state of being bent. The secondary battery 7407 includes a lead electrode electrically connected to a current collector.

FIG. 31D illustrates an example of a bangle-type display device. A portable display device 7100 includes a housing 7101, a display portion 7102, operation buttons 7103, and a secondary battery 7104. FIG. 31E illustrates the secondary battery 7104 that is being bent. When the display device is worn on a user's arm while the secondary battery 7104 is bent, the housing changes its shape and the curvature of part or the whole of the secondary battery 7104 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is changed with a radius of curvature in the range of 40 mm to 150 mm, both inclusive. When the radius of curvature of the main surface of the secondary battery 7104 ranges from 40 mm to 150 mm, both inclusive, the reliability can be kept high. By using the secondary battery of one embodiment of the present invention as the secondary battery 7104, a lightweight long-life portable display device can be provided.

FIG. 31F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication. For example, hands-free calling is possible with mutual communication between the portable information terminal 7200 and a headset capable of wireless communication.

Moreover, the portable information terminal 7200 includes the input/output terminal 7206, and data can be directly transmitted to and received from another information terminal via a connector. In addition, charge via the input/output terminal 7206 is possible. Note that the charge operation may be performed by wireless charge without using the input/output terminal 7206.

The display portion 7202 of the portable information terminal 7200 includes the secondary battery of one embodiment of the present invention. With the use of the secondary battery of one embodiment of the present invention, a lightweight long-life portable information terminal can be provided. For example, the secondary battery 7104 in FIG. 31E that is in the state of being curved can be provided in the housing 7201. Alternatively, the secondary battery 7104 in FIG. 31E can be provided in the band 7203 such that it can be curved.

The portable information terminal 7200 preferably includes a sensor. As the sensor, a human body sensor such as a fingerprint sensor, a pulse sensor, or a temperature sensor; a touch sensor; a pressure sensitive sensor; or an acceleration sensor is preferably mounted, for example.

FIG. 31G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication.

The display device 7300 includes an input/output terminal, and data can be directly transmitted to and received from another information terminal via a connector. In addition, charge via the input/output terminal is possible. Note that the charge operation may be performed by wireless charge without using the input/output terminal.

By using the secondary battery of one embodiment of the present invention as the secondary battery included in the display device 7300, a lightweight long-life display device can be provided.

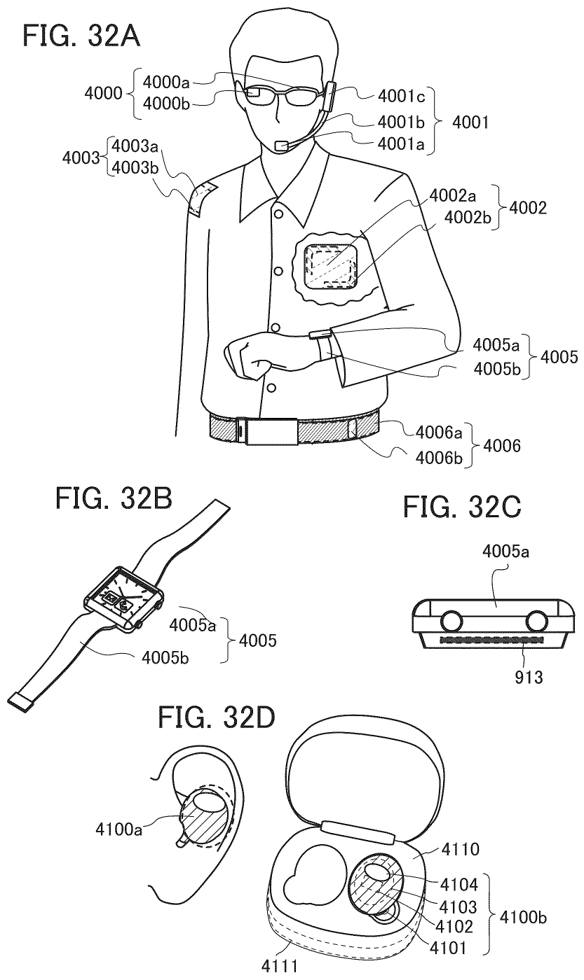

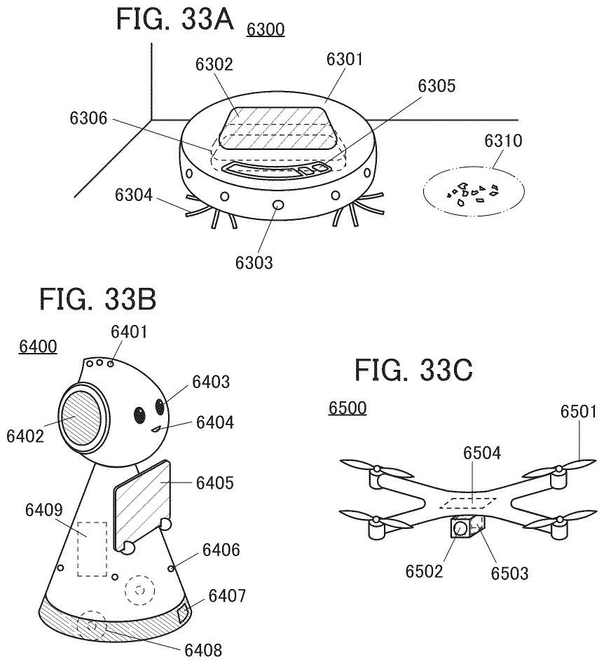

An example of an electronic device including the secondary battery with excellent cycle performance described in the above embodiment is described with reference to FIG. 31H, FIGS. 32A to 32D, and FIGS. 33A to 33C.

By using the secondary battery of one embodiment of the present invention as a secondary battery of a daily electronic device, a lightweight long-life product can be provided. Examples of daily electronic devices include an electric toothbrush, an electric shaver, and electric beauty equipment. As secondary batteries for these products, small and lightweight stick-type secondary batteries with high discharge capacity are desired in consideration of handling ease for users.

FIG. 31H is a perspective view of a device called a vaporizer (electronic cigarette). In FIG. 31H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and/or overdischarge of the secondary battery 7504 may be electrically connected to the secondary battery 7504. The secondary battery 7504 in FIG. 31H includes an external terminal for connection to a charger. When the electronic cigarette 7500 is held by a user, the secondary battery 7504 is at the tip of the device; thus, it is preferable that the secondary battery 7504 have a short total length and be lightweight. With the secondary battery of one embodiment of the present invention, which has high discharge capacity and excellent cycle performance, the small, lightweight, and long-term usable electronic cigarette 7500 that can be used for long hours can be provided.

FIG. 32A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 32A. The glasses-type device 4000 includes a frame 4000a and a display part 4000b. The secondary battery is provided in a temple of the frame 4000a having a curved shape, whereby the glasses-type device 4000 can be lightweight and can have a well-balanced weight and a long continuous use time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone unit 4001a, a flexible pipe 4001b, and an earphone unit 4001c. The secondary battery can be provided in the flexible pipe 4001b and/or the earphone unit 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 32B is a perspective view of the watch-type device 4005 that is detached from an arm.

FIG. 32C is a side view illustrating a state where the secondary battery 913 is incorporated in the watch-type device 4005. The secondary battery 913 is the secondary battery described in the above embodiment. The secondary battery 913, which is small and lightweight, is provided at a position overlapping with the display portion 4005a.

FIG. 32D illustrates an example of wireless earphones. The wireless earphones shown as an example consist of, but not limited to, a pair of earphone bodies 4100a and 4100b.

The earphone bodies 4100a and 4100b include a driver unit 4101, an antenna 4102, and a secondary battery 4103. The earphone bodies 4100a and 4100b may also include a display portion 4104. Moreover, the earphone bodies 4100a and 4100b preferably include a substrate where a circuit such as a wireless IC is provided, a terminal for charge, and the like. The earphone bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, the coin-type secondary battery or the cylindrical secondary battery described in the above embodiment can be used, for example. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 33A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes the secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 33B illustrates an example of a robot. A robot 6400 illustrated in FIG. 33B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 33C illustrates an example of a flying object. A flying object 6500 illustrated in FIG. 33C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### Embodiment 5

In this embodiment, examples of vehicles each including the secondary battery containing a positive electrode active material of one embodiment of the present invention are described.

The use of secondary batteries in vehicles enables production of next-generation clean energy vehicles such as hybrid vehicles (HV), electric vehicles (EV), and plug-in hybrid vehicles (PHV).

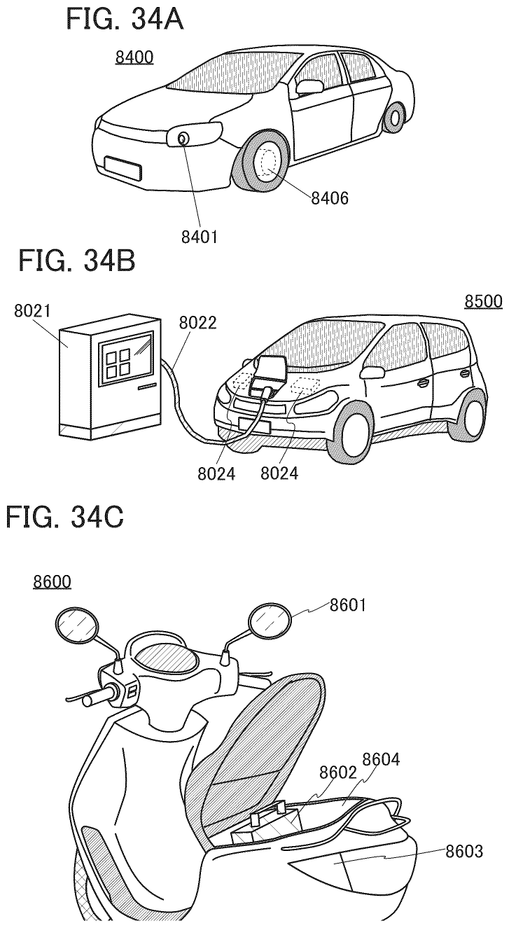

FIGS. 34A to 34C illustrate examples of vehicles each including the secondary battery of one embodiment of the present invention. An automobile 8400 illustrated in FIG. 34A is an electric vehicle that runs on the power of an electric motor. Alternatively, the automobile 8400 is a hybrid vehicle capable of driving using an electric motor or an engine as appropriate. The use of one embodiment of the present invention allows fabrication of a high-mileage vehicle. The automobile 8400 includes the secondary battery. For example, the modules of the secondary battery can be arranged in a floor portion in the automobile to be used. The secondary battery is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 34B illustrates an automobile 8500 including the secondary battery. The automobile 8500 can be charged when the secondary battery is supplied with electric power from external charging equipment by a plug-in system and/or a contactless power feeding system, for example. In FIG. 34B, a secondary battery 8024 included in the automobile 8500 is charged with the use of a ground-based charging apparatus 8021 through a cable 8022. In charging, a given method such as CHAdeMO (registered trademark) or Combined Charging System can be employed as a charge method, the standard of a connector, or the like as appropriate. The charging apparatus 8021 may be a charging station provided in a commerce facility or a power source in a house. For example, with the use of a plug-in technique, the secondary battery 8024 included in the automobile 8500 can be charged by being supplied with electric power from the outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charge can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 34C illustrates an example of a motorcycle including the secondary battery of one embodiment of the present invention. A motor scooter 8600 illustrated in FIG. 34C includes a secondary battery 8602, side mirrors 8601, and indicators 8603. The secondary battery 8602 can supply electric power to the indicators 8603.

In the motor scooter 8600 illustrated in FIG. 34C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors and charged, and is stored before the motor scooter is driven.

According to one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle and thereby increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Embodiment 6

In this embodiment, examples of space equipment including the secondary battery of one embodiment of the present invention are described.

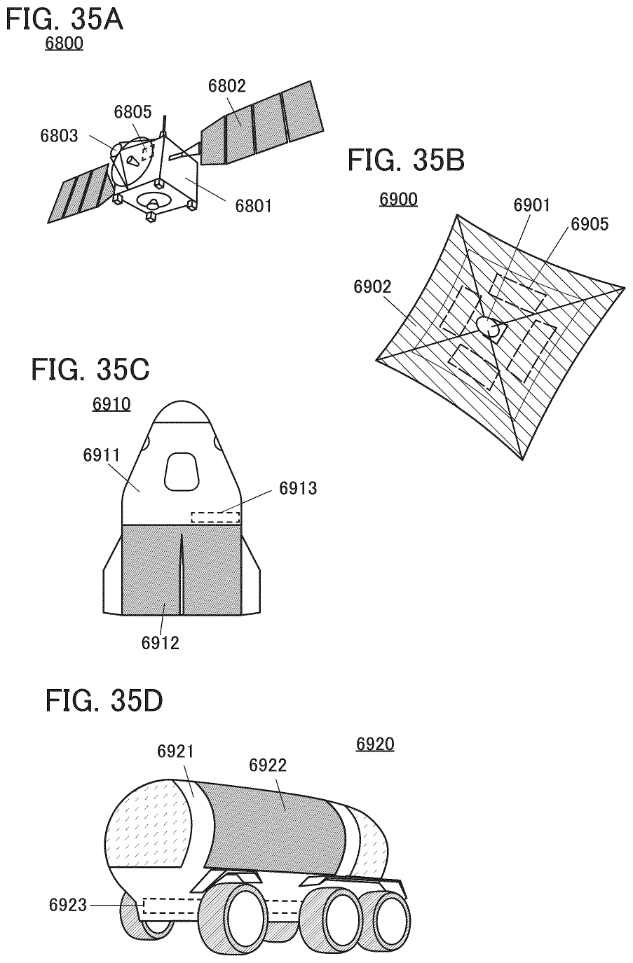

FIG. 35A illustrates an artificial satellite 6800 as an example of space equipment. The artificial satellite 6800 includes an artificial satellite body 6801, a solar panel 6802, an antenna 6803, and a secondary battery 6805. Such a solar panel is referred to as a solar cell module in some cases.

When the solar panel 6802 is illuminated by sunlight, electric power required for operation of the artificial satellite 6800 is generated. However, for example, in the situation where the solar panel is not illuminated by sunlight or the situation where the solar panel is illuminated with a slight amount of sunlight, the amount of generated electric power is small. Accordingly, a sufficient amount of electric power required for operation of the artificial satellite 6800 may be difficult to generate. In order to operate the artificial satellite 6800 even with a small amount of generated electric power, the artificial satellite 6800 is preferably provided with the secondary battery 6805. The positive electrode active material of the present invention is used in the secondary battery, whereby the secondary battery can have high discharge capacity and excellent cycle performance.

The artificial satellite 6800 can generate a signal. The signal is transmitted through the antenna 6803, and can be received by a ground-based receiver or another artificial satellite, for example. When the signal transmitted by the artificial satellite 6800 is received, the position of a receiver that receives the signal can be measured. Thus, the artificial satellite 6800 can make up part of a satellite positioning system.

The artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can function as an earth observing satellite, for example.

FIG. 35B illustrates a probe 6900 including a solar sail as an example of space equipment. The probe 6900 includes a probe body 6901, a solar sail 6902, and a secondary battery 6905. The positive electrode active material of the present invention is used in the secondary battery, whereby the secondary battery can have high discharge capacity and excellent cycle performance. When photons from the sun are incident on the surface of the solar sail 6902, the momentum is transmitted to the solar sail 6902. Hence, the surface of the solar sail 6902 preferably has a thin film with high reflectance and further preferably faces in the direction of the sun.

The solar sail 6902 may be designed such that the solar sail 6902 is furled in a small size until it goes beyond the earth's atmosphere, and is unfurled to have a large sheet-like shape as illustrated in FIG. 35B in the space beyond the earth's atmosphere (outer space).

FIG. 35C illustrates a spacecraft 6910 as an example of space equipment. The spacecraft 6910 includes a spacecraft body 6911, a solar panel 6912, and a secondary battery 6913. The positive electrode active material of the present invention is used in the secondary battery, whereby the secondary battery can have high discharge capacity and excellent cycle performance. The spacecraft body 6911 can include a pressurized cabin and an unpressurized cabin, for example. The pressurized cabin may be designed so that the crew can get into the cabin. Electric power that is generated by illumination of sunlight on the solar panel 6912 can be stored in the secondary battery 6913.

FIG. 35D illustrates a rover 6920 as an example of space equipment. The rover 6920 includes a rover body 6921 and a secondary battery 6923. The positive electrode active material of the present invention is used in the secondary battery, whereby the secondary battery can have high discharge capacity and excellent cycle performance. The rover 6920 may include a solar panel 6922.

The rover 6920 may be designed so that the crew can get into the rover. Electric power that is generated by illumination of sunlight on the solar panel 6912 may be stored in the secondary battery 6923, or electric power generated by another power source such as a fuel cell or a radioisotope thermoelectric generator, for example, may be stored in the secondary battery 6923.

This embodiment can be combined with any of the contents in the other embodiments as appropriate.

### Example 1

In this example, a test battery (half cell) including a positive electrode active material of one embodiment of the present invention was fabricated and subjected to charge and discharge cycle tests. Steps for fabricating samples are described and the cycle performance results are shown.

### <Formation of Positive Electrode Active Material>

The positive electrode active materials used in this example are described with reference to the formation methods in FIG. 5 and FIGS. 6A to 6C.

As lithium cobalt oxide (LiCoO₂) in Step S10 in FIG. 5, commercially available lithium cobalt oxide (Cellseed C-5H produced by NIPPON CHEMICAL INDUSTRIAL CO., LTD.) containing cobalt as the transition metal M and no additive element was prepared and sieved with an automatic sieving machine. Processing with an automatic sieve machine can be performed with, for example, an electromagnetic vibrating sieve MS-200 produced by Ito Seisakusho Co., Ltd. with a size of a sieve opening of 53 μm, under a condition of using a tapping ball. As the initial heating in Step S15, the lithium cobalt oxide was put in a setter and the setter was covered with a lid, heating was performed at 850° C. for two hours with use of a roller hearth kiln simulator furnace (produced by NORITAKE CO., LIMITED) as a baking furnace. Air (compressed air which was sufficiently dried) was made to flow at 10 L/min in the furnace. The flow rate, specifically, the width of an opening of an outlet, was adjusted such that a differential pressure gauge read 5 Pa, whereby the inside of the furnace was under positive pressure. After the initial heating, cooling in the furnace was performed at a rate of 200° C./h, with the air keeping on flowing until the temperature reached 200° C.

In this example, first, Mg and F were separately added as additive elements in accordance with Step S20a shown in FIG. 6A. LiF was prepared as the F source and MgF₂ was prepared as the Mg source in accordance with Step S21 shown in FIG. 6A. LiF and MgF₂ were weighed such that the molar ratio of LiF to MgF₂ was 1:3, and were mixed in dehydrated acetone at a rotation speed of 500 rpm for 20 hours. The mixture was made to pass through a sieve with an aperture size of 300 μm, whereby an additive element source (an A1 source) with a uniform particle diameter was formed.

Next, in Step S31 shown in FIG. 5, the A1 source and the lithium cobalt oxide were weighed such that magnesium of the A1 source was 1 mol % of cobalt of the lithium cobalt oxide, and the A1 source and the lithium cobalt oxide that had been subjected to the initial heating were stirred with picobond (produced by HOSOKAWA MICRON CORPORATION) at a rotation speed of 3000 rpm for 10 minutes, whereby the mixture 903 was obtained (Step S32). Nobilta was used as a rotor of the picobond. Before Step S33, the mixture 903 was sieved with an automatic sieving machine.

Subsequently, in Step S33, the mixture 903 was heated. The heating was performed at 850° C. for 10 hours. In the heating, the mixture 903 was put in a setter and the setter was covered with a lid. Here, the amount of the mixture 903 to be put into the setter was varied for five conditions. Specifically, setters containing 30 g, 60 g, 120 g, 180 g, and 240 g of the mixture 903 were put were prepared. A condition where 30 g of the mixture 903 was put is called Condition A, a condition where 60 g of the mixture 903 was put is called Condition B, a condition where 120 g of the mixture 903 was put is called Condition C, a condition where 180 g of the mixture 903 was put is called Condition D, and a condition where 240 g of the mixture 903 was put is called Condition E. The level H of the mixture 903 in the setter was greater than or equal to 0.5 mm and less than or equal to 1.0 mm under Condition A, greater than or equal to 1.5 mm and less than or equal to 2.0 mm under Condition B, greater than or equal to 3.5 mm and less than or equal to 4.0 mm under Condition C, greater than or equal to 5.5 mm and less than or equal to 6.0 mm under Condition D, and greater than or equal to 7.5 mm and less than or equal to 8.0 mm under Condition E. Table 2 shows these numerical values.

TABLE 2

| | Condition | Condition | Condition | Condition | Condition |
|---|---|---|---|---|---|
| | A | B | C | D | E |
| Weight | 30 g | 60 g | 120 g | 180 g | 240 g |
| Maximum | 1.0 mm | 2.0 mm | 4.0 mm | 6.0 mm | 8.0 mm |
| height | | | | | |
| Minimum | 0.5 mm | 1.5 mm | 3.5 mm | 5.5 mm | 7.5 mm |
| height | | | | | |
| (mm) | | | | | |

The setter was put in a roller hearth kiln simulator furnace (produced by NORITAKE CO., LIMITED) and heated at the above temperature. Oxygen was made to flow at 10 L/min in the furnace (O₂ flow). The flow rate, specifically, the width of an opening of an outlet, was adjusted such that a differential pressure gauge read 5 Pa, whereby the inside of the furnace was under positive pressure. After the initial heating, cooling in the furnace was performed at a rate of 200° C./h, with the oxygen keeping on flowing until the temperature reached 200° C. In this manner, a composite oxide containing Mg and F was obtained (Step S34a).

Then, in Step S40, the composite oxide and an additive element source (a A2 source) were prepared. First, nickel hydroxide on which a grinding step was performed was prepared as a nickel source and aluminum hydroxide on which a grinding step was performed was prepared as an aluminum source in accordance with Step S41 shown in FIG. 6C, and those were used as the additive element source (the A2 source). In each of the grinding steps, the nickel hydroxide or the aluminum hydroxide was stirred in dehydrated acetone at a rotation speed of 500 rpm for 20 hours. After that, the mixture was made to pass through a sieve with an aperture size of 300 μm.

The A2 source was weighed such that nickel of nickel hydroxide was 0.5 mol % of cobalt and aluminum of aluminum hydroxide was 0.5 mol % of cobalt, and the A2 source and the composite oxide containing Mg and F were stirred with picobond (produced by HOSOKAWA MICRON CORPORATION) at a rotation speed of 3000 rpm for 10 minutes, whereby a mixture 904 was obtained (Step S52). Nobilta was used as a rotor of the picobond. Before Step S53, the mixture 904 was sieved with an automatic sieving machine. Note that after the conditions were divided in Step S33, the materials processed under the different conditions were independently subjected to steps up to Step S52. The material processed in Condition A in Step S33 and then processed up to Step S52 is called a mixture 904A; similarly, the material processed in Condition B in Step S33 and then processed up to Step S52 is called a mixture 904B; the material processed in Condition C in Step S33 and then processed up to Step S52 is called a mixture 904C; the material processed in Condition D in Step S33 and then processed up to Step S52 is called a mixture 904D; and the material processed in Condition E in Step S33 and then processed up to Step S52 is called a mixture 904E.

Subsequently, in Step S53, the mixture 904 was heated. The heating was performed at 850° C. for 2 hours. In the heating, the mixture 904 was put in a setter and the setter was covered with a lid. As in the case where the conditions were divided in Step S33 described above, 30 g of the mixture 904A was put in a setter, 60 g of the mixture 904B was put in another setter, 120 g of the mixture 904C was put in another setter, 120 g of the mixture 904D was put in another setter, and 240 g of the mixture 904E was put in another setter. A condition where 30 g of the mixture 904A was put is called Condition AA, a condition where 60 g of the mixture 904B was put is called Condition BB, a condition where 120 g of the mixture 904C was put is called Condition CC, a condition where 180 g of the mixture 904D was put is called Condition DD, and a condition where 240 g of the mixture 904E was put is called Condition EE. The level H of the mixture 904 in the setter was greater than or equal to 0.5 mm and less than or equal to 1.0 mm under Condition AA, greater than or equal to 1.5 mm and less than or equal to 2.0 mm under Condition BB, greater than or equal to 3.5 mm and less than or equal to 4.0 mm under Condition CC, greater than or equal to 5.5 mm and less than or equal to 6.0 mm under Condition DD, and greater than or equal to 7.5 mm and less than or equal to 8.0 mm under Condition EE. Table 3 shows these numerical values.

TABLE 3

| | Condition | Condition | Condition | Condition | Condition |
|---|---|---|---|---|---|
| | AA | BB | CC | DD | EE |
| Weight | 30 g | 60 g | 120 g | 180 g | 240 g |
| Maximum | 1.0 mm | 2.0 mm | 4.0 mm | 6.0 mm | 8.0 mm |
| height | | | | | |
| Minimum | 0.5 mm | 1.5 mm | 3.5 mm | 5.5 mm | 7.5 mm |
| height | | | | | |
| (mm) | | | | | |

The setter was put in a roller hearth kiln simulator furnace (produced by NORITAKE CO., LIMITED) and heated at the above temperature. Oxygen was made to flow at 10 L/min in the furnace (O₂ flow). The flow rate, specifically, the width of an opening of an outlet, was adjusted such that a differential pressure gauge read 5 Pa, whereby the inside of the furnace was under positive pressure. After the heating, cooling in the furnace was performed at a rate of 200° C./h, with the oxygen keeping on flowing until the temperature reached 200° C.

Thus, lithium cobalt oxide containing Mg, F, Ni, and Al was obtained (Step S54). Note that after the conditions were divided in Step S53, the materials processed under the different conditions were independently subjected to steps up to Step S54. The material processed under Condition AA in Step S53 and then processed up to Step S54 is called a positive electrode active material A; the material processed under Condition BB in Step S53 and then processed up to Step S54 is called a positive electrode active material B; the material processed under Condition CC in Step S53 and then processed up to Step S54 is called a positive electrode active material C; the material processed under Condition DD in Step S53 and then processed up to Step S54 is called a positive electrode active material D; and the material processed under Condition EE in Step S53 and then processed up to Step S54 is called a positive electrode active material E.

### <Formation of Positive Electrode>

The above positive electrode active materials A to E were prepared as a positive electrode active material, acetylene black (AB) was prepared as a conductive material, and poly(vinylidene fluoride) (PVDF) was prepared as a binding agent. The PVDF prepared was one dissolved in N-methyl-2-pyrrolidone (NMP) with the weight ratio of 5%. Then, the positive electrode active material, AB, and PVDF were mixed at a weight ratio of 95:3:2 to form a slurry, and the slurry was applied on an aluminum positive electrode current collector. As a solvent of the slurry, NMP was used. After the application of the slurry on the positive electrode current collector, the solvent was volatilized.

After that, pressing was performed with a roller press machine to increase the density of the positive electrode active material layer over the positive electrode current collector. The pressing was performed with a linear pressure of 210 kN/m. Note that the temperature of each of an upper roll and a lower roll of the roller press machine was 120° C.

Through the above steps, positive electrodes containing the positive electrode active materials were obtained. The carried amount of the positive electrode active material was adjusted to be greater than or equal to 10 mg/cm² and less than or equal to 11 mg/cm². Note that a positive electrode formed with the positive electrode active material A is called a positive electrode A, a positive electrode formed with the positive electrode active material B is called a positive electrode B, a positive electrode formed with the positive electrode active material C is called a positive electrode C, a positive electrode formed with the positive electrode active material D is called a positive electrode D, and a positive electrode formed with the positive electrode active material E is called a positive electrode E.

### <Fabrication of Half Cell>

A half cell was fabricated with the above-described positive electrodes A, B, C, D, and E, a lithium metal foil, a separator, an electrolyte, a coin cell positive electrode can, and a coin cell negative electrode can. The size of the half cell was 2032 (a diameter of 20 mm and a thickness of 3.2 mm). Note that each of the positive electrodes had a circular shape with a diameter of 12 mm.

As the electrolyte solution, a solution obtained in the following manner was used: ethylene carbonate (EC) and diethyl carbonate (DEC) were mixed at a volume ratio of EC:DEC=3:7; 1 mol/L lithium hexafluorophosphate (LiPF₆) was dissolved in the mixed solution; and 2 wt % of vinylene carbonate (VC) was added thereto as an additive.

As the separator, a 20-μm-thick porous polypropylene film was used.

A half cell fabricated with the positive electrode A is called a cell A, a half cell fabricated with the positive electrode B is called a cell B, a half cell fabricated with the positive electrode C is called a cell C, a half cell fabricated with the positive electrode D is called a cell D, and a half cell fabricated with the positive electrode E is called a cell E. Note that three cells were fabricated for each cell.

### <Charge and Discharge Cycle Test>

Charge and discharge cycle tests were performed on the cells A to E formed above. The following three conditions were employed for the charge and discharge cycle tests: the maximum voltage at the time of charge was 4.60 V (Condition 1), 4.65 V (Condition 2), and 4.70 V (Condition 3).

Under Condition 1, as charge, constant current charge was performed at a current of 0.5 C until the battery voltage reached 4.60 V, and then constant voltage charge was performed at 4.60 V until the current reached lower than 0.05 C (constant current-constant voltage charge). As discharge, discharge was performed at a constant current of 0.5 C until the battery voltage reached 2.50 V (constant current discharge). The above charge and discharge were repeated 50 times at an ambient temperature of 25° C. Condition 2 was the same as Condition 1 except that the voltage at the time of charge was changed to 4.65 V. Condition 3 was the same as Condition 1 except that the voltage at the time of charge was changed to 4.70 V. Note that 1 C was 200 mA/g per weight of the positive electrode active material in this example.

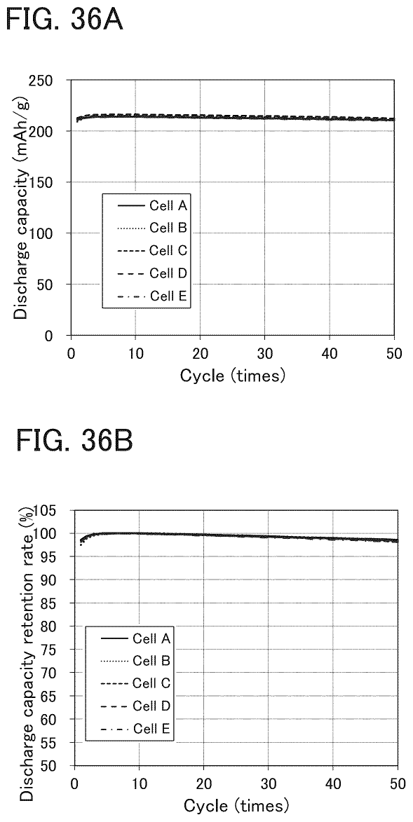

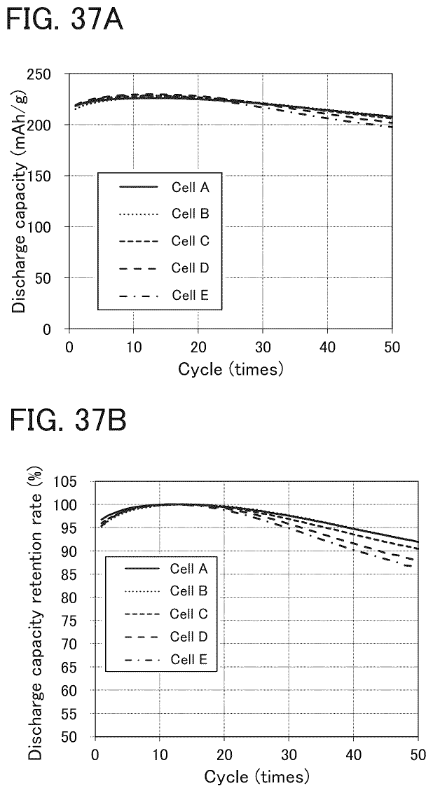

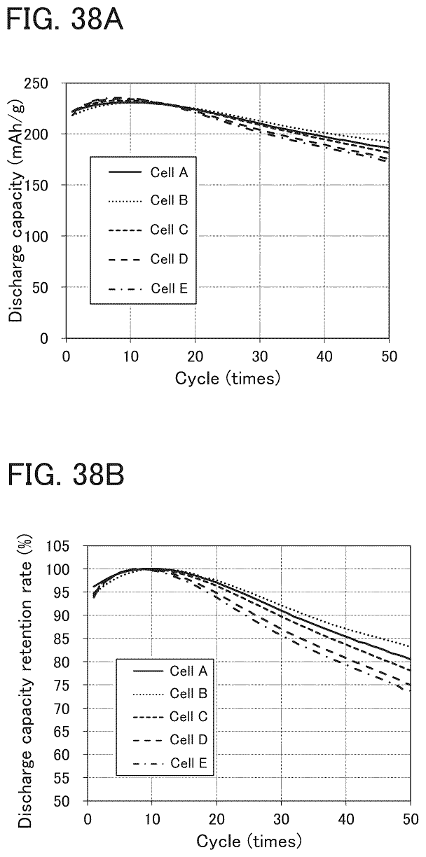

FIGS. 36A and 36B, FIGS. 37A and 37B, and FIGS. 38A and 38B show the results of the charge and discharge cycle tests. FIGS. 36A and 36B are graphs showing the results of the charge and discharge cycle tests under Condition 1. FIGS. 37A and 37B are graphs showing the results of the charge and discharge cycle tests under Condition 2. FIGS. 38A and 38B are graphs showing the results of the charge and discharge cycle tests under Condition 3. In FIG. 36A, FIG. 37A, and FIG. 38A, the horizontal axis represents the number of repetition times of charge and discharge (the number of cycles), and the vertical axis represents the discharge capacity obtained by dividing the discharge capacity of the cell by the weight of the positive electrode active material included in the positive electrode of the cell. In FIG. 36B, FIG. 37B, and FIG. 38B, the horizontal axis represents the number of repetition times of charge and discharge, and the vertical axis represents the percentage of the discharge capacity in each cycle with the maximum discharge capacity in the whole charge and discharge cycle test regarded as 100% (i.e., discharge capacity retention rate).

The results of the charge and discharge cycle tests under Condition 1 (4.60 V condition) shown in FIGS. 36A and 36B show overlaps of the results of the cells A to E, which means that there was almost no difference between the cells A to E. The discharge capacity retention rate of each of the cells A to E after 50 cycles exceeds 98%, which is excellent charge and discharge cycle performance.

The results of the charge and discharge cycle tests under Condition 2 (4.65 V condition) shown in FIGS. 37A and 37B show that the results of the cells A and B overlap with each other, and that after 50 cycles, the cells A and B have the highest discharge capacity retention rate, the cell C has the second highest discharge capacity retention rate, the cell D has the third highest discharge capacity retention rate, and the cell E has the lowest discharge capacity retention rate. Note that the discharge capacity retention rates of the cells A, B, and C after 50 cycles exceed 90%, which means that the cells A, B, and C have excellent charge and discharge cycle performance under the 4.65 V condition. That is, as for the formation of the positive electrode active materials, the positive electrode active materials A, B, and C, which were heated in the state where they each had a thickness greater than or equal to 3.5 mm and less than or equal to 4.0 mm in the setter, showed excellent charge and discharge cycle performance under the 4.65 V condition.

The results of the charge and discharge cycle tests under Condition 3 (4.70 V condition) shown in FIGS. 38A and 38B show that the cell B has the highest discharge capacity retention rate, the cell A has the second highest, the cell C has the third highest, the cell D has the fourth highest, and the cell E has the lowest discharge capacity retention rates after 50 cycles. Note that the discharge capacity retention rates of the cells A and B after 50 cycles exceed 80%, which means that the cells A and B have excellent charge and discharge cycle performance under the 4.70 V condition. That is, as for the formation of the positive electrode active materials, the positive electrode active materials A and B, which were heated in the state where they each had a thickness greater than or equal to 1.5 mm and less than or equal to 2.0 mm in the setter, showed excellent charge and discharge cycle performance under the 4.70 V condition.

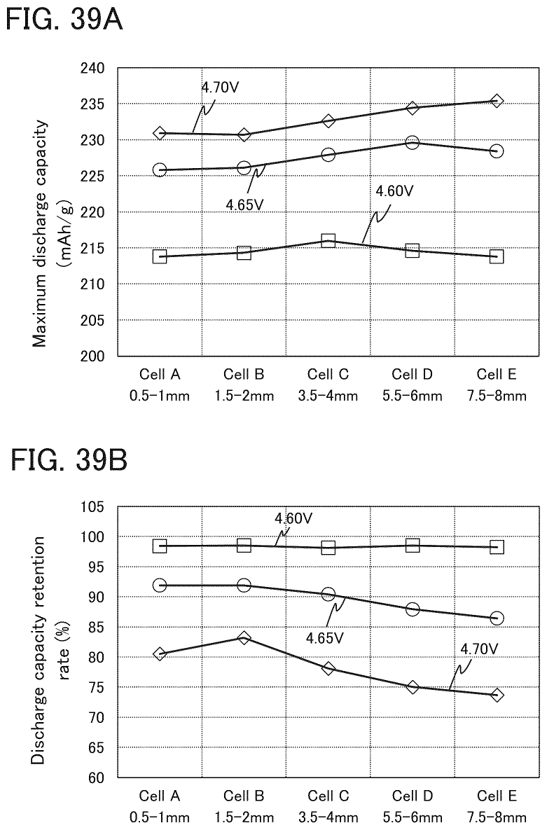

FIG. 39A is a graph comparing the maximum discharge capacities under the respective conditions among the results of the charge and discharge cycle tests shown in FIGS. 36A and 36B, FIGS. 37A and 37B, and FIGS. 38A and 38B, and FIG. 39B is a graph comparing the discharge capacity retention rates under the respective conditions. The values of the graphs in FIGS. 39A and 39B are shown in Table 4, Table 5, and Table 6. Note that the horizontal axes of the graphs in FIGS. 39A and 39B show information related to the positive electrode used in each cell (the thickness of the mixture (the mixture 903 or the mixture 904) in the setter at the time of forming the positive electrode active material).

TABLE 4

| Condition 1 | Cell A | Cell B | Cell C | Cell D | Cell E |
|---|---|---|---|---|---|
| Maximum discharge | 213.8 | 214.3 | 216.0 | 214.6 | 213.8 |
| capacity | mAh/g | mAh/g | mAh/g | mAh/g | mAh/g |
| Discharge capacity | 98.4% | 98.5% | 98.1% | 98.5% | 98.2% |
| retention rate | | | | | |
| after 50 cycles | | | | | |

TABLE 5

| Condition 2 | Cell A | Cell B | Cell C | Cell D | Cell E |
|---|---|---|---|---|---|
| Maximum | 225.8 | 226.1 | 227.9 | 229.6 | 228.4 |
| discharge capacity | mAh/g | mAh/g | mAh/g | mAh/g | mAh/g |
| Discharge capacity | 91.9% | 91.9% | 90.4% | 87.9% | 86.4% |
| retention rate | | | | | |
| after 50 cycles | | | | | |

TABLE 6

| Condition 3 | Cell A | Cell B | Cell C | Cell D | Cell E |
|---|---|---|---|---|---|
| Maximum | 230.9 | 230.7 | 232.6 | 234.4 | 235.4 |
| discharge capacity | mAh/g | mAh/g | mAh/g | mAh/g | mAh/g |
| Discharge capacity | 80.5% | 83.2% | 78.1% | 75% | 73.7% |
| retention rate | | | | | |
| after 50 cycles | | | | | |

As shown in FIGS. 39A and 39B and Table 4, as for the formation of the positive electrode active materials, the positive electrode active materials A, B, and C, which were heated in the state where the mixture (903 or 904) had a thickness greater than or equal to 3.5 mm and less than or equal to 4.0 mm in the setter, showed excellent charge and discharge cycle performance under the 4.65 V condition. As for the formation of the positive electrode active materials, the positive electrode active materials A and B, which were heated in the state where they each had a thickness less than or equal to 2.0 mm in the setter, showed excellent charge and discharge cycle performance under the 4.70 V condition.

### Example 2

In this example, a test battery (full cell) including a positive electrode active material, a negative electrode, and an electrolyte solution, which are embodiments of the present invention, was fabricated and subjected to low-temperature charge and discharge tests. Steps for fabricating samples are described and the test results are shown.

### <Formation of Negative Electrode>

The negative electrode A used in this example is described with reference to the formation method in FIG. 16.

In accordance with FIG. 16, as the graphite particle in this example, graphite (Formula BT 1520 produced by Superior Graphite Co.) having an average particle diameter of 20 μm was prepared.

In accordance with FIG. 16, as the silicon particle in this example, silicon particles (product number 633097 produced by Sigma-Aldrich Co. LLC) having a specific surface area of 12.7715 m²/g by a BET method and an average particle diameter of 100 nm were prepared. A 100-nm silicon particle is referred to as a nanosilicon particle.

In accordance with FIG. 16, poly(acrylic acid) (PPA) (10CL produced by FUJIFILM Waco Chemical Corporation) was used as the binder in this example.

In accordance with FIG. 16, acetylene black (AB) was prepared as the conductive material in this example.

In accordance with Step S60 in FIG. 16, the mixture 404 was formed by mixing the graphite particle, the silicon particle, AB, and PAA at a weight ratio of the graphite particle: the silicon particle:AB:PAA=72:8:6:14. The carried amount of the negative electrode active material was adjusted to be greater than or equal to 3.66 mg/cm² and less than or equal to 3.85 mg/cm².

In accordance with FIG. 16, deionized water was prepared as the solvent.

In accordance with Step S61 in FIG. 16, deionized water was added to the mixture 404 and mixed to give the slurry 406.

In accordance with FIG. 16, a copper foil was prepared as the negative electrode current collector, and the slurry was applied to the copper foil in accordance with Step S62.

The negative electrode 408 was obtained by drying the slurry in accordance with Step S63 in FIG. 16. As pre-drying, the copper foil to which the slurry was applied was fixed to a hot plate heated to 50° C. and kept for 30 minutes. After that, as main drying, the copper foil to which the slurry was applied was set in a circulation dryer at 80° C. and kept for 45 minutes.

### <Fabrication of Full Cell>

A laminated full cell (a cell BF1) was fabricated with use of the above-described negative electrode A and the positive electrode B in Example 1. The positive electrode B was a positive electrode one surface of which was coated, and the area of the positive electrode active material layer (coated portion) was approximately 21 cm². The negative electrode A was a negative electrode one surface of which was coated, and the area of the negative electrode active material layer (coated portion) was approximately 24 cm².

As the electrolyte solution, LiPF₆ was dissolved in a mixed solvent containing FEC and MTFP at a volume ratio of 20:80. Here, the amount of LiPF₆ was set to 1 mol/L with respect to the mixed solvent of FEC and MTFP. Note that no additive agent was used.

As the separator, a porous polyimide film was used. Three 23-μm-thick polyimide films were stacked and placed as separators between the positive electrode B and the negative electrode.

### [Initial Charge and Discharge]

The cell BF1 fabricated as described above was subjected to initial charge and discharge. Table 7 shows a method of the initial charge and discharge. In the initial charge and discharge in Table 7, Step A6 and Step A7 were repeated three times in total. Step A8 and Step A9 were repeated three times in total.

The initial charge and discharge are sometimes referred to as aging or conditioning. Note that 1 C was 200 mA/g per weight of the positive electrode active material in this example.

TABLE 7

| | Charge/discharge | Conditions |
|---|---|---|
| Step A1 | Constant | 0.01 C. Ambient temperature: 25° C. |
| | current | Charge is terminated when any of the following |
| | charge | conditions is satisfied: termination voltage of 4.5 |
| | | V, termination capacity of 15 mAh/g, and |
| | | termination time of 20 hours. |
| Step A2 | Constant | 0.1 C. Ambient temperature: 25° C. |
| | current | Charge is terminated when any of the following |
| | charge | conditions is satisfied: termination voltage of 4.5 |
| | | V, termination capacity of 105 mAh/g, and |
| | | termination time of 20 hours. |
| Step A3 | Heating and | Stationary at an ambient temperature of 60° C. for |
| | resealing | 24 hours. |
| | | Subsequently, the cell is opened in a glove box |
| | | containing Ar atmosphere at an ambient |
| | | temperature of 25° C., and sealing under reduced |
| | | pressure (resealing) is performed. |
| Step A4 | Constant | 0.1 C, 4.5 V. Ambient temperature: 25° C. |
| | current- | Charge is terminated when any of the following |
| | constant | conditions is satisfied: termination current of |
| | voltage charge | 0.01 C or lower and termination time of 10 hours. |
| Step A5 | Constant | 0.2 C. Ambient temperature: 25° C. |
| | current | Discharge is terminated when any of the following |
| | discharge | conditions is satisfied: termination voltage of 2.5 |
| | | V and termination time of 8 hours. |
| Step A6 | Constant | 0.2 C, 4.5 V. Ambient temperature: 25° C. |
| | current- | Charge is terminated when any of the following |
| | constant | conditions is satisfied: termination current of |
| | voltage charge | 0.02 C or lower and termination time of 8 hours. |
| Step A7 | Constant | 0.2 C. Ambient temperature: 25° C. |
| | current | Discharge is terminated when any of the following |
| | discharge | conditions is satisfied: termination voltage of 2.5 |
| | | V and termination time of 8 hours. |

※ Step A6 and Step A7 are repeated three times in total.

### <Low-Temperature Charge and Discharge Test>

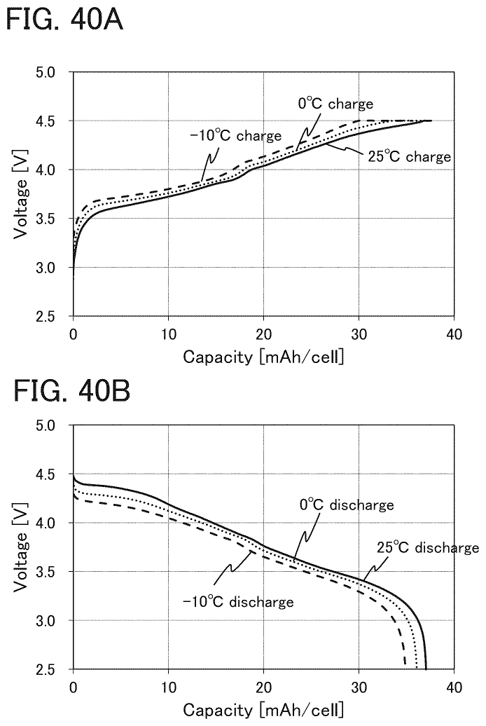

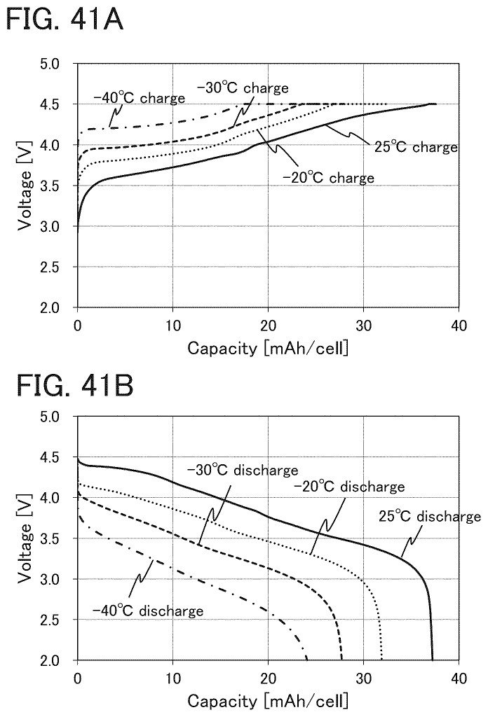

A low-temperature charge and discharge test was performed using the cell BF1 fabricated as described above. As the low-temperature charge and discharge test, charge capacity and discharge capacity were measured at each temperature in the following order: charge and discharge at 25° C.; charge and discharge at 0° C.; charge and discharge at −10° C.; charge and discharge at −20° C.; charge and discharge at −30° C.; and charge and discharge at −40° C. Measurement results are shown in FIGS. 40A and 40B, FIGS. 41A and 41B, and Table 8.

At each temperature, the charge was performed in the following manner: constant current charge was performed at charge current of 0.1 C until the voltage reached 4.50 V, and constant voltage charge was successively performed at 4.50 V until the charge current was lower than or equal to 0.01 C. In the discharge, constant current discharge was performed at a discharge rate of 0.1 C until the voltage reached 2.0 V (cutoff voltage). Note that the current of 0.1 C can be referred to as current of 20 mA/g per positive electrode active material weight, and the current of 0.01 C can be referred to as current of 2 mA/g per positive electrode active material weight.

FIG. 40A is a graph showing charge curves of charge at 25° C., charge at 0° C., and charge at −10° C. FIG. 40B is a graph showing discharge curves of discharge at 25° C., discharge at 0° C., and discharge at −10° C.

FIG. 41A is a graph showing charge curves of charge at 25° C., charge at −20° C., charge at −30° C., and charge at −40° C. FIG. 41B is a graph showing discharge curves of discharge at 25° C., discharge at −20° C., discharge at −30° C., and discharge at −40° C. Note that the charge curve and the discharge curve at 25° C. are the same as those shown in FIGS. 40A and 40B.

In Table 8, the first column represents temperature conditions, the second column represents charge capacity of the cell BF1, the third column represents discharge capacity of the cell BF1, the fourth column represents charge capacity in each temperature environment when the charge capacity at 25° C. is 100%, and the fifth column represents discharge capacity in each temperature environment with a discharge capacity of 100% at 25° C.

TABLE 8

| | | | Charge | Discharge |
|---|---|---|---|---|
| | Charge | Discharge | capacity | capacity |
| | capacity | capacity | at 25° C. | at 25° C. |
| 25° C. | 37.6 mAh | 37.2 mAh | 100.0% | 100.0% |
| 0° C. | 36.8 mAh | 36.2 mAh | 97.8% | 97.4% |
| −10° C. | 35.6 mAh | 35.1 mAh | 94.5% | 94.2% |
| −20° C. | 32.4 mAh | 31.9 mAh | 86.2% | 85.7% |
| −30° C. | 28.2 mAh | 27.7 mAh | 75.0% | 74.4% |
| −40° C. | 25.2 mAh | 24.1 mAh | 67.0% | 64.7% |

According to the measurement results of charge and discharge in a low-temperature environment, the following favorable results of the cell BF1 that is the secondary battery of one embodiment of the present invention were obtained when the discharge capacity value measured in charge and discharge at 25° C. was 100%. The discharge capacity value measured in charge and discharge at −40° C. was 64.7%, which was a favorable result of exceeding 60%. The discharge capacity value measured in charge and discharge at −30° C. was 74.4%, which was a favorable result of exceeding 70%. The discharge capacity value measured in charge and discharge at −20° C. was 85.7%, which was a favorable result of exceeding 85%. The discharge capacity value measured in charge and discharge at −10° C. was 94.2%, which was a favorable result of exceeding 90% The discharge capacity value measured in charge and discharge at 0° C. was 97.4%, which is a favorable result of exceeding 97%.

As described in the above example, it was found that extremely excellent charge operation and discharge operation are possible in the temperature range from −40° C. to 25° C. with use of the positive electrode active material obtained by the fabrication method described in Embodiment 1 and the negative electrode and the electrolyte solution described in Embodiment 2.

### Example 3

In this example, a battery including the positive electrode active material, a negative electrode, an electrolyte solution, and an exterior body, which are embodiments of the present invention, was fabricated and the impact resistance was examined.

### <Fabrication of Full Cell>

A laminated full cell (a cell BF2) was fabricated with use of the positive electrode B in Example 1 and the negative electrode in Example 2. The positive electrode B was a positive electrode one surface of which was coated, and the area of the positive electrode active material layer (coated portion) was approximately 21 cm². The negative electrode A was a negative electrode one surface of which was coated, and the area of the negative electrode active material layer (coated portion) was approximately 24 cm². The number of positive electrodes B and that of negative electrodes were each eight.

As the electrolyte solution, LiPF₆ was dissolved in a mixed solvent containing FEC and MTFP at a volume ratio of 20:80. Here, the amount of LiPF₆ was set to 1 mol/L with respect to the mixed solvent of FEC and MTFP. Note that no additive agent was used.

As the separator, a porous polypropylene film was used.

A stack was formed by stacking the positive electrode B, the negative electrode, and the separator, the stack was placed inside the exterior body, and the outer edge of the exterior body was sealed. The method of stacking the positive electrode B, the negative electrode, and the separator was performed in a manner similar to that described with reference to FIGS. 19A to 19C. As the exterior body, the aluminum laminated film having the alternating wave shape illustrated in FIG. 23A was used.

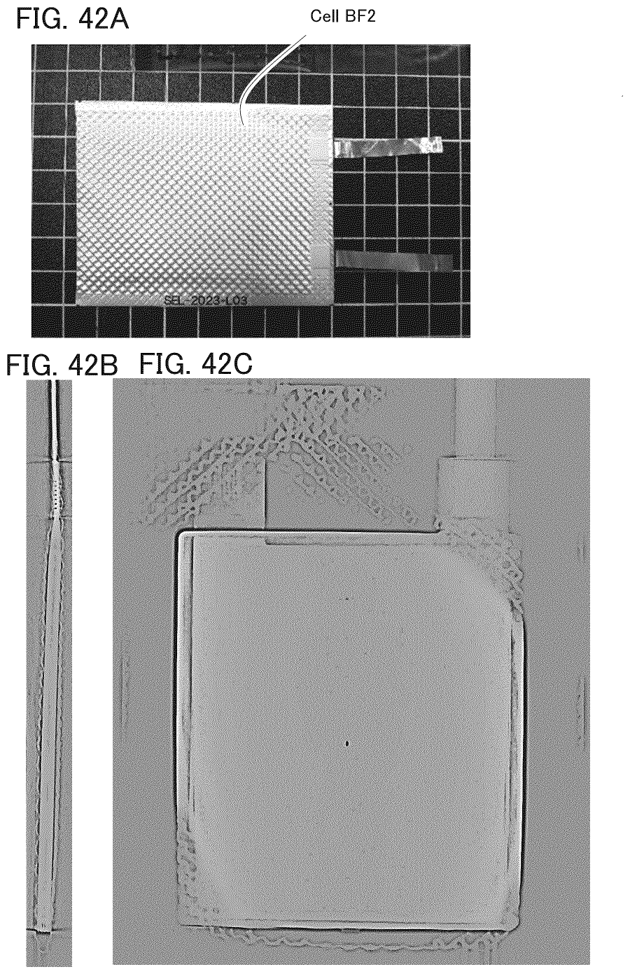

FIG. 42A is an external photograph of the battery (cell BF2) fabricated as described above. FIGS. 42B and 42C show X-ray CT images of the cell BF2. Note that FIG. 42B is an X-ray CT image of the side surface of the cell BF2, and FIG. 42C is an X-ray CT image of the top surface of the cell BF2.

The cell BF2 fabricated as described above was subjected to initial charge and discharge. The initial charge and discharge were performed by the method shown in Table 7 in Example 2. Note that 1 C was 200 mA/g per weight of the positive electrode active material in this example.

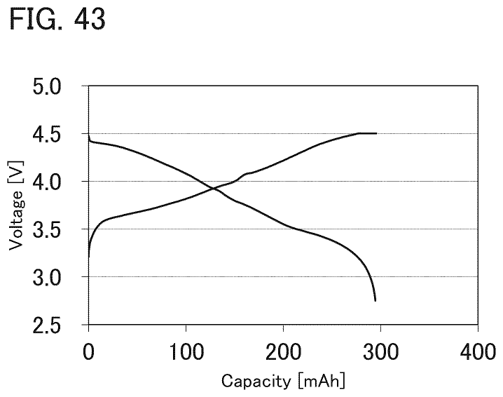

Next, the cell BF2 after the initial charge and discharge was charged and discharged under the following conditions, and the battery characteristics before the impact test were confirmed. As charge, constant current charge was performed at a current of 0.2 C until the battery voltage reached 4.50 V, and then constant voltage charge was performed at 4.50 V until the current reached lower than 0.02 C (constant current-constant voltage charge). As discharge, discharge was performed at a constant current of 0.2 C until the battery voltage reached 2.75 V (constant current discharge). The ambient temperature of the charge and discharge was 25° C. FIG. 43 shows the results of the charge and discharge. The graph in FIG. 43 shows a charge curve and a discharge curve, and the horizontal axis represents capacity and the vertical axis represents voltage.

### [Impact Test]

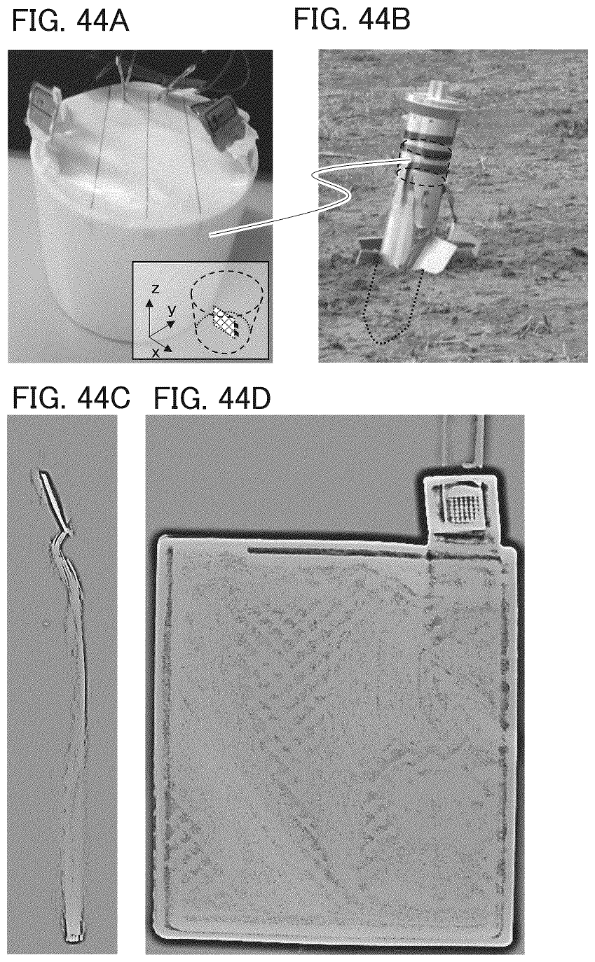

Before an impact test, an X-ray CT image was taken, the charge and discharge characteristics were measured, and the state of charge (SOC) of the cell BF2 was adjusted to 50%, and then the impact test was performed. As the impact test, the cell BF2 was embedded and fixed in a cylindrical resin as shown in a photograph of FIG. 44A to be held in a cylindrical test container whose top portion has a cone shape (cylindrical conical test container). The cell BF2 was embedded such that the Z axis direction became the short side direction of the cell BF2 when the bottom surface of the cylindrical shape was the X-Y plane in the diagram. In other words, the cell BF2 was set such that the long side direction of the cell BF2 was parallel to the X-Y plane.

The cell BF2 embedded in the cylindrical resin was held in the cylindrical conical test container (a dotted line portion in FIG. 44B), and the test container was dropped from a height of approximately 120 m to the ground. FIG. 44B is a photograph showing the state where the test container after the dropping sticks into the ground. The dotted line in the drawing indicates the shape of the test container in the ground. In this manner, the impact test was performed. Note that the impact due to the dropping was approximately 1000 G.

The internal structure of the cell BF2 after the impact test was analyzed with X-ray CT. FIGS. 44C and 44D show X-ray CT images of the cell BF2. Note that FIG. 44C is an X-ray CT image of the side surface of the cell BF2, and FIG. 44D is an X-ray CT image of the top surface of the cell BF2. Although FIG. 44C shows that part of the cell BF2 is bent, the positional shift of the electrode in the battery is small as shown in FIG. 44D. Thus, when the cell BF2 was embedded in the cylindrical resin, the cell BF2 possibly changed its shape together with the exterior body, forming the bent portion seen in FIG. 44C.

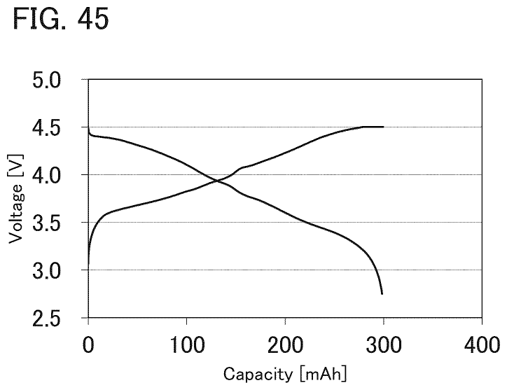

After the impact test, charge and discharge of the cell BF2 were performed, and the influence of the impact test on battery characteristics was examined. As charge, constant current charge was performed at a current of 0.2 C until the battery voltage reached 4.50 V, and then constant voltage charge was performed at 4.50 V until the current reached lower than 0.02 C (constant current-constant voltage charge). As discharge, discharge was performed at a constant current of 0.2 C until the battery voltage reached 2.75 V (constant current discharge). Discharge was performed at a constant current until the battery voltage reached 2.75 V with a current of 0.2 C (constant current discharge). The ambient temperature of the charge and discharge was 25° C. FIG. 45 shows the results of the charge and discharge.

When the graph of FIG. 43, which is the result of the charge and discharge test before the impact test, and the graph of FIG. 45, which is the result of the charge and discharge test after the impact test, are compared, there is almost no change. That is, the battery of one embodiment of the present invention can be used without problems even after receiving an impact of approximately 1000 G.

### Example 4

In this example, a battery including the positive electrode active material, a negative electrode, an electrolyte solution, and an exterior body, which are embodiments of the present invention, was fabricated and the resistance to repetition of bending was examined.

### <Formation of Negative Electrode>

The negative electrode B used in this example is described with reference to the formation method in FIG. 16.

In accordance with FIG. 16, as the graphite particle in this example, graphite with a particle diameter D50 of approximately 17 μm (CMB-Z produced by GELON Lib Co., Ltd.) was prepared. Note that silicon was not used for the negative electrode B.

In accordance with FIG. 16, CMC and SBR were used as the binder in this example.

In accordance with FIG. 16, VGCF (registered trademark) was prepared as the conductive material in this example.

In accordance with Step S60 in FIG. 16, the mixture 404 was formed by mixing the graphite particle, CMC, SBR, and VGCF at a weight ratio of the graphite particle:CMC:SBR:VGCF=97:1:1:1. The carried amount of the negative electrode active material was adjusted to be greater than or equal to 7 mg/cm² and less than or equal to 8 mg/cm².

In accordance with FIG. 16, deionized water was prepared as the solvent.

In accordance with Step S61 in FIG. 16, deionized water was added to the mixture 404 and mixed to give the slurry 406.

In accordance with FIG. 16, a copper foil was prepared as the negative electrode current collector, and the slurry was applied to the copper foil in accordance with Step S62.

The negative electrode 408 was obtained by drying the slurry in accordance with Step S63 in FIG. 16.

Laminated full cells (a cell BF3, a cell BF4, and a cell BF5) were fabricated with use of the positive electrode B in Example 1 and the above-described negative electrode B. The positive electrode B was a positive electrode one surface of which was coated, and the area of the positive electrode active material layer (coated portion) was approximately 21 cm². The negative electrode B was a negative electrode one surface of which was coated, and the area of the negative electrode active material layer (coated portion) was approximately 24 cm². The number of positive electrodes B and that of negative electrodes were each eight.

As the electrolyte solution, LiFSA was dissolved in EMI-FSA. Here, LiFSA was set to 2 mol/L with respect to EMI-FSA. Note that no additive agent was used.

As the separator, a porous polyimide film was used.

A stack was formed by stacking the positive electrode B, the negative electrode B, and the separator, the stack was placed inside the exterior body, and the outer edge of the exterior body was sealed. The method of stacking the positive electrode B, the negative electrode, and the separator was performed in a manner similar to that described with reference to FIGS. 19A to 19C.

A full cell in which an aluminum laminated film having an embossed cross-wave shape illustrated in FIG. 23A is used for the exterior body is referred to as the cell BF3. Full cells including an aluminum laminated film having an embossed cross-wave shape on one surface illustrated in FIG. 24B are referred to as the cell BF4 and the cell BF5. At this time, in order to align the positions of the positive electrode, the negative electrode, and a bend tester to be described later, the cell BF4 was fabricated such that the surface having the embossed shape became the top surface (a surface opposite to a surface in contact with the bend tester). The cell BF5 was fabricated such that the surface having the embossed shape became a bottom surface (the surface in contact with the bend tester). Note that two cells BF3, two cells BF4, and two cells BF5 were fabricated.

The cells BF3, BF4, and BF5 fabricated as described above were subjected to initial charge and discharge. The initial charge and discharge were performed by the method shown in Table 7 in Example 2.

### [Bending Test]

Next, bending tests were repeatedly performed on the cells BF3, BF4, and BF5. As the bending tests, a state of being bent with a radius of curvature of 40 mm and a state of being extended with a radius of curvature of 150 mm were repeatedly performed.

The bend tester is described. The bend tester includes a cylindrical supporting body with a radius of curvature of 40 mm extending in the depth direction under a center portion where a secondary battery is placed. The tester also includes arms extending in the right and left directions. End portions of the arms are mechanically connected to holding plates. By moving the end portions of the arms up or down, the holding plates can be bent along the support body. The bending test of the secondary battery was performed in a state where the secondary battery was sandwiched between the two holding plates. Thus, moving the end portions of the arms up or down allows the secondary battery to be bent along the cylindrical supporting body. Specifically, lowering the end portions of the arms permits the secondary battery to be bent with a radius of curvature of 40 mm. Note that the secondary battery is curved with a radius of curvature of 150 mm at the position where the tip portion of the arm is raised. Since the secondary battery is bent while being sandwiched between the two holding plates, unnecessary force except bending force can be prevented from being applied to the secondary battery. Furthermore, bending force can be uniformly applied to the whole secondary battery.

In the bending test, the cell BF4 was provided such that the surface having the embossed shape was on the side (also referred to as the front side) opposite to the support side. The cell BF5 was provided such that the surface having the embossed shape was on the support side (also referred to as the rear side).

As the bending test conditions, one bending was performed at intervals of 2 seconds. The charge and discharge characteristics were evaluated at 25° C. after the secondary battery was dismounted from the bend tester. As charge, constant current charge was performed at a rate of 0.2 C until the voltage reached 4.5 V, and constant voltage charge was performed at the voltage of 4.5 V until the current reached 0.02 C. As discharge, constant current discharge was performed at a rate of 0.2 C until the voltage reached 2.75 V. The measurement temperature was 25° C.

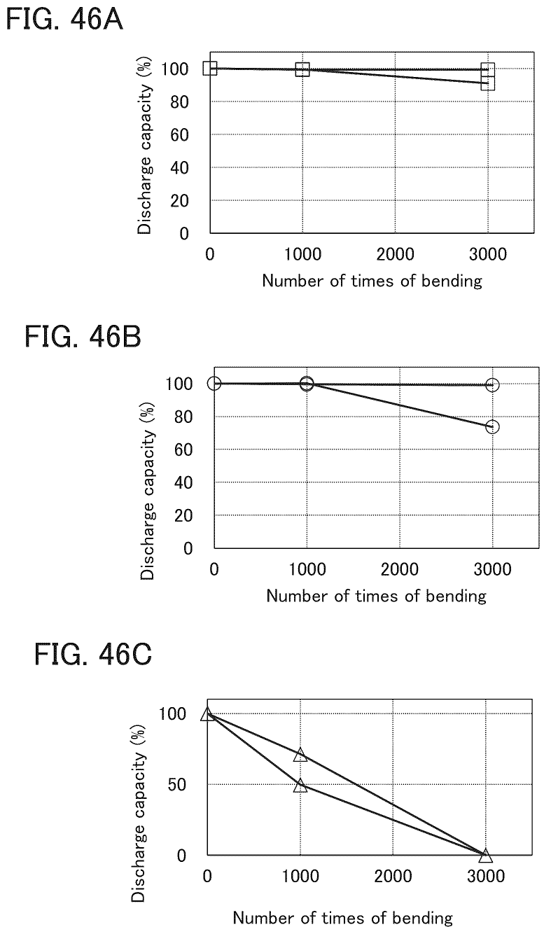

FIGS. 46A to 46C show discharge capacity before the start of the bending test (0 times), after 1000 times of bending, and after 3000 times of bending. FIG. 46A shows the measurement results of the cell BF3 (having the embossed shapes on the both sides), FIG. 46B shows the measurement results of the cell BF4 (having the embossed shape on the front side), and FIG. 46C shows the measurement results of the cell BF5 (having the embossed shape on the rear side). Note that calculation was performed on the assumption that the discharge capacity before the start of the bending test (0 times) was regarded as 100%.

As shown in FIG. 46A, the capacity of one of the two cells BF3 was not decreased even after 3000 times of bending, and the capacity of the other of the cells BF3 was decreased by approximately 10%.

As shown in FIG. 46B, the capacity of one of the two cells BF4 was not decreased even after 3000 times of bending, and the capacity of the other of the cells BF4 was decreased by approximately 25%.

As shown in FIG. 46C, the two cells BF5 both were incapable of being charged and discharged after 3000 times of bending. Note that the capacity of one of the two cells BF5 was decreased by approximately 30% after 1000 times of bending, and the capacity of the other of the cells BF5 was decreased by approximately 50%.

From the above results, as for the embossed shape of the exterior body, the cell BF3 having embossed shapes on the both sides brought the most favorable result, and then the cell BF4 having an embossed shape on the front side brought the second most favorable result. In the case where an aluminum laminated film having an embossed cross-wave shape was used as one surface described illustrated in FIG. 24B, it was found that having an embossed shape on the front side at the time of bending is more highly resistant to bending than having an embossed shape on a surface on the back side.

This application is based on Japanese Patent Application Serial No. 2023-130742 filed with Japan Patent Office on Aug. 10, 2023 and Japanese Patent Application Serial No. 2023-198136 filed with Japan Patent Office on Nov. 22, 2023, the entire contents of which are hereby incorporated by reference.

What is claimed is:

1. A method for forming a positive electrode active material using a setter for holding an object to be heated, comprising:
heating lithium cobalt oxide with a median diameter of less than or equal to 10 μm at a temperature higher than or equal to 700° C. and lower than or equal to 1000° C. for longer than or equal to an hour and shorter than or equal to 5 hours, the heating being performed in an atmosphere containing oxygen;
mixing a fluorine source and a magnesium source with the heated lithium cobalt oxide to form a first mixture;
heating the first mixture at a temperature higher than or equal to 800° C. and lower than or equal to 1100° C. for longer than or equal to an hour and shorter than or equal to 10 hours, the heating being performed in an atmosphere containing oxygen;
mixing a nickel source and an aluminum source with the heated first mixture to form a second mixture; and
heating the second mixture at a temperature higher than or equal to 800° C. and lower than or equal to 950° C. for longer than or equal to an hour and shorter than or equal to 5 hours, the heating being performed in an atmosphere containing oxygen,
wherein the heating of the first mixture is performed in a state where the first mixture is held to have a thickness of less than or equal to 2.0 mm in a first setter, and
wherein the heating the second mixture is performed in a state where the second mixture is held to have a thickness of less than or equal to 2.0 mm in a second setter.

2. The method for forming a positive electrode active material, according to claim 1, wherein a number of magnesium atoms in the magnesium source is greater than or equal to 0.3% and less than or equal to 3% of a number of cobalt atoms in the heated lithium cobalt oxide.

3. The method for forming a positive electrode active material, according to claim 2, wherein a number of nickel atoms in the nickel source is greater than or equal to 0.05% and less than or equal to 4% of the number of cobalt atoms in the heated lithium cobalt oxide.

4. The method for forming a positive electrode active material, according to claim 3, wherein a number of aluminum atoms in the aluminum source is greater than or equal to 0.05% and less than or equal to 4% of the number of cobalt atoms in the heated lithium cobalt oxide.

5. A method for fabricating a lithium-ion battery,
the lithium-ion battery comprising:
a positive electrode;
an electrolyte solution;
a negative electrode;
a separator; and
an exterior body,
the method for fabricating a lithium-ion battery, comprising the steps of:
dispersing the positive electrode active material formed by the method according to claim 1, a conductive material, and polyvinylidene fluoride in an organic solvent, thereby forming a positive electrode slurry;
applying the positive electrode slurry on a positive electrode current collector and drying the positive electrode slurry, thereby forming the positive electrode;
dispersing a graphite particle, a silicon particle, and poly(acrylic acid) in water, thereby forming a negative electrode slurry;
applying the negative electrode slurry on a negative electrode current collector and drying the negative electrode slurry, thereby forming the negative electrode; and
mixing a lithium salt, fluorinated cyclic carbonate, and fluorinated linear carbonate, thereby forming the electrolyte solution,
wherein the positive electrode and the negative electrode are stacked with the separator interposed therebetween, thereby forming a stack, and
wherein the stack and the electrolyte solution are held in the exterior body.

6. The method for fabricating a lithium-ion battery, according to claim 5,
wherein the lithium salt comprises LiPF₆,
wherein the fluorinated cyclic carbonate comprises fluoroethylene carbonate, and
wherein the fluorinated linear carbonate comprises methyl trifluoropropionate.

7. A method for forming a positive electrode active material using a setter for holding an object to be heated, comprising:
heating lithium cobalt oxide with a median diameter of less than or equal to 10 μm at a temperature higher than or equal to 700° C. and lower than or equal to 1000° C. for longer than or equal to an hour and shorter than or equal to 5 hours, the heating being performed in an atmosphere containing oxygen;
mixing a fluorine source and a magnesium source with the heated lithium cobalt oxide to form a first mixture;
heating the first mixture at a temperature higher than or equal to 800° C. and lower than or equal to 1100° C. for longer than or equal to an hour and shorter than or equal to 10 hours, the heating being performed in an atmosphere containing oxygen;
mixing a nickel source and an aluminum source with the heated first mixture to form a second mixture; and
heating the second mixture at a temperature higher than or equal to 800° C. and lower than or equal to 950° C. for longer than or equal to an hour and shorter than or equal to 5 hours, the heating being performed in an atmosphere containing oxygen,
wherein the heating of the first mixture is performed in a state where the first mixture is held to have a thickness of greater than or equal to 0.5 mm and less than or equal to 4.0 mm in a first setter, and
wherein the heating the second mixture is performed in a state where the second mixture is held to have a thickness of greater than or equal to 0.5 mm and less than or equal to 4.0 mm in a second setter.

8. The method for forming a positive electrode active material, according to claim 7, wherein a number of magnesium atoms in the magnesium source is greater than or equal to 0.3% and less than or equal to 3% of a number of cobalt atoms in the heated lithium cobalt oxide.

9. The method for forming a positive electrode active material, according to claim 8, wherein a number of nickel atoms in the nickel source is greater than or equal to 0.05% and less than or equal to 4% of a number of cobalt atoms in the heated lithium cobalt oxide.

10. The method for forming a positive electrode active material, according to claim 9, wherein a number of aluminum atoms in the aluminum source is greater than or equal to 0.05% and less than or equal to 4% of the number of cobalt atoms in the heated lithium cobalt oxide.

11. A method for fabricating a lithium-ion battery,
the lithium-ion battery comprising:
a positive electrode;
an electrolyte solution;
a negative electrode;
a separator; and
an exterior body,
the method for fabricating a lithium-ion battery, comprising the steps of:
dispersing the positive electrode active material formed by the method according to claim 7, a conductive material, and polyvinylidene fluoride in an organic solvent, thereby forming a positive electrode slurry;
applying the positive electrode slurry on a positive electrode current collector and drying the positive electrode slurry, thereby forming the positive electrode;
dispersing a graphite particle, a silicon particle, and poly(acrylic acid) in water, thereby forming a negative electrode slurry;
applying the negative electrode slurry on a negative electrode current collector and drying the negative electrode slurry, thereby forming the negative electrode; and
mixing a lithium salt, fluorinated cyclic carbonate, and fluorinated linear carbonate, thereby forming the electrolyte solution,
wherein the positive electrode and the negative electrode are stacked with the separator interposed therebetween, thereby forming a stack, and
wherein the stack and the electrolyte solution are held in the exterior body.

12. The method for fabricating a lithium-ion battery, according to claim 11,
wherein the lithium salt comprises LiPF₆,
wherein the fluorinated cyclic carbonate comprises fluoroethylene carbonate, and
wherein the fluorinated linear carbonate comprises methyl trifluoropropionate.

13. A method for forming a positive electrode active material using a setter for holding an object to be heated, comprising:
heating lithium cobalt oxide with a median diameter of less than or equal to 10 μm at a temperature higher than or equal to 700° C. and lower than or equal to 1000° C. for longer than or equal to an hour and shorter than or equal to 5 hours, the heating being performed in an atmosphere containing oxygen;
mixing a fluorine source and a magnesium source with the heated lithium cobalt oxide to form a first mixture;
heating the first mixture at a temperature higher than or equal to 800° C. and lower than or equal to 1100° C. for longer than or equal to an hour and shorter than or equal to 10 hours, the heating being performed in an atmosphere containing oxygen and a pressurized state;
mixing a nickel source and an aluminum source with the heated first mixture to form a second mixture; and
heating the second mixture at a temperature higher than or equal to 800° C. and lower than or equal to 950° C. for longer than or equal to an hour and shorter than or equal to 5 hours, the heating being performed in an atmosphere containing oxygen,
wherein the heating of the first mixture is performed in a state where the first mixture is held to have a thickness of greater than or equal to 0.5 mm and less than or equal to 4.0 mm in a first setter, and
wherein the heating the second mixture is performed in a state where the second mixture is held to have a thickness of greater than or equal to 0.5 mm and less than or equal to 4.0 mm in a second setter.

14. The method for forming a positive electrode active material, according to claim 13, wherein a number of magnesium atoms in the magnesium source is greater than or equal to 0.3% and less than or equal to 3% of a number of cobalt atoms in the heated lithium cobalt oxide.

15. The method for forming a positive electrode active material, according to claim 14, wherein a number of nickel atoms in the nickel source is greater than or equal to 0.05% and less than or equal to 4% of a number of cobalt atoms in the heated lithium cobalt oxide.

16. The method for forming a positive electrode active material, according to claim 15, wherein a number of aluminum atoms in the aluminum source is greater than or equal to 0.05% and less than or equal to 4% of the number of cobalt atoms in the heated lithium cobalt oxide.

17. A method for fabricating a lithium-ion battery,
the lithium-ion battery comprising:
a positive electrode;
an electrolyte solution;
a negative electrode;
a separator; and
an exterior body,
the method for fabricating a lithium-ion battery, comprising the steps of:
dispersing the positive electrode active material formed by the method according to claim 13, a conductive material, and polyvinylidene fluoride in an organic solvent, thereby forming a positive electrode slurry;
applying the positive electrode slurry on a positive electrode current collector and drying the positive electrode slurry, thereby forming the positive electrode;
dispersing a graphite particle, a silicon particle, and poly(acrylic acid) in water, thereby forming a negative electrode slurry;
applying the negative electrode slurry on a negative electrode current collector and drying the negative electrode slurry, thereby forming the negative electrode; and
mixing a lithium salt, fluorinated cyclic carbonate, and fluorinated linear carbonate, thereby forming the electrolyte solution,
wherein the positive electrode and the negative electrode are stacked with the separator interposed therebetween, thereby forming a stack, and
wherein the stack and the electrolyte solution are held in the exterior body.

18. The method for fabricating a lithium-ion battery, according to claim 17,
wherein the lithium salt comprises LiPF₆,
wherein the fluorinated cyclic carbonate comprises fluoroethylene carbonate, and
wherein the fluorinated linear carbonate comprises methyl trifluoropropionate.
